(19) United States
(12) Patent Application Publication
(10) Pub. No.: US 2007/0207390 A1
(43) Pub. Date: Sep. 6, 2007

(54) Hologram recording material and hologram recording method

(75) Inventors: Hiroo Takizawa, Kanagawa (JP); Noriko Yamashita, Kanagawa (JP); Tomotaka Tsuchimura, Shizuoka (JP); Kazuto Shimada, Shizuoka (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/712,928

(22) Filed: Mar. 2, 2007

(30) Foreign Application Priority Data
Mar. 2, 2006 (JP) 2006-056353

(51) Int. Cl. G03H 1/02

(52) U.S. Cl. 430/1; 359/3; 430/2; 430/281.1

(57) ABSTRACT

A hologram recording material with high sensitivity, high diffraction efficiency, good storability, a small shrinkage ratio, dry processing applicability and a multiple recording performance, which is applicable to high density optical recording media and the like, is provided. The hologram recording material contains the specific acid generator of sensitizing dye.

This application claims foreign priority from Japanese Patent Application No. 2006-56353, filed Mar. 2, 2006, the entire disclosure of which is herein incorporated by reference.

### BACKGROUND OF THE INVENTION

1. Field of the Invention

The present invention relates to a hologram recording material and a hologram recording method, both applicable to for example high-density optically recording media, three-dimensional displays, and holographic optical devices.

2. Description of Related Art

A number of references and professional text books including for example “Holographic Display” (edited by Jyunpei Tsuji and issued by Sangyo Tosho), Section 2 describe the general principle of hologram preparation. According to these references and text books, one of the two coherent laser lights irradiates a recording subject, while a photosensitive hologram recording material is placed at a position where total reflection light from the recording subject can be received. The hologram recording material is directly irradiated with the other coherent light in addition to the reflection light from the subject, without any irradiation of the subject. The reflection light from the subject is referred to as subject light, while the light directly irradiating the recording material is referred to as reference light. The interference fringes between the reference light and the subject light are recorded as image information. When the same light as the reference light (reproducing irradiation light) irradiates the treated recording material, then, the light is diffracted on a hologram so as to regenerate the waveform of the reflection light first arriving from the subject at the recording material during recording. Consequently, approximately the same subject image as the real image of the subject can be observed three-dimensionally.

A hologram formed by directing the reference light and the subject light incident on a hologram recording material along the same direction is referred to as transmission hologram. Interference fringes are formed in a shape vertical or approximately vertical to the film face of the recording material at an interval of about 1,000 to 3,000 fringes per 1 mm.

A hologram formed by directing the reference light and the subject light incident on a hologram recording material along directions opposite to each other is generally referred to as reflection hologram. Interference fringes are formed in a shape parallel or approximately parallel to the film face of the recording material at an interval of about 3,000 to 7,000 fringes per 1 mm.

The transmission hologram can be prepared by known processes for example the process disclosed in JP-A-6-43634. Additionally, the reflection hologram can be prepared by known processes for example the process disclosed in JP-A-2-3082 and the process disclosed in JP-A-3-50588.

A hologram with a film thickness sufficiently large compared with the interval of interference fringes (generally, the film thickness is about 5-fold or more the interval of interference fringes or of about 1 μm or more) is referred to as volume hologram.

Meanwhile, a hologram with a film thickness of about 5-fold or less the interval of interference fringes or of about 1 μm or less is referred to as plane- or surface hologram.

Additionally, a hologram recording interference fringes via the absorption of dyes or silver is referred to as amplitude hologram. A hologram recording interference fringes via surface relief or refractive index modulation is referred to as phase hologram. Due to optical absorption, the optical diffraction or reflection efficiency is significantly reduced in the amplitude hologram, disadvantageously in terms of the optical utilization efficiency. Generally, therefore, phase hologram is preferably used.

On the volume-phase hologram, optical phase can be modulated without optical absorption, by forming enormous interference fringes not via optical absorption but with different refractive indices in the hologram recording material therefor.

The volume-phase hologram of reflection type is particularly referred to as Lipmann hologram and can be provided in full colors, white color reproducing and high resolution to generate high-resolution full-color three-dimensional displays, at high diffraction efficiency due to the wavelength-selective reflection owing to the Bragg diffraction.

In recent years, furthermore, the Lipmann hologram has been widely applied in practical sense by actively utilizing the wavelength-selective reflection to hologram optical elements (HOE) typically including head-up display (HUD), pickup lenses for optical disks, head-mount displays, color filters for liquid crystal, and liquid crystal reflection plates of reflection type.

Besides, research works have been under way so as to practically applying or simply applying the Lipmann hologram to for example lenses, diffraction lattices, interference filters, binder devices for optical fiber, polarization devices for facsimile, and building window glasses.

In the recent distribution of advanced information systems, networks such as Internet and high-vision TV have been spread rapidly. Furthermore, HDTV (high definition television) will be on air very soon. Therefore, high-density recording media are increasingly desired for household use so as to record 100-Gb or more image information in a simple manner at low cost.

Additionally in the demand toward computers with large capacities, an ultra-high density recording medium capable of recording information of a large volume such as about 1 TB or more at a high speed and at low cost is expected for business applications such as computer back-up applications and broadcasting back-up applications.

In such circumstances, optical recording media in smaller shapes at low cost, reversibly functioning and being accessible randomly, have now drawn attentions, compared with random-access-impossible magnetic tape media and hard disks irreversibly functioning at high out-of-order rates. However, existing two-dimensional optical recording media such as DVD-R may possibly get a recording capacity of about 25 GB at most on a single face thereof in view of the physical principle, even when the wavelength for recording and reproducing is shortened. Therefore, it cannot be said that such existing two-dimensional optical recording media can get a recording capacity large enough to satisfy potential future demands.

As an ultimate, ultra-high density recording medium, a three-dimensional optical recording medium for recording along the direction of the film thickness is now increasingly focused. A potent method therefor includes a method with a two-photon absorption material and a method by holography (interference). Hence, dramatically increasing attention has been focused quite recently on volume-phase hologram recording materials as three-dimensional optical recording media (holographic memories).

Holographic memory using a volume-phase hologram recording material can record numerous two-dimensional digital information (referred to as signal light) using spatial light modulator (SLM) such as DMD and LCD, instead of subject light reflecting from three-dimensional subjects. During recording multiple recording via for example angle multiplicity, phase multiplicity, wavelength multiplicity and shift multiplicity is in progress, so that such holographic memory can record information of a capacity as large as 1 TB. For readout, generally, CCD and CMOS are for example used. Due to parallel writing and readout of the information, a transfer speed as large as 1 Gbps can be attained.

Herein, the hologram recording material for use in holographic memories should satisfy more strict requirements than those for three-dimensional displays and HOE, as described below.

### (1) High sensitivity.

### (2) High resolution.

### (3) High diffraction efficiency of hologram.

### (4) Dry recording process at a high speed.

### (5) Multiple recording (wide dynamic range).

### (6) Small shrinkage ratio after recording.

### (7) Good hologram storability.

The high diffraction efficiency of hologram, the dry recording process at a high speed, the small shrinkage ratio after recording and the good hologram storability described above in (3), (4), (6) and (7) are physico-chemical properties contradictory to the high sensitivity described above in (1), from the chemical standpoint. Accordingly, it is very difficult to satisfy all of the requirements.

As known volume-phase hologram recording materials, for example, those of write-once modes such as dichromate-gelatin mode, bleached silver halide salt mode and photopolymer mode and those of rewrite-double modes such as photorefractive mode and photochromic polymer mode have been known.

However, these known volume-phase hologram recording materials have not yet satisfied all the requirements for use in highly sensitive optical recording media, in particular. Therefore, these known volume-phase hologram recording materials should be improved.

Specifically, for example, the dichromate-gelatin mode has an advantageous performance of high diffraction efficiency with low noise but has very poor storability. Therefore, the dichromate-gelatin mode requires a wet process and is hence at a low sensitivity, disadvantageously. Accordingly, the dichromate-gelatin mode is not suitable for holographic memory.

The bleached silver halide mode has an advantageous performance of high sensitivity but requires a wet process involving a laborious bleaching process. Additionally, the bleached silver halide mode has drawbacks of large scattering and poor optical resistance and is also generally unsuitable for holographic use.

The photorefractive materials have an advantageous rewritable aspect but require the application of a high electric field during recording, disadvantageously, leading to poor record storability.

The photochromic polymer mode typically involving azobenzene polymer materials advantageously has a rewritable profile, but is at extremely poor sensitivity and with poor record storability. For example, the International Publication WO 97/44365 (A1) pamphlet proposes a rewritable hologram recording material using the anisotropic refractive index and orientation control of an azobenzene polymer (photochromic polymer). However, the material is at an extremely poor sensitivity due to the low quantum yield of azobenzene anisotropy and due to the mode involving the modification of the orientation. Further, disadvantageously, the material is at poor record storability as an aspect inconsistent with the rewritable property. Therefore, the hologram recording material is far from any practical application.

Among those modes, the dry photopolymer mode disclosed in JP-A-6-43634, JP-A-2-3082 and JP-A-3-50588 comprises an essential composition of a binder, a radical-polymerizable monomer and a photo-polymerizable initiator, where a compound with an aromatic ring or with chlorine or bromine is used as either one of the binder and the radical-polymerizable monomer to allow for a difference in refractive indices, so as to improve the refractive index modulation. Consequently, the monomer accumulates in the bright portion in interference fringes formed during hologram exposure, while the binder accumulates in the dark portion therein, to form a difference in refractive indices during the progress of polymerization. Thus, the dry photopolymer mode is a relatively practical mode capable of consistently satisfying high diffraction efficiency and dry processing applicability.

Nonetheless, the dry photopolymer mode has the following disadvantages compared with the bleached silver halide mode: the sensitivity is about 1/1000-fold that of the bleached silver halide mode; a heating and fixing process as long as about 2 hours is required for increasing the diffraction efficiency; the mode is under influences of the oxygen inhibition of polymerization because of radical polymerization; the diffraction wavelength and angle during reproducing may change because of the shrinkage of recording materials after exposure and fixing; and the storability is not sufficient due to the film softness. Thus, the dry photopolymer mode is never satisfactory for use in holographic memories.

Compared with radical polymerization, generally, cation polymerization, in particular cation polymerization involving the ring opening of for example epoxy compounds causes less post-polymerization shrinkage under no oxygen inhibition of polymerization, to provide a film with rigidity. It is suggested that cation polymerization is therefore more suitable for holographic memories.

For example, JP-A-5-107999 and JP-A-8-16078 disclose hologram recording materials including a cation-polymerizable compounds (monomer or oligomer) used in place of a binder, in combination of a sensitizing dye, a radical polymerization initiator, a cation polymerization initiator, and a radical-polymerizable compound.

Additionally, for example, JP-T-2001-523842 and JP-T-11-512847 disclose a hologram recording material using a sensitizing dye, a cation polymerization initiator, a cation-polymerizable compound and a binder, with no use of radical polymerization.

Compared with the radical polymerization mode, the shrinkage ratio is improved according to the cation polymerization mode. Contradictorily, however, the sensitivity is reduced, disadvantageously for transfer speed for practical application. Additionally, the diffraction efficiency is also reduced, disadvantageously in terms of S/N ratio and multiple recording.

As described above, the photopolymer mode involves substance transfer. Thus, the photopolymer mode falls into a dilemma in applying the mode to holographic memories, such that the improvement of the storability and the reduction of the shrinkage lead to the reduction of the sensitivity (cation polymerization mode) while the improvement of the sensitivity leads to the deterioration of the storability and the shrinkage ratio (radical polymerization mode). So as to improve the recording density of holographic memories, still further, multiple recording as much as 50 times or more to 100 times or more is essential. Because the photopolymer mode employs polymerization involving substance transfer for recording, the recording speed in the late phase of multiple recording after the progress of the polymerization of many compounds is slower than the initial recording speed in multiple recording, practically disadvantageously, which therefore inevitably requires the adjustment of the exposure level by controlling the recording speed and the arrangement of a wide dynamic range.

In terms of the physical rule, such problem of the dilemma of high sensitivity inconsistent with good storability, a small shrinkage ratio, dry processing applicability and a multiple recording performance (high recording density) is unavoidable as long as the conventional photopolymer mode is used. From the standpoint of the principle, it is very difficult that the silver halide mode satisfies the requirements demanded for the holographic memories in terms of the dry processing applicability.

So as to apply a hologram recording material to holographic memories, it has been strongly desired to develop a totally new recording method capable of essentially overcoming the problem, particularly consistently realizing high sensitivity, a small shrinkage ratio, good storability, dry processing applicability and a multiple recording performance (high recording density).

Therefore, the present inventors made investigations to develop hologram recording materials and hologram recording methods capable of essentially overcoming the problems and using the refractive index modulation via the color developing or discoloring reaction of dyes. The hologram recording materials and the hologram recording methods were disclosed in JP-A-2005-99751, JP-A-2005-99753 and JP-A-2005-309359.

However, still unsatisfactory aspects remain in terms of for example the diffraction efficiency, the multiple recording profile and the storability in darkness. Accordingly, these hologram recording materials and hologram recording methods have needed further improvement.

### SUMMARY OF THE INVENTION

An object of an illustrative, non-limiting embodiment of the invention is to provide a hologram recording material and a hologram recording method, which are applicable to for example high density optical recording media, three-dimensional displays, holographic optical elements and are also capable of consistently achieving high sensitivity, high diffraction efficiency, good storability, a small shrinkage ratio, dry processing applicability and a multiple recording performance (high recording density).

The inventors made investigations. Consequently, the object of the invention was attained by the following approaches.

### (1) A hologram recording material containing an acid generator represented by the formula (1-1) or (1-2):

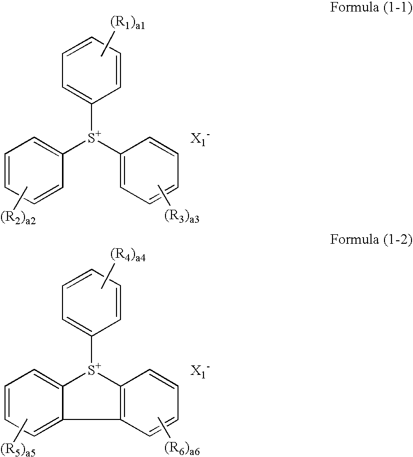

In the formulae (1-1) and (1-2), R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; a5 and a6 independently represent an integer of 0 to 4, provided that R₁, R₂, R₃, R₄, R₅ and R₆ independently existing in plurality may be the same or different when a1 through a6 are 2 or more; and X₁⁻ represents an anion.

### (2) A hologram recording material described above in (1), where R₄, R₅ and R₆ independently represent an electron attractive group in the formula (1-2).

### (3) A hologram recording material described above in (1) or (2), where a4 is an integer of 1 to 5; and a5 and a6 are independently an integer of 1 to 4.

(4) A hologram recording material described above in (1) through (3), where R₁, R₂ and R₃ as electron attractive substituents and R₄, R₅ and R₆ as substituents are independently any one of halogen atoms, halogen-substituted alkyl groups, cyano group, sulfamoyl group, alkylsulfonyl groups, arylsulfonyl groups and heterocyclic groups.

### (5) A hologram recording material described above in (1), where at least one of the electron attractive substituents R₁, R₂ and R₁ is chlorine atom in the formula (1-1).

### (6) A hologram recording material described above in (1), where at least one of the electron attractive substituents R₄, R₅ and R₆ is chlorine atom in the formula (1-2).

(7) A hologram recording material described above in (1), where the acid generators represented by the formulae (1-1) and (1-2) are represented by the formulae (1-3) and (1-4), respectively:

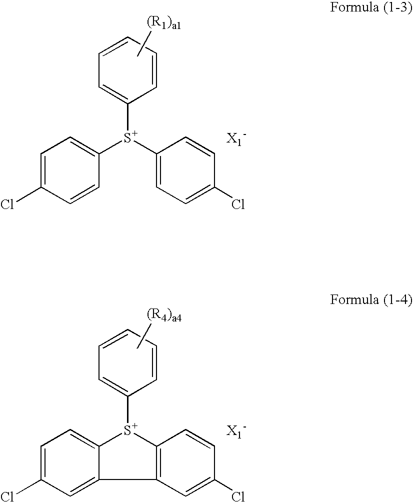

In the formulae (1-3) and (1-4), R₁, R₄, a1, a4, and X₁⁻ have individually the same meanings as in the formulae (1-1) and (1-2).

### (8) A hologram recording material described above in (7), where the acid generators represented by the formulae (1-3) and (14) are represented by the formulae (1-5) and (1-6), respectively;

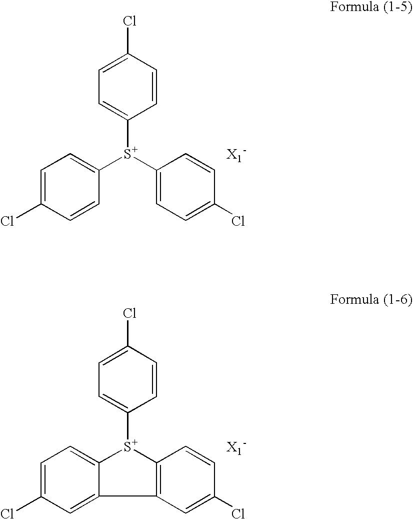

In the formulae (1-5) and (1-6), X₁⁻ has the same meaning as in the formulae (1-1).

(9) A hologram recording material described above in (1) through (8), where X₁⁻ represents any anion of PF₆⁻, SbF₆⁻, BF₄⁻, B(C₆F₅)₄⁻; R₇SO₃⁻, (R₈SO₂)N⁻ and (R₉SO₂)₃C⁻ in the formulae (1-1) through (1-6), provided that R₇ represents an alkyl group, a fluorine-substituted alkyl group, an aryl group or a fluorine-substituted aryl group and that R₈ and R₉ independently represent a fluorine-substituted alkyl group.

### (10) A hologram recording material described above in (8), where X₁⁻ represents PF₆⁻.

(11) A hologram recording method using a hologram recording material as described above in (1) through (10), the material containing an acid generator represented by any one of the formulae (1-1) through (1-6) as described above in (1), (2) and (3), the method comprising recording interference fringes as refractive index modulation (i.e., recording a refractive index modulation providing interference fringes) by one reaction of 1) polymerization reaction, 2) color developing reaction, 3) color developing reaction comprising latent image formation via color developing and the self-sensitization and amplification of a color developing substance, 4) polymerization reaction comprising latent image formation via color developing and sensitizing a color developing substance, 5) the orientation change of a compound with intrinsic birefringence, 6) dye discoloring reaction, and 7) polymerization reaction comprising forming latent image of residual discolorable dye and sensitizing the latent image.

### (12) A hologram recording material containing a sensitizing dye represented by any one of the formulae (2-1) through (2-5):

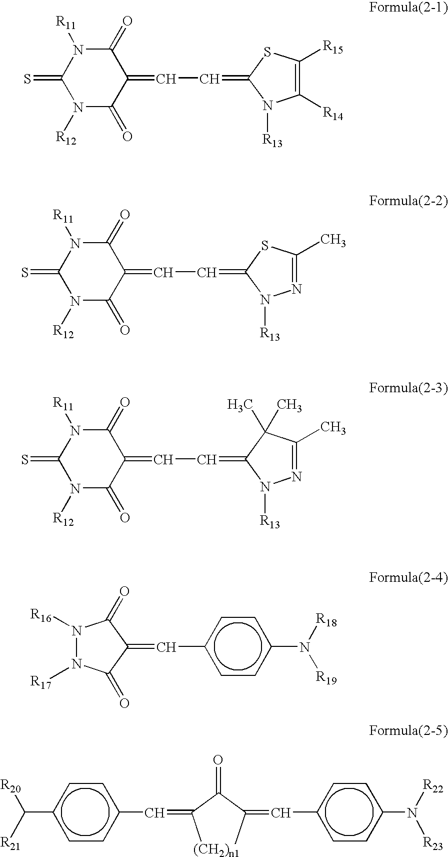

In the formulae (2-1) through (2-4), R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group.

In the formulae (2-4) and (2-5), R₁₈, R₁₉, R₂₀, R₂₁, R₂₂ and R₂₃ independently represent an alkyl group, an alkenyl group, a cycloalkyl group, or an aryl group; and R₁₈ and R₁₉, R₂₀ and R₂₁, or R₂₂ and R₂₃ may independently bind together to form a ring.

### In the formula (2-5), n1 represents any integer of 0, 1, 3 and 4.

### (13) A hologram recording material described above in (12), where R₁₈, R₂₀ and R₂₂ are independently an alkyl group substituted with an electron attractive group in the formula (2-4) or (2-5).

(14) A hologram recording material described above in (13), where the electron attractive group in the substitution of an alkyl group is any one of cyano group, an alkoxycarbonyl group, carbamoyl group, a halogen atom, an alkoxy group, an aryloxy group, an acyloxy group, an alkylsulfonyl group, and an arylsulfonyl group.

### (15) A hologram recording material described above in (13), where n1 is 0 or 3 in the formula (2-5).

(16) A hologram recording method described above in (12) to (15) using a sensitizing dye represented by any one of the formulae (2-1) through (2-5), the method comprising recording interference fringes as refractive index modulation (i.e., recording a refractive index modulation providing interference fringes) by one reaction of 1) polymerization reaction, 2) color developing reaction, 3) color developing reaction comprising latent image formation via color developing and the self-sensitization and amplification of a color developing substance, 4) polymerization reaction comprising latent image formation via color developing and sensitizing a color developing substance, 5) the orientation change of a compound with intrinsic birefringence, 6) dye discoloring reaction, and 7) polymerization reaction comprising forming latent image of residual discolorable dye and sensitizing the latent image.
(17) A hologram recording method described above in (11) and (16) using an acid generator represented by any one of the formulae (1-1) through (1-6) as described above in (1), (2) and (3) and a sensitizing dye represented by any one of the formulae (2-1) through (2-5) as described above in (12), the method comprising recording interference fringes as refractive index modulation via any one mode of 1) polymerization reaction, 2) color developing reaction, 3) color developing reaction comprising latent image formation via color developing and the self-sensitization and amplification of a color developing substance, 4) polymerization reaction comprising latent image formation via color developing and sensitizing a color developing substance, 5) the orientation change of a compound with intrinsic birefringence, 6) dye discoloring reaction, and 7) polymerization reaction comprising forming latent image of residual discolorable dye and sensitizing the latent image.
(18) A hologram recording material for use in a hologram recording method via 2) color developing reaction or 3) color developing reaction comprising latent image formation via color developing and the self-sensitization and amplification of a color developing substance, as described above in (11), (16) or (17), the hologram recording material containing:

1) a sensitizing dye absorbing light via hologram exposure to generate an excited state of the sensitizing dye itself,

2) an acid generator generating an acid via electron transfer or energy transfer from the excited state of the sensitizing dye or from the excited state of a color developing substance comprising a dye precursor, and

3) the dye precursor capable of converting to the color developing substance with absorption in a wavelength longer than that in the initial state via the addition of the acid but with no absorption in the wavelength of the hologram reproducing beam (hologram reproducing light),

wherein either one or both of a sensitizing dye represented by any one of the formulae (2-1) through (2-5) and an acid generator represented by any one of the formulae (1-1) through (1-6) are used as the sensitizing dye described in 1) and the acid generator described in 2), respectively.

(19) A hologram recording method via 4) polymerization reaction comprising latent image formation via color developing and sensitizing a color developing substance, as described above in (11), (16) or (17), comprising a first step of generating at least a color developing substance with no absorption in the wavelength of hologram reproducing light by hologram exposure as a latent image and a second step of irradiating light of a wavelength different from that for the hologram exposure on the latent image of the color developing substance for triggering polymerization to record interference fringes as refractive index modulation, where the first and second steps are done by dry processes.
(20) A hologram recording material for use in a hologram recording method described above in (19), comprising:

1) a sensitizing dye absorbing light during the hologram exposure at the first step for generating an excited state of the sensitizing dye itself,

2) an acid generator generating an acid via electron transfer or energy transfer from the excited state of the sensitizing dye at the first step or from the excited state of a color developing substance comprising a dye precursor at the second step,

3) the dye precursor capable of converting to the color developing substance with absorption in a wavelength longer than that in the initial state via the addition of the acid but with no absorption in the wavelength of the hologram reproducing light,

4) a polymerization initiator (sometimes also functioning as the acid generator described in 2)) capable of initiating the polymerization of a polymerizable compound via electron transfer or energy transfer from the excited state of the sensitizing dye at the first step or from the excited state of the color developing substance at the second step,

5) the polymerizable compound, and

6) a binder,

where either one or both of a sensitizing dye represented by any one of the formulae (2-1) through (2-5) and an acid generator represented by any one of the formulae (1-1) through (1-6) are used as the sensitizing dye described in 1) and the acid generator described in 2), respectively.

(21) A hologram recording material for use in a hologram recording method via 6) dye discoloring reaction, as described above in (11), (14) or (17), the hologram recording material containing:

1) a sensitizing dye absorbing light via hologram exposure to generate an excited state of the sensitizing dye itself,

2) an acid generator generating an acid via electron transfer or energy transfer from the excited state of the sensitizing dye itself, and

3) a discolorable dye with no absorption in the wavelength of hologram reproducing light, which is discolored with the acid,

where the sensitizing dye generates the excited state thereof via hologram exposure to subsequently transfer electron to an acid generator to generate an acid, which discolors a discolorable dye to form interference fringes via refractive index modulation, and where either one or both of a sensitizing dye represented by any one of the formulae (2-1) through (2-5) and an acid generator represented by any one of the formulae (1-1) through (1-6) are used as the sensitizing dye described in 1) and the acid generator described in 2), respectively.

(22) A hologram recording method via 7) polymerization reaction comprising forming latent image of residual discolorable dye and sensitizing the latent image, as described above in (11), (16) or (17), comprising a first step of allowing a sensitizing dye with absorption in the wavelength of hologram exposure to absorb light during the hologram exposure to generate an excited state thereof to subsequently transfer electron to an acid generator to allow the acid generator to generate an acid, discoloring a discolorable dye with the acid to prepare a latent image of the residual discolorable dye never discolored, and a second step of irradiating light of a wavelength different from that for the hologram exposure on the latent image of the residual discolorable dye for activating a polymerization initiator via energy transfer or electron transfer to trigger the polymerization to form interference fringes via refractive index modulation.
(23) A hologram recording material for use in a hologram recording method described in (22), comprising:

1) a sensitizing dye absorbing light during the hologram exposure at the first step for generating an excited state of the sensitizing dye itself,

2) an acid generator generating an acid via an electron transfer or energy transfer from the excited state of the sensitizing dye;

3) a discolorable dye having no absorption in a wavelength of hologram reproducing light and discoloring by an acid;

4) a polymerization initiator (sometimes also functioning as the acid generator described in 2)) capable of initiating the polymerization of a polymerizable compound via electron transfer or energy transfer from the excited state of the sensitizing dye at the first step or from the excited state of the color developing substance at the second step,

5) the polymerizable compound, and

6) a binder.

(24) A hologram recording material described above in (1) through (10), (12) through (15), (18), (20), (21) or (23), the hologram recording material containing an electron donating compound with a potential to reduce the radical cation of the sensitizing dye or the color developing substance generated from the dye precursor.

### (25) A hologram recording material described above in (24), where the electron donating compound described above in (24) is one of phenothiazines.

(26) A hologram recording material described above in (1) through (10), (12) through (15), (18), (20), (21) or (23) through (25), where the hologram recording described above in (1) through (10), (12) through (15), (18), (20), (21) or (23) through (25) is not of a rewritable mode.

### (27) A volume-phase hologram recording method comprising recording a volume-phase hologram using a hologram recording material described above in (1) through (26).

### (28) A hologram recording method comprising a step of multiple recordings 10 times or more using a hologram recording material described above in (1) through (26).

### (29) A hologram recording method described above in (28), where any of the multiple recordings is done at any constant exposure level during multiple recordings.

### (30) An optically recording medium comprising a hologram recording material described above in (1) through (29).

### (31) An optically recording medium where the hologram recording material described above in (1) through (30) is stored in a light-shielded cartridge during storage.

### BRIEF DESCRIPTION OF DRAWING

The sole FIGURE is a schematic view depicting the optical two-beam system for hologram exposure.

Reference numerals and signs in the FIGURE are set forth below,

### 10: YAG laser

12: laser beam
14: mirror
20: beam splitter
22: beam segment
24: mirror
26: spatial filter
28: sample
30: hologram recording material

### 32: He—Ne laser beam

### 34: He—Ne laser

36: detector
38: rotation stage
40: beam expander

### DETAILED DESCRIPTION OF THE EXEMPLARY EMBODIMENTS

Although the invention will be described below with reference to the exemplary embodiment thereof, the following exemplary embodiment and its modification do not restrict the invention.

According to an exemplary embodiment of the invention, a hologram recording material containing the specific sensitizing dye or acid generator can be used for hologram recording at high diffraction efficiency and with a linear increase of the refractive index modulation level vs. exposure level, without any shrinkage during recording and with good storability in darkness. The hologram recording material is applicable to holographic memories and the like, advantageously in terms of multiple recording, storability in darkness and the like.

Exemplary embodiments of a hologram recording method and a hologram recording material in accordance with the invention are described below in detail.

An exemplary embodiment of a hologram recording method of the invention preferably comprises recording interference fringes as refractive index modulation (i.e., recording a refractive index modulation providing recording interference fringes) via any one of 1) polymerization reaction, 2) color developing reaction, 3) color developing reaction comprising latent image formation via color developing and the self-sensitization and amplification of a color developing substance, 4) polymerization reaction comprising latent image formation via color developing and sensitizing a color developing substance, 5) the orientation change of a compound with intrinsic birefringence, 6) dye discoloring reaction, and 7) polymerization reaction comprising forming latent image of residual discolorable dye and sensitizing the latent image.

More preferably, a hologram recording method of the invention comprises recording interference fringes as refractive index modulation via any one of 2) color developing reaction, 4) polymerization reaction comprising latent image formation via color developing and sensitizing a color developing substance, 5) the orientation change of a compound with intrinsic birefringence, 6) dye discoloring reaction, and 7) polymerization reaction comprising forming latent image of residual discolorable dye and sensitizing the latent image.

A hologram recording method of the invention is preferably done without using any wet process.

A hologram recording material of the invention is preferably a not-rewritable mode. Herein, the not-rewritable mode is a recording mode via irreversible reaction. The data once recorded cannot be rewritten but stored even when attempts are made to rewrite the data by over-recording. Thus, the not-rewritable mode is suitable for storing important data requiring long-term storage. It is needless to say that new data can additionally be written and recorded in a region without any recorded data. In that sense, generally, such not-rewritable mode is called “postscript type” or “write-once type”.

The light (or beam) for use in the hologram recording in accordance with the invention is preferably ultraviolet ray, visible ray and infrared ray in a wavelength of 200 to 2,000 nm. More preferably, the light is ultraviolet ray or visible ray in a wavelength of 300 to 700 nm. Still more preferably, the light is visible ray of 400 to 700 nm.

The light for use in the hologram recording of the invention is preferably a coherent (phase- and wavelength-aligned) laser beam. Any of solid laser, semiconductor laser, gas laser and liquid laser may be used as the laser. Preferably, the laser beam includes for example YAG second harmonic generation (SHG) laser of 532 nm, YAG third harmonic generation (THG) laser of 355 nm, semiconductor lasers of for example GaN and InGaN around 400 to 415 nm, semiconductor lasers of for example AlGaInP around 650 to 660 nm, Ar ion laser of 488 or 515 nm, He—Ne laser of 632 or 633 nm, Kr ion laser of 647 nm, ruby laser of 694 nm, and He—Cd lasers of 636, 634, 538, 534 and 442 nm.

Additionally, pulse lasers in nano-second or pico-second orders are preferably used.

For using the hologram recording material of the invention as an optically recording medium, YAG laser second harmonic generation of 532 nm, semiconductor lasers of GaN and InGaN around 400 to 415 nm, and semiconductor lasers of for example AlGaInP around 650 to 660 nm are preferably used.

The wavelength of the light for use in hologram reproducing is preferably equal to or longer than the wavelength of the light for use in hologram exposure (recording).

The hologram recording material of the invention may satisfactorily be treated at a fixing step with light or heat or with both of the two, after hologram exposure.

In case that an acid generator or a base generator is used in the hologram recording material of the invention, in particular, heating is preferably done for fixing in terms of effectively allowing an acid generator or a base generator to function.

In case of optical fixing, ultraviolet ray or visible ray irradiates the whole surface of the hologram recording material (non-interference exposure). Visible ray laser, ultraviolet laser, carbon arc, high-pressure mercury lamp, xenon lamp, metal halide lamp, fluorescence lamp, tungsten lamp, LED and organic EL are preferably used as the light source.

For thermal fixing, the fixing step is done at preferably 40° C. to 160° C., more preferably 60° C. to 130° C.

For both of the optical fixing and thermal fixing, satisfactorily, light and heat may simultaneously or separately be applied.

The refractive index modulation level in recording interference fringes is preferably 0.00001 to 0.5, more preferably 0.0001 to 0.3. As the film thickness of a hologram recording material is larger, preferably, the refractive index modulation level is lower. As the film thickness of a hologram recording material is smaller, preferably, the refractive index modulation level is larger.

The (relative) diffraction efficiency “η” of a hologram recording material is given by the following formula.

η=Idiff/Io

Herein, Io is the intensity of transmitting light with no diffraction; Idiff is the intensity of light diffracted (diffraction type) or reflected (reflection type). The diffraction efficiency is at any value of 0 to 100%. Nonetheless, the diffraction efficiency is preferably 30% or more, more preferably 60% or more and most preferably 80% or more.

The sensitivity of a hologram recording material is generally represented by the exposure level (mJ/cm²) per unit area. It can be said that the sensitivity is higher as the value is smaller. However, it is variable depending on the reference or patent at what point of time the exposure level should be measured for defining the sensitivity. Sometimes the sensitivity is defined by the exposure level when recording (refractive index modulation) is started; the sensitivity is defined by the exposure level to give the maximum diffraction efficiency (refractive index modulation); the sensitivity is defined by the exposure level to give the half of the maximum diffraction efficiency; otherwise, the sensitivity is defined by the exposure level “E” to make the slope of the diffraction efficiency the largest.

According to the Kugelnik's theoretical formula, the differential refractive index modulation level “Δn” to give a certain diffraction efficiency level is in inverse proportion to the film thickness “d”. In other words, the sensitivity to give a certain diffraction efficiency level varies depending on the film thickness. As the film thickness “d” is larger, the differential refractive index modulation level “Δn” is smaller. Therefore, the sensitivity cannot be definitely defined unless conditions such as film thickness are constant.

In accordance with the invention, the sensitivity is defined as the “exposure level (mJ/cm²) to give the half of the maximum diffraction efficiency”. The sensitivity of the hologram recording material of the invention is preferably 2 J/cm² or less, more preferably 1 J/cm² or less, still more preferably 500 mJ/cm² or less, most preferably 200 mJ/cm² or less in case that the film thickness is about 10 to 200 μm.

When the hologram recording material of the invention is used as an optically recording medium for holographic memories, preferably, two-dimensional digital information (referred to as signal light) is numerously recorded using a spatial light modulation (SLM) such as DMD and LCD. So as to raise the recording density, multiple recording is preferably used. The method for multiple recording includes multiple recordings in terms of angle multiplicity, phase multiplicity, wavelength multiplicity, and shift multiplicity. Preferably, recordings in terms of angle multiplicity or recordings in terms of shift multiplicity are used. Additionally, CCD and CMOS are preferably used for reading out reproduced two-dimensional data.

When the hologram recording material of the invention is used as a holographic memory as one of optically recording media, essentially, multiple recording should be done so as to raise the capacity (recording density). In that case, more preferably, multiple recordings 10 times or more are done. Multiple recordings are done, more preferably 50 times or more, most preferably 100 times or more. Multiple recordings at a constant exposure level during any multiple recordings are preferable in terms of the simplification of a recording system therefor and the improvement of S/N ratio.

In case that the hologram recording material is used as an optically recording medium, additionally, the hologram recording material under storage is stored in a light-shielded cartridge. Preferably, a light-shielding filter capable of partially cutting off the wavelengths of ultraviolet ray, visible ray and infrared ray except the wavelengths of recording light and reproducing light is preferably arranged on the surface of the hologram recording material, the back face thereof or both of the surface and back face thereof.

In case of using the hologram recording material of the invention as an optical recording medium, the optical recording medium may be in any shapes such as disk, card and tape.

In case that the individual hologram recording methods of the invention and the individual components of the hologram recording materials to which such recording methods are applicable are described below in detail.

### 1) Recording Interference Fringes via Polymerization Reaction

Preferably, the hologram recording materials contain at least a sensitizing dye, a polymerization initiator, a polymerizable compound and a binder, where the polymerizable compound and the binder have different refractive indices. Via the occurrence of the photo-polymerization due to the optical absorption of the sensitizing dye, the composition ratio of the polymerizable compound and the polymerized product to the binder gets non-uniform in the bright part of interference and in the dark part of interference, so that interference fringes are recorded through refractive index modulation.

Herein, the sensitizing dye and the polymerization initiator may function in place of each other. In other words, the polymerization initiator may satisfactorily be excited directly for recording.

Additionally in the hologram recording material of the invention, either one or both of a sensitizing dye represented by any one of the formulae (2-1) through (2-5) and an acid generator represented by any one of the formulae (1-1) through (1-6) are used as a sensitizing dye and an acid generator, respectively. Preferably, both of the two are used.

The sensitizing dye absorbing light via hologram exposure to generate the excited state thereof in accordance with the invention is described in detail hereinbelow.

The sensitizing dye of the invention preferably absorbs any of ultraviolet ray, visible ray, and infrared ray of a wavelength of 200 to 2,000 nm to generate an excited state of the sensitizing dye itself, more preferably absorbs ultraviolet ray or visible ray of a wavelength of 300 to 700 nm to generate an excited state of the sensitizing dye itself, and still more preferably absorbs visible ray of a wavelength of 400 to 700 mm to generate an excited state.

From the standpoints of diffraction efficiency and multiplicity, the sensitizing dye of the invention is preferably a sensitizing dye represented by any one of the formulae (2-1) through (2-5).

In the formulae (2-1) through (2-3), R₁₁, R₁₂, R₁₄, R₁₅, R₁₆ and R₁₇ independently represent hydrogen atom, an alkyl group (an alkyl group with preferably one to 20 carbon atoms, for example methyl, ethyl, n-propyl, isopropyl, n-butyl, n-pentyl, n-octyl, n-octadecyl, benzyl, 2-methoxyethyl, 2-butoxyethyl, 2-(2′-methoxyethoxy)ethyl, 3-sulfopropyl, 4-sulfobutyl, carboxymethyl, 5-carboxypentyl, 2-chloroethyl, 2-cyanoethyl, 2-methylsulfonyl)ethyl, 2-(phenylsulfonyl)ethyl, methoxycarbonylmethyl, 2-(acetyloxy)methyl), an alkenyl group (an alkenyl group with preferably 2 to 20 carbon atoms, for example vinyl, allyl, 2-butenyl, 1,3-butadienyl), a cycloalkyl group (a cycloalkyl group with 3 to 20 carbon atoms, for example cyclopentyl, cyclohexyl), an aryl group (an aryl group with preferably 6 to 20 carbon atoms, for example phenyl, 2-chlorophenyl, 4-methoxyphenyl, 3-methylphenyl, 1-naphthyl, 2-naphthyl).

R₁₁ and R₁₂ represent preferably hydrogen atom, an alkyl group, and an aryl group, more preferably an alkyl group and most preferably ethyl group.

R₁₄ represents preferably hydrogen atom, an alkyl group, and an aryl group, more preferably hydrogen atom or methyl group.

R₁₅ represents preferably hydrogen atom, an alkyl group or an aryl group, more preferably hydrogen atom or phenyl group.

R₁₆ and R₁₇ represent preferably hydrogen atom, an alkyl group and an aryl group, more preferably methyl group or phenyl group and most preferably phenyl group.

In the formulae (2-1) through (2-3), R₁₃ represents an alkyl group, an alkenyl group, a cycloalkyl group or an aryl group (where preferable substituent examples therefor are the same as the examples for R₁₁), preferably an alkyl group.

In the formulae (2-4) and (2-5), R₁₈, R₁₉, R₂₀, R₂₁, R₂₂ and R₂₃ independently represent an alkyl group, an alkenyl group or an aryl group (where preferable substituent examples therefor are the same as the examples for R₁₁), preferably an alkyl group.

Particularly, R₁₈, R₂₀ and R₂₂ are preferably an alkyl group substituted with an electron attractive group.

Herein, the electron attractive group means a substituent with a negative value of the Hammet's σm. The electron attractive group is preferably cyano group, an alkoxycarbonyl group, carbamoyl group, a halogen atom, an alkoxy group, an aryloxy group, an acyloxy group, an alkylsulfonyl group or an arylsulfonyl group, more preferably cyano group, an alkoxycarbonyl group, a halogen atom or an alkoxy group.

R₁₈, R₂₀ and R₂₂ are preferably an alkyl group substituted with such electron attractive group at position α or β. Preferable specific examples thereof are 2-methoxyethyl, 2-butoxyethyl, 2-(2′-methoxyethoxy)ethyl, 2-chloroethyl, 2-cyanoethyl, 2-(methylsulfonyl)ethyl, 2-(phenylsulfonyl)ethyl, methoxycarbonylmethyl, and 2-acetyloxy)methyl. More preferable specific examples thereof are for example 2-methoxyethyl, 2-chloroethyl, 2-cyanoethyl and methoxycarbonylmethyl.

R₁₈ and R₁₉, R₂₀ and R₂₁, or R₂₂ and R₂₃ may bind together to form a ring. The ring to be formed preferably includes pyrrolidine ring, piperidine ring, morpholine ring and piperazine ring.

In the formula (2-5), n1 represents an integer of 0, 1, 3 and 4, preferably 0 or 3 and more preferably 3.

Specific examples of the sensitizing dye represented by any one of the formulae (2-1) through (2-5) are listed below. However, the invention is not limited by the examples.

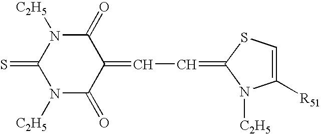

| | R₅₁ |
|---|---|
| SS-1 | —CH₃ |
| SS-2 | —H |
| SS-3 | 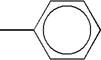 |

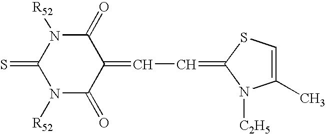

| | R₅₂ |
|---|---|
| SS-4 | —H |
| SS-5 | 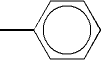 |

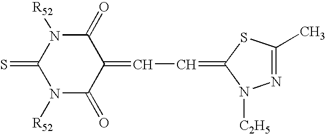

| | R₅₂ |
|---|---|
| SS-6 | —C₂H₅ |
| SS-7 | —H |
| SS-8 | 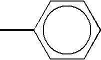 |
| SS-9 | 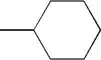 |
| SS-10 | —CH₂CH═CH₂ |

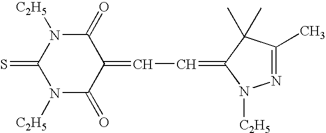

SS-11

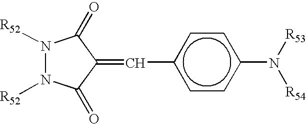

| | R₅₂ | R₅₃ | R₅₄ |
|---|---|---|---|
| SS-12 | 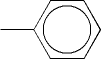 | —CH₃ | —CH₃ |
| SS-13 | ″ | —C₂H₅ | —C₂H₅ |
| SS-14 | ″ | —CH₃ | —CH₂CH₂Cl |
| SS-15 | ″ | —C₂H₅ | —CH₂CH₂CN |
| SS-16 | ″ | —CH₃ | —CH₂COOCH₃ |
| SS-17 | ″ | —C₂H₅ | —CH₂CH₂OCH₃ |
| SS-18 | ″ | —CH₃ | —CH₂CH₂SO₂CH₃ |
| SS-19 | ″ | ″ | 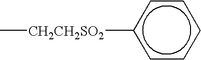 |
| SS-20 | ″ | ″ | —CH₂CH₂OCOCH₃ |
| SS-21 | —CH₃ | ″ | —CH₃ |
| SS-22 | ″ | ″ | —CH₂CH₂Cl |
| SS-23 | —H | ″ | ″ |

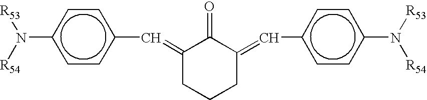

| | R₅₃ | R₅₄ |
|---|---|---|
| SS-24 | —CH₃ | —CH₃ |
| SS-25 | ″ | —CH₂CH₂Cl |
| SS-26 | —C₂H₅ | —C₂H₅ |
| SS-27 | ″ | —CH₂CH₂CN |
| SS-28 | ″ | —CH₂COOCH₃ |
| SS-29 | ″ | CH₂₃COOC₂H₅ |

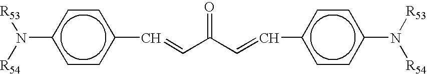

| | R₅₃ | R₅₄ |
|---|---|---|
| SS-30 | —CH₃ | —CH₃ |
| SS-31 | ″ | —CH₂CH₂Cl |
| SS-32 | ″ | —CH₂CH₂CN |
| SS-33 | —CH₂CH₂CN | —CH₂CH₂CN |
| SS-34 | —CH₂COOCH₃ | —CH₂COOCH₃ |

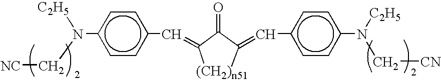

| | n₅₁ |
|---|---|
| SS-35 | 1 |
| SS-36 | 4 |

In case that a sensitizing dye of any of the formulae (2-1) through (2-5) is used in the hologram recording material of the invention, the laser for hologram recording is preferably YAG-SHG laser of 532 nm.

When the hologram recording material of the invention contains an acid generator represented by any one of the formulae (1-1) through (1-6), even a sensitizing dye other than the sensitizing dyes represented by the formulae (2-1) through (2-5) may be satisfactory as the sensitizing dye to be contained in the hologram recording material of the invention. Such sensitizing dye preferably includes cyanine dye, squalirium cyanine dye, styryl dye, pyrilium dye, merocyanine dye, benzylidene dye, oxonol dye, azurenium dye, coumarine dye, keto-coumarine dye, styrylcoumarine dye, pyran dye, xanthene dye, thioxanthene dye, phenothiazine dye, phenoxazine dye, phenazine dye, phthalocyanine dye, azaporphylline dye, porphylline dye, condensed-ring aromatic dyes, perylene dye, azomethine dye, anthraquinone dye, metal complex dyes, and metallocene dye, more preferably cyanine dye, squalirium cyanine dye, pyrilium dye, merocyanine dye, oxonol dye, coumarine dye, keto-coumarine dye, styrylcoumarine dye, pyran dye, xanthene dye, thioxanthene dye, condensed-ring aromatic dyes, metal complex dyes and metallocene dye and still more preferably cyanine dye, merocyanine dye, oxonol dye, metal complex dyes and metallocene dye. As the metal complex dyes, Ru complex dyes are particularly preferable. As the metallocene dye, ferrocenes are particularly preferable.

Additionally, dyes and dyestuffs described in “Sikiso Handbook (Dye Handbook)” (Nobuya O-gawara, ed., Kodansha, 1986), “Kino-sei Sikiso no Kagaku (Chemistry of Functional Dyes)” (Nobuya O-gawara, ed., CMC, 1981), “Tokushu Kino Zairyo (Materials with Unique Functions)”, (Chuzaburo Ikemori, et al., ed., CMC, 1986) may also be used as the sensitizing dye of the invention. Additionally, the sensitizing dye of the invention is not limited to them. Any dye and any dyestuff with optical absorption in a visible ray region may also be used. These sensitizing dyes can be selected in a manner suitably for the wavelength of a laser as a light source, depending on the object of the use. Depending on the use, two or more types of sensitizing dyes may be used in combination. Specific examples of the sensitizing dye of the invention are described below. However, the invention is not limited by them.

<Cyanine dyes>
S-1

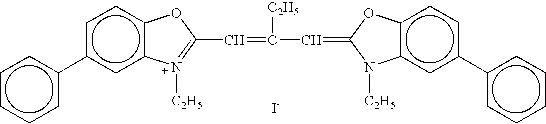

S-2

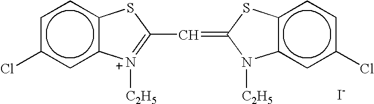

S-3

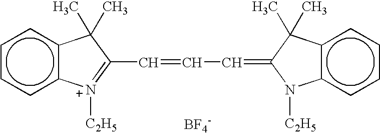

S-4

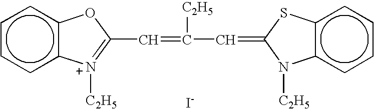

S-5

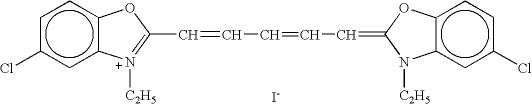

S-6

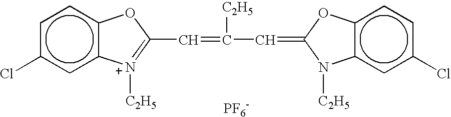

S-7

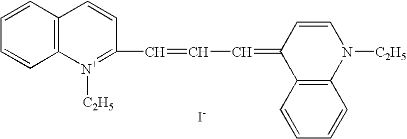

S-8

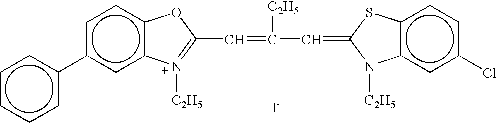

S-9

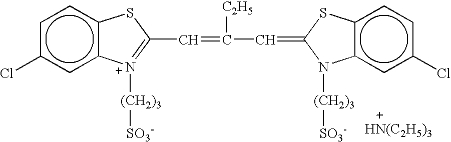

S-10

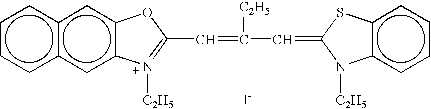

S-11

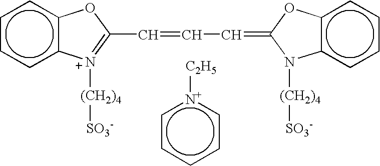

<Squalirium dyes>
S-12

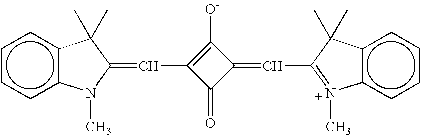

S-13

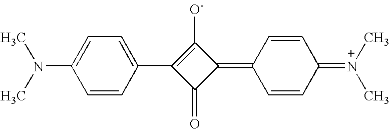

<Styryl dyes>
S-14

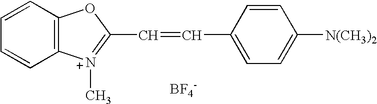

S-15

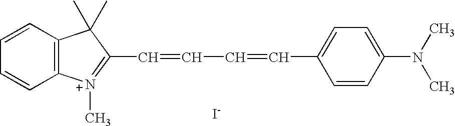

<Pyrilium dyes>
S-16

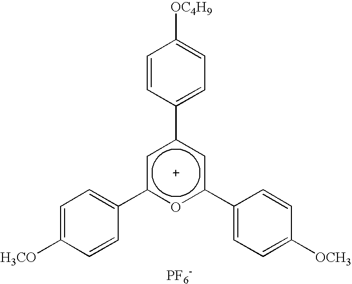

S-17

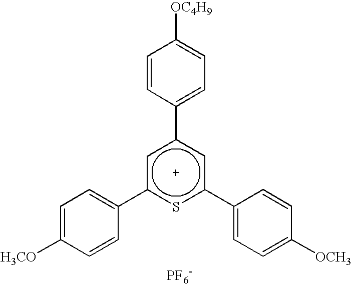

<Merocyanine dyes>

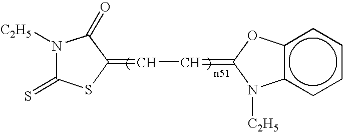

| | n51 |
|---|---|
| S-18 | 0 |
| S-19 | 1 |
| S-20 | 2 |

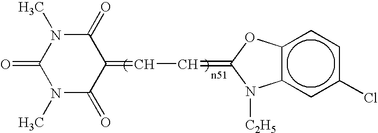

| | n51 |
|---|---|
| S-21 | 1 |
| S-22 | 2 |

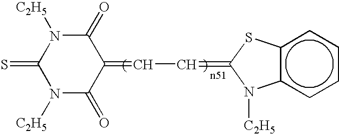

| | n51 |
|---|---|
| S-23 | 1 |
| S-24 | 2 |

| | Q₅₁═CH—CH═Q₅₂ | |
|---|---|---|
| | Q₅₁ | Q₅₂ |
| S-25 | 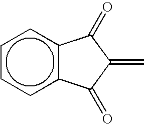 | 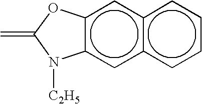 |
| S-26 | 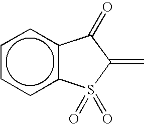 | 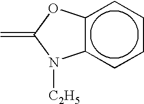 |
| S-27 | 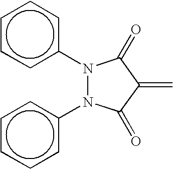 | 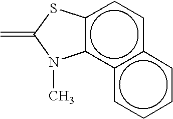 |
| S-28 | 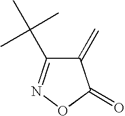 | 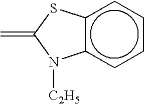 |
| S-29 | 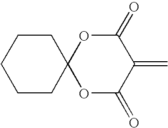 | 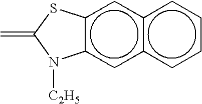 |

S-30

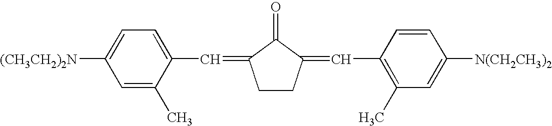

S-31

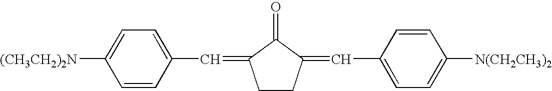

S-32

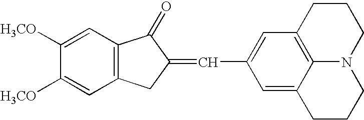

S-33

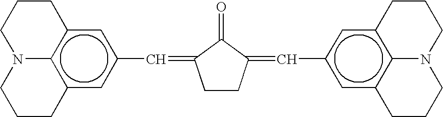

S-34

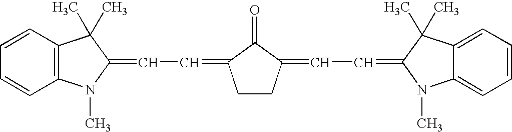

S-35

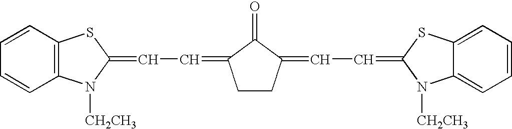

S-36

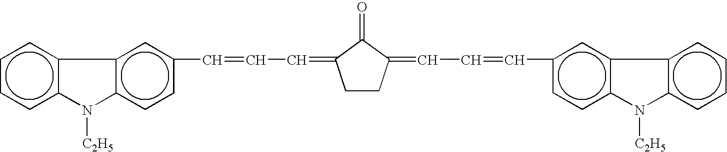

<Arylidene dyes>
S-37

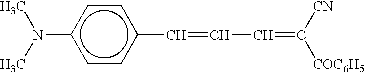

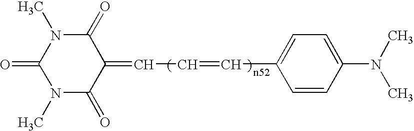

| | n52 |
|---|---|
| S-38 | 0 |
| S-39 | 1 |

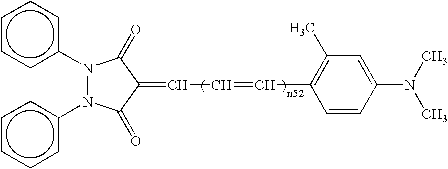

| | n52 |
|---|---|
| S-40 | 0 |
| S-41 | 1 |

<Oxonol dyes>

| | Q₅₂═CHCH═CHₙ₅₃Q₅₃ Cl | | | |
|---|---|---|---|---|
| | Q₅₂ | Q₅₃ | n₅₃ | Cl |
| S-42 | 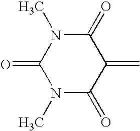 | 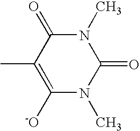 | 2 | H⁺ |
| S-43 | 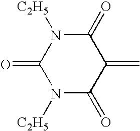 | 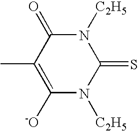 | 1 | 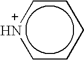 |
| S-44 | 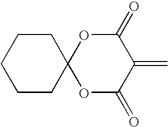 | 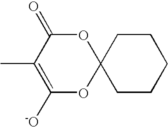 | 2 | H⁺ |
| S-45 | 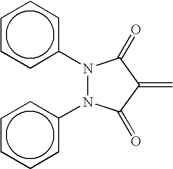 | 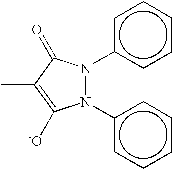 | 1 | H⁺ |
| S-46 | 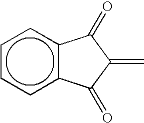 | 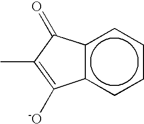 | 1 | HN⁺(C₂H₅)₃ |

<Azurenium dyes>
S-47

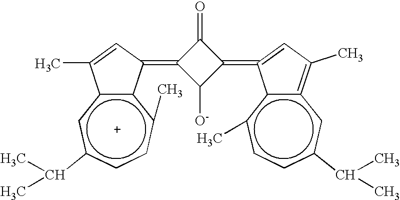

<Coumarine dyes>
S-48

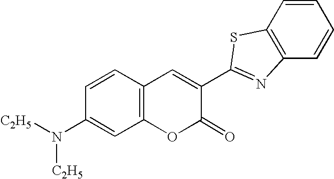

S-49

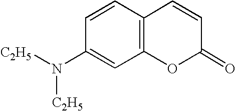

<Keto-coumarine dyes>
S-50

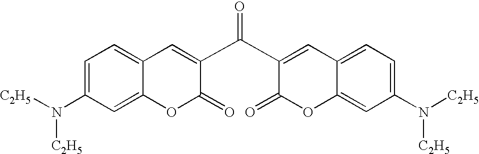

S-51

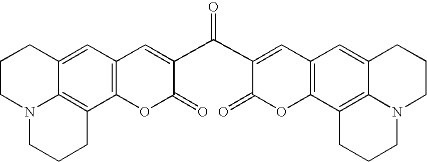

<Styrylcoumarine dyes>
S-52

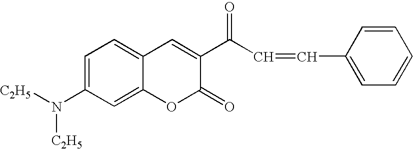

S-53

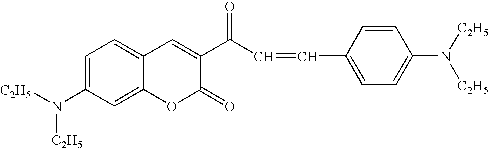

<Pyran dyes>

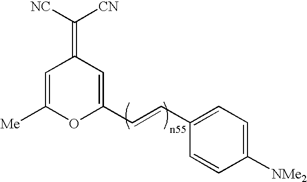

| | n55 |
|---|---|
| S-54 | 1 |
| S-55 | 2 |
| S-56 | 3 |

<Xanthene dyes>
S-57

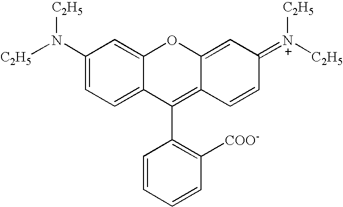

S-58

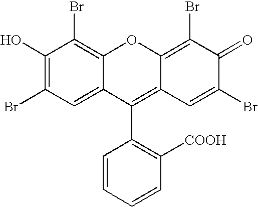

<Thioxanthene dyes>
S-59

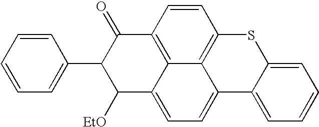

<Phenothiazine dyes>
S-60

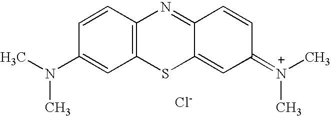

<Phenoxazine dyes>
S-61

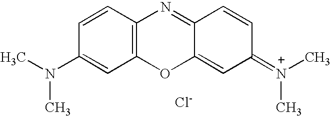

<Phenazine dyes>
S-62

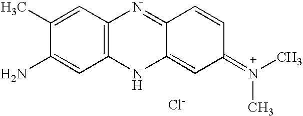

<Phthalocyanine dyes>
S-63

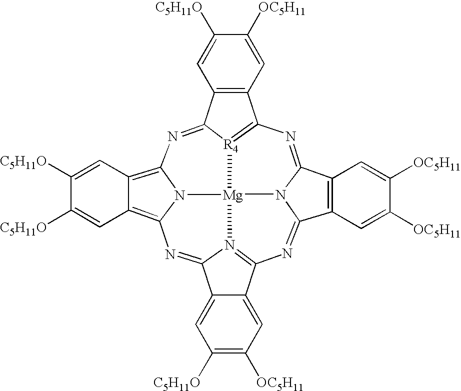

<Azaporphylline dyes>
S-64

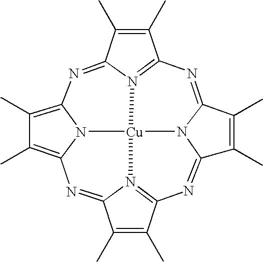

<Porphylline dyes>
S-65

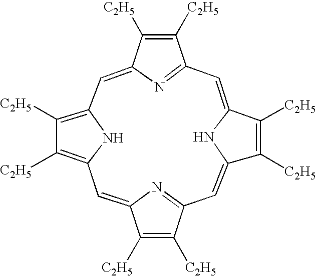

<Condensed-ring aromatic dyes>
S-66

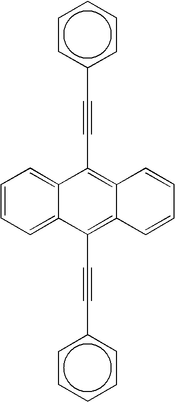

S-67

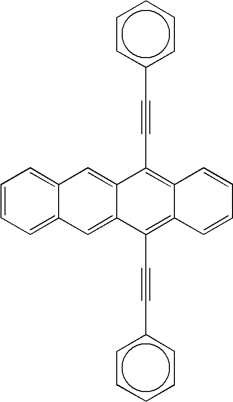

<Perylene dyes>
S-68

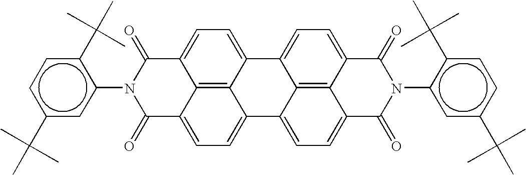

<Azomethine dyes>
S-69

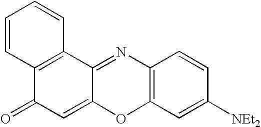

<Anthraquinone dyes>
S-70

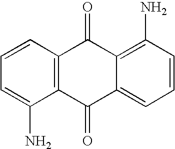

<Metal complex dyes>
S-71

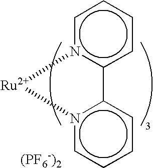

S-72

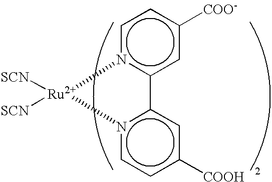

S-73

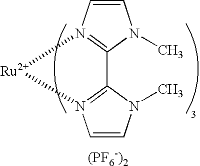

S-74

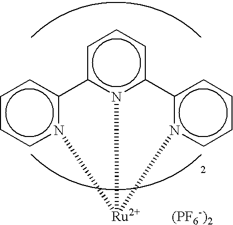

S-75

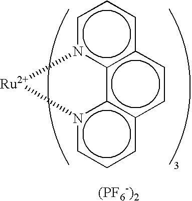

S-76

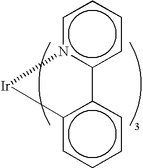

S-77

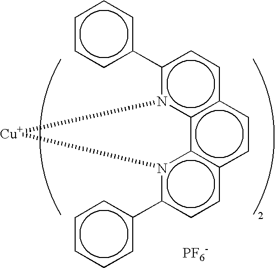

S-78

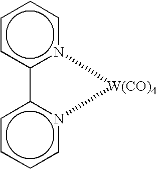

S-79

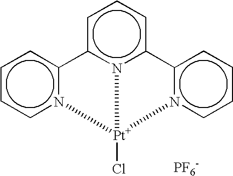

S-80

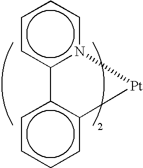

<Metallocene dyes>
S-81

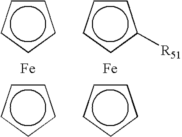

| | R₅₁ |
|---|---|
| S-82 | —CHO |
| S-83 | —CH₂CH₂COOH |
| S-84 | —CH₂CH₂COOCH₃ |
| S-85 | 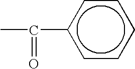 |
| S-86 | —CH₂OH |
| S-87 | —COOCH₃ |

S-88

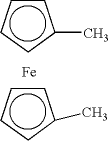

S-89

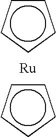

S-90

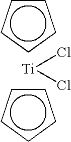

<Cyanine dyes>

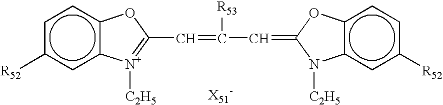

| | R₅₂ | R₅₃ | X₅₁⁻ |
|---|---|---|---|
| S-91 | —Cl | —H | I⁻ |
| S-92 | —H | —C₂H₅ | ″ |
| S-93 | ″ | —H | ″ |
| S-94 | ″ | ″ | PF₆⁻ |
| S-95 | —Br | ″ | BF₄⁻ |
| S-96 | —CH₃ | ″ | I⁻ |
| S-97 | —OCH₃ | —C₂H₅ | PF₆⁻ |

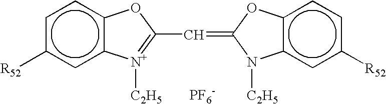

| | R₅₂ |
|---|---|
| S-98 | —H |
| S-99 | —Cl |
| S-100 | —Ph |
| S-101 | —CH₃ |
| S-102 | —OCH₃ |

S-103

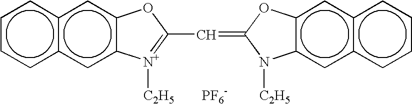

S-104

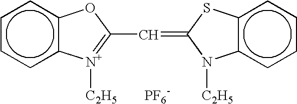

Because the hologram recording material is used at a state with a large film thickness, through which recording light should mostly transmit, the molar absorption coefficient of a sensitizing dye in the wavelength for hologram exposure gets smaller to raise the amount of the sensitizing dye to be added as much as possible, preferably for high sensitization. The molar absorption coefficient thereof in the wavelength for hologram exposure is preferably 1 or more to 10,000 or less, more preferably 1 or more to 5,000 or less, still more preferably 5 or more to 2,500 or less and most preferably 10 or more to 1,000 or less.

The transmittance of the light in the recording wavelength through the hologram recording material is preferably 10 to 99%, more preferably 20 to 95%, still more preferably 30 to 90%, and most preferably 40 to 85% in terms of diffraction efficiency, sensitivity, and recording density (multiplicity). Thus, the molar absorption coefficient of the sensitizing dye in the recording wavelength and the molar concentration thereof to be added are preferably adjusted in a manner suitable for the film thickness of the hologram recording material, to attain the transmittance.

Additionally, preferably, the sensitizing dye is with λmax in a shorter wavelength than the wavelength for hologram recording. More preferably, λmax is within a wavelength range of the wavelength for hologram recording to a wavelength shorter by 100 nm than the wavelength for hologram recording.

The molar absorption coefficient of the sensitizing dye in the recording wavelength is preferably ⅕-fold or less, more preferably 1/10-fold or less the molar absorption coefficient at λmax. When the sensitizing dye is an organic dye such as cyanine dye and merocyanine dye, in particular, the molar absorption coefficient thereof is preferably 1/20-fold or less, more preferably 1/50-fold or less, most preferably 1/100-fold or less.

When the wavelength for hologram recording is YAG-SHG laser at 532 nm, the sensitizing dye is particularly preferably trimethine cyanine dye with benzoxazole ring, merocyanine dye with barbiturate-like nucleus, benzylidene dye with pyrazolidinedioate-like nucleus, Ru complex dye, and ferrocenes. For GaN and InGaN lasers at 400 to 415 nm, monomethine cyanine dye with benzoxazole ring, merocyanine dye, Ru complex dye and ferrocenes are particularly preferable.

Preferable examples of the sensitizing dye of the invention are additionally described in JP-A-2005-99751. The sensitizing dye of the invention may be commercially available or synthetically prepared by known methods.

For recording interference fringes via polymerization reaction, preferably, a binder has a refractive index different from that of a polymerizable compound. So as to raise refractive index modulation, the difference in refractive index between the polymerizable compound in bulk and the binder in bulk is preferably larger. The difference in refractive index is preferably 0.01 or more, more preferably 0.05 or more and still more preferably 0.1 or more.

Thus, preferably, either one of the polymerizable compound and the binder contains at least one aryl group, aromatic heterocyclic group, chlorine atom, bromine atom, iodine atom and sulfur atom, while the remaining one thereof never contains any of them. It does not matter which one of the polymerizable compound and the binder has a larger refractive index.

In accordance with the invention, the polymerizable compound means a compound addition-polymerizable via radicals or acids (Brønsted's acids or Lewis' acids) or bases (Brønsted's bases or Lewis' bases) generated via photo-irradiation on the sensitizing dye (or a color developing substance) and a polymerization initiator, to be prepared as an oligomer or a polymer.

The polymerizable compound of the invention may be monofunctional or polyfunctional or may comprise one compound or plural components or maybe a monomer, a prepolymer (for example, a dimer, and an oligomer) or a mixture thereof. Preferably, the polymerizable compound is a monomer.

Additionally, the polymerizable compound may be in the form of liquid or solid at ambient temperature.

The polymerizable compound of the invention is broadly grouped in radical-polymerizable compounds and cation- or anion-polymerizable compounds.

Preferable examples of the polymerizable compounds grouped into radical-polymerizable compounds and cation- or anion-polymerizable compounds are individually described below, where A) the polymerizable compounds have larger refractive indices than those of binders or B) binders have larger refractive indices than those of the polymerizable compounds.

### A) Preferable Examples of Radical-Polymerizable Compounds Where the Radical-Polymerizable Compounds Have Larger Refractive Indices Than Those of Binders.

In this case, the radical-polymerizable compounds have preferably larger refractive indices. The radical-polymerizable compounds with larger refractive indices are preferably compounds having at least one ethylenic unsaturated double bond within the molecule and containing at least one aryl group, aromatic heterocyclic group, chlorine atom, bromine atom, iodine atom and sulfur atom. Additionally, the compounds are in the form of liquid with boiling points of 100° C. or more.

Specifically, the radical-polymerizable compounds include the following polymerizable monomers and prepolymers (dimers, oligomers, etc.) comprising the monomers.

The radical-polymerizable monomers with high refractive indices preferably include styrene, 2-chlorostyrene, 2-bromostyrene, methoxystyrene, phenyl acrylate, p-chlorophenyl acrylate, 2-phenylethyl acrylate, 2-phenoxyethyl acrylate, 2-phenoxyethyl methacrylate, 2-p-chlorophenoxy)ethyl acrylate, benzyl acrylate, 2-(1-naphthyloxy)ethyl acrylate, 2,2-di(p-hydroxyphenyl)propane diacrylate or 2,2-di(p-hydroxyphenyl)propane methacrylate, di(2-methacryloxyethyl) ether of bisphenol A, di(2-acryloxyethyl) ether of bisphenol A, di(2-methacryloxyethyl) ether of tetrachloro-bisphenol A, di(2-methacryloxyethyl) ether of tetrabromo-bisphenol A, 1,4-benzenediol dimethacrylate, and 1,4-diisopropenylbenzene, more preferably 2-phenoxyethyl acrylate, 2-phenoxyethyl methacrylate, 2-(p-chlorophenoxy)ethyl acrylate, p-chlorophenyl acrylate, phenyl acrylate, 2-phenylethyl acrylate, di(2-acryloxyethyl) ether of bisphenol A, and 2-(1-naphthyloxy)ethyl acrylate.

The polymerizable compound is preferably a liquid and may be used in mixture with a second polymerizable compound in solid, such as N-vinylcarbazole, 2-naphthyl acrylate, pentachlorophenyl acrylate, 2,4,6-tribromophenyl acrylate, bisphenol A diacrylate, 2-(2-naphthyloxy)ethyl acrylate and N-phenylmaleimide.

### B) Preferable Examples of Radical-Polymerizable Compounds Where Binders Have Larger Refractive Indices Than Those of the Radical-Polymerizable Compounds.

In this case, the radical-polymerizable compounds have preferably smaller refractive indices. The radical-polymerizable compounds with smaller refractive indices are preferably compounds having at least one ethylenic unsaturated double bond within the molecule and absolutely never containing any aryl group, aromatic heterocyclic group, chlorine atom, bromine atom, iodine atom and sulfur atom.

Additionally, the compounds are in the form of liquids with boiling points of 100° C. or more.

Specifically, the radical-polymerizable compounds include the following polymerizable monomers and prepolymers (dimers, oligomers, etc.) comprising the monomers.

The radical-polymerizable monomers with smaller refractive indices include preferably t-butyl acrylate, cyclohexyl acrylate, iso-bornyl acrylate, 1,5-pentandiol diacrylate, ethylene glycol diacrylate, 1,4-butanediol diacrylate, diethylene glycol diacrylate, hexamethylene glycol diacrylate, 1,3-propanediol diacrylate, decamethylene glycol diacrylate, 1,4-cyclohexyldiol diacrylate, 2,2-dimethylol propane diacrylate, glycerol diacrylate, trimethylol propane diacrylate, pentaerythritol triacrylate, pentaerythritol tetraacrylate, triethylene glycol diacrylate, triethylene glycol dimethacrylate, ethylene glycol dimethacrylate, 1,3-propanediol dimethacrylate, 1,2,4-butanetriol trimethacrylate, 2,2,4-trimethyl-1,3-propanediol dimethacrylate, pentaerythritol trimethacrylate, pentaerythritol tetramethacrylate, trimethylol propane trimethacrylate, 1,5-pentanediol dimethacrylate, diallyl fumarate, 1H,1H-perfluorooctyl acrylate, 1H,1H,2H,2H-perfluoroctyl methacrylate, 1H,1H,2H,2H-perfluorooctyl acrylate, and 1-vinyl-2-pyrrolidinone, more preferably decanediol diacrylate, iso-bornyl acrylate, triethylene glycol diacrylate, diethylene glycol diacrylate, triethylene glycol dimethacrylate, ethoxyethoxyethyl acrylate, ethoxylated trimethylol propane triacrylate ester, and 1-vinyl-2-pyrrolidine, and still more preferably decanediol diacrylate, iso-bornyl acrylate, triethylene glycol diacrylate, diethylene glycol diacrylate, triethylene glycol dimethacrylate, ethoxyethoxyethyl acrylate, 1H,1H-perfluorooctyl acrylate, 1H,1H,2H,2H-perfluorooctyl methacrylate, 1H,1H,2H,2H-perfluorooctyl acrylate, and 1-vinyl-2-pyrrolidine.

Preferably, the polymerizable compound is a liquid and may be used in mixture with a polymerizable monomer compound in solid, for example N-vinylcaprolactam.

The cation-polymerizable compound of the invention is a compound of which the polymerization is initiated with an acid generated from photo-irradiation on a sensitizing dye and a cation polymerization initiator, while the anion-polymerizable compound of the invention is a compound of which the polymerization is initiated with a base generated from photo-irradiation on a sensitizing dye and an anion polymerization initiator.

The cation-polymerizable compound of the invention preferably includes compounds with at least one oxirane ring, oxetane ring, vinyl ether group, styryl group, or N-vinylcarbazole moiety within the molecule. Preferably, the cation-polymerizable compound of the invention preferably includes compounds with two oxirane rings, oxetane rings, vinyl ether groups, styryl groups, or N-vinylcarbozole moieties within the molecule. More preferably, the cation-polymerizable compound of the invention preferably includes compounds with oxirane ring moieties.

The anion-polymerizable compound of the invention includes preferably compounds with at least one oxirane ring, oxetane ring, vinyl ether group, styryl group, N-vinylcarbazole moiety, ethylenic double bond moiety with an electron attractive substituent, lactone moiety, lactam moiety, cyclic urethane moiety, cyclic urea moiety or cyclic siloxane moiety within the molecule. Preferably, the anion-polymerizable compound of the invention is a compound with oxirane ring moiety.

### A) Preferable Examples of the Cation- or Anion-Polymerizable Compounds Provided That the Refractive Indices of the Polymerizable Compounds are Larger Than the Refractive Indices of Binders.

In this case, the cation- or anion-polymerizable compounds have preferably larger refractive indices. The cation- or anion-polymerizable compounds with larger refractive indices in accordance with the invention are preferably compounds having at least one, preferably two oxirane rings, oxetane rings, vinyl ether groups, styryl groups, or N-vinylcarbozole moieties within the molecule and additionally containing at least one aryl group, aromatic heterocyclic group, chlorine atom, bromine atom, iodine atom and sulfur atom. Additionally, the compounds more preferably contain at least one aryl group.

Specifically, the cation- or anion-polymerizable compounds include the following polymerizable monomers and prepolymers (dimers, oligomers, etc.) comprising the monomers.

The cation- or anion-polymerizable monomers with oxirane ring and with larger refractive indices preferably include for example phenyl glycidyl ether, phthalic acid diglyciyl ether, trimellitic acid triglycidyl ester, resorcin diglycidyl ether, dibromophenyl glycidyl ether, dibromoneopentyl glycol diglyciyl ether, 4,4′-bis(2,3-epoxypropoxyperfluoroisopropyl)diphenyl ether, p-bromostyrene oxide, bis(4-glycidyloxyphenyl)methane, bisphenol A-diglycidyl ether, tetrabromobisphenol-A-diglycidyl ether, bisphenol-F-diglycidyl ether, and 1,3-bis(3′,4′-epoxycyclohexyl)ethyl-1,3-diphenyl-1,3-dimethyldisiloxane.

Specific examples of the cation- or anion-polymerizable monomers with large refractive indices and with oxetane ring are compounds prepared by substituting the glycidyl group “1” in the specific examples of the cation-polymerizable monomers having such glycidyl group “1” as an oxirane ring, with the group “2” containing oxetane ring.

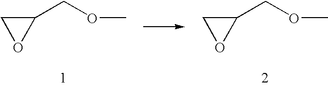

Additionally, the cation- or anion-polymerizable monomers with large refractive indices preferably include the following compounds.

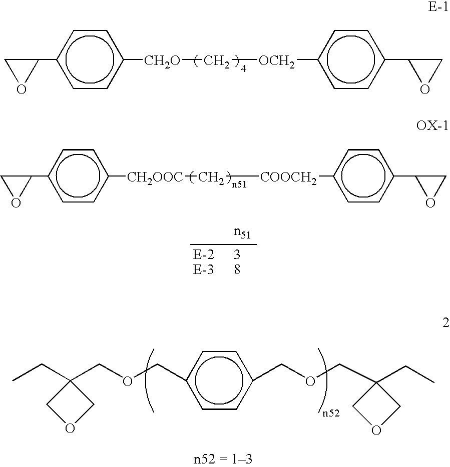

Herein, the combined use of such monomers with oxirane ring and such monomers with oxetane ring is also satisfactory. In that case, preferably, the monomers with oxetane ring are added at a ratio of 5 to 95% by mass to the monomers with oxirane ring.

Specific examples of the cation- or anion-polymerizable monomers with vinyl ether group moiety and with large refractive indices include for example vinyl-2-chloroethyl ether, 4-vinyl ether styrene, hydroquinone divinyl ether, phenyl vinyl ether, bisphenol A divinyl ether, tetrabromobisphenol A divinyl ether, bisphenol F divinyl ether, phenoxyethylene vinyl ether, and p-bromophenoxyethylene vinyl ether.

Additionally, styrene and styrenic monomers such as 2-chlorostyrene, 2-bromostyrene and methoxystyrene as well as N-vinylcarbazole is also preferable as the cation-polymerizable monomers with large refractive indices.

### B) Preferable Examples of the Cation- or Anion-Polymerizable Compounds Provided That the Refractive Indices of Binders are Larger Than the Refractive Indices of the Polymerizable Compounds.

In this case, the cation- or anion-polymerizable compounds have preferably smaller refractive indices. The cation- or anion-polymerizable compounds with smaller refractive indices in accordance with the invention are preferably compounds having at least one, preferably two oxirane rings, oxetane rings, or vinyl ether groups within the molecule but absolutely never containing aryl group, aromatic heterocyclic ring, chlorine atom, bromine atom, iodine atom, or sulfur atom. The cation- or anion-polymerizable compounds arc preferably liquids with boiling points of 100° C. or more.

Specifically, the cation- or anion-polymerizable compounds include the following polymerizable monomers and prepolymers (dimers, oligomers, etc.) comprising the monomers.

Specific examples of the cation- or anion-polymerizable monomers with oxirane ring and with small refractive indices preferably include for example glycerol glycidyl ether, glycerol triglycidyl ether, pentaerythritol polyglycidyl ether, trimethylol propane triglycidyl ether, 1,6-hexanediol diglycidyl ether, propylene glycol diglycidyl ether, ethylene glycol monoglycidyl ether, propylene glycol diglycidyl ether, neopentyl glycol diglycidyl ether, adipic acid diglycidyl ester, 1,2,7,8-diepoxyoctane, 1,6-dimethylol perfluorohexane diglycidyl ether, vinylcyclohexene dioxide, 3,4-epoxycyclohexyloxirane, bis(3,4-epoxycyclohexyl)adipate, 2,2-bis(4-(2,3-epoxypropoxy)cyclohexyl)propane, 2,2-bis(4-(2,3-epoxypropoxy)cyclohexyl)hexafluoropropane, 2-(3,4-epoxycyclohexyl)-3′,4′-epoxy-1,3-dioxane-5-spirocyclohexane, 1,2-ethylenedioxy-bis(3,4-epoxycyclohexylmethane), ethylene glycol-bis(3,4-epoxycyclohexane carboxylate), bis(3,4-epoxycyclohexylmethyl)adipate, di-2,3-epoxycyclopentyl ether, vinyl glycidyl ether, allyl glycidyl ether, 2-ethylhexyl glycidyl ether, and 1,3-bis(3′,4′-epoxycyclohexyl)ethyl-1,1,3,3-tetramethyldisiloxane.

Specific examples of the cation-polymerizable monomers with small refractive indices and with oxetane ring are compounds prepared by substituting the glycidyl group “1” in the specific examples of the cation-polymerizable monomers with small refractive indices and with such glycidyl group “1” as an oxirane ring, with the group “2” containing oxetane ring.

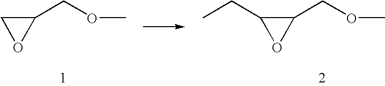

Additionally, the cation-polymerizable monomers with small refractive indices preferably include the following compounds.

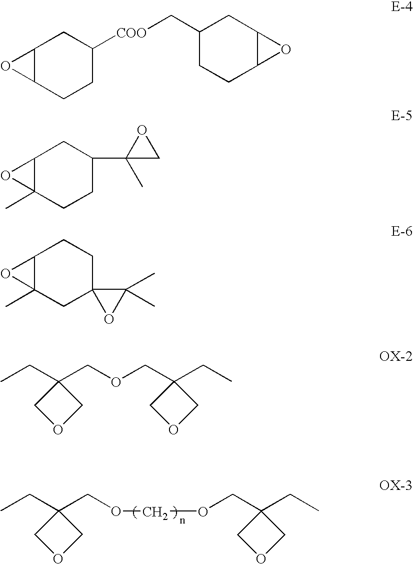

Herein, the combined use of such monomers with oxirane ring and such monomers with oxetane ring is also satisfactory. In that case, preferably, the monomers with oxetane ring are added at a ratio of 5 to 95% by mass to the monomers with oxirane ring.

Specific examples of the cation- or anion-polymerizable monomers with vinyl ether group moiety and with small refractive indices include for example vinyl-n-butyl ether, vinyl-t-butyl ether, ethylene glycol divinyl ether, ethylene glycol monovinyl ether, propylene glycol divinyl ether, neopentyl glycol divinyl glycol, glycerol divinyl ether, glycerol trivinyl ether, triethylene glycol divinyl ether, trimethylol propane monovinyl ether, trimethylol propane divinyl ether, trimethylol propane trivinyl ether, allyl vinyl ether, 2,2-bis(4-cyclohexanol)propane divinyl ether, and 2,2-bis(4-cyclohexanol)trifluoropropane divinyl ether.

Preferable binders for recording interference fringes via polymerization reaction in accordance with the invention are described below in the following cases; A) the refractive indices of polymerizable compounds are larger than the refractive indices of binders and B) the refractive indices of binders are larger than the refractive indices of polymerizable compounds.

### A) Preferable Binder Examples When the Refractive Indices of Polymerizable Compounds are Larger Than the Refractive Indices of Binders.

In this case, the binders have preferably small refractive indices. The binders are preferably binders absolutely never containing aryl group, aromatic heterocyclic group, chlorine atom, bromine atom, iodine atom or sulfur atom.

Specific examples of the binders with small refractive indices include acrylate and alpha-alkyl acrylate ester and acid polymers and inter-polymers (for example, polymethyl methacrylate and polyethyl methacrylate, copolymers of methyl methacrylate with other (metha)acrylate alkyl esters), polyvinyl ester (for example, vinyl polyacetate, polyacetic acid/vinyl acrylate, polyacetic acid/vinyl methacrylate and polyvinyl acetate of hydrolysis type), ethylene/vinyl acetate copolymer, saturated and unsaturated polyurethane, butadiene and isoprene polymers and copolymers and high-molecular polyethylene oxide of polyglycol of a weight average molecular weight of 4,000 to 1,000,000, epoxylated products (for example, epoxylated products with acrylate- or methacrylate group), polyamide (for example, N-methoxymethyl polyhexamethylene adipamide), cellulose ester (for example, cellulose acetate, cellulose acetate succinate and cellulose acetate butylate), cellulose ether (for example, methyl cellulose, ethyl cellulose, ethylbenzyl cellulose), polycarbonate, polyvinyl acetal (for example, polyvinyl butyral and polyvinyl formal), polyvinyl alcohol, and polyvinyl pyrrolidone.

Additionally, fluorine atom-containing polymers are also preferable as the binders with small refractive indices. Preferably, the binders are polymers containing fluoro-olefin as the essential component and being soluble in organic solvents containing one or two or more unsaturated monomers selected from alkyl vinyl ether, alicyclic vinyl ether, hydroxyvinyl ether, olefin, halo-olefin, unsaturated carboxylic acid and esters thereof, and carboxylate vinyl ester as the copolymerizable components. Preferably, the binders are of a weight average molecular weight of 5,000 to 200,000 and at a fluorine atom content of 5 to 70% by mass.

Specific examples of the fluorine atom-containing polymers are for example “Lumiflon” series soluble in organic solvents with hydroxyl group (for example, Lumiflon LF200 with a weight average molecular weight of about 50,000, manufactured by Asahi Glass Co., Ltd.). Additionally, fluorine atom-containing polymers soluble in organic solvents are commercially available from Daikin Kogyo Kabushiki Kaisha, Central Glass Co., Ltd. and Penwalt Glass Corporation. These may also be used.

Additionally, silicone compounds such as poly(dimethyl siloxane) and silicone oil never containing aromatic compounds are also listed as the preferable examples.

Besides, epoxy oligomer compounds never containing aromatic compounds may be used as the reactive binders with small refractive indices.

### B) Preferable Binder Examples When the Refractive Indices of Binders are Larger Than the Refractive Indices of Polymerizable Compounds.

In this case, the binders have preferably larger refractive indices. The binders are preferably binders containing at least one aryl group, aromatic heterocyclic group, chlorine atom, bromine atom, iodine atom or sulfur atom. Preferably, the binders are binders containing aryl group.

Specific examples of the binders with large refractive indices include for example polystyrene polymers, and copolymers thereof with for example acrylonitrile, maleic anhydride, acrylic acid, methacrylic acid and esters thereof, vinylidene chloride copolymers (for example, vinylidene chloride/acrylonitrile copolymer, vinylidene chloride/methacrylate copolymer, vinylidene chloride/vinyl acetate copolymer), polyvinyl chloride and copolymers thereof (for example, polyvinyl chloride/acetate copolymer, vinyl chloride/acrylonitrile copolymer), polyvinyl benzene synthetic rubbers (for example, butadiene/acrylonitrile copolymer, acrylonitrile/butadiene/styrene copolymer, methacrylate/acrylonitrile/butadiene/styrene copolymer, 2-chlorobutadiene-1,3 polymer, chlorinated rubber, styrene/butadiene/styrene block copolymer, styrene/isoprene/styrene block copolymer), polymethylene glycol of copolyesters (for example, polymethylene glycol of the formula HO(CH₂)nOH (in the formula, n is an integer, of 2 to 10), and products produced from (1) hexahydroterephthalic acid, sebacic acid and terephthalic acid, (2) terephthalic acid, isophthalic acid and sebasic acid, (3) terephthalic acid and sebacic acid, (4) terephthalic acid and isophthalic acid, and (5) a mixture of the glycol and a copolyester produced from (i) terephthalic acid, isophthalic acid and sebasic acid, and (ii) terephthalic acid, isophthalic acid, sebasic acid and adipic acid, poly(N-vinylcarbazole) and copolymers thereof, and polycarbonates comprising carbonate esters and bisphenol.

Additionally, for example, siloxane compounds such as polymethylphenylsiloxane and 1,3,5-trimethyl-1,1,3,5,5-pentaphenyltrisiloxane, and silicone oil containing a large amount of aromatic compounds are also preferable examples thereof.

Besides, epoxy oligomer compounds containing a great amount of aromatic compounds may also be used as the reactive binders with large refractive indices.

The acid generator (cation polymerization initiator) for use as the hologram recording material of the invention is preferably a sulfonium salt-series acid generator represented by the formula (1-1) or (1-2) in terms of storability. Additionally, the sulfonium salt-series acid generator represented by the formula (1-1) or (1-2) may also function as the radical polymerization initiator.

In the formula (1-1), R₁, R₂ and R₃ independently represent an electron attractive substituent. Herein, die electron attractive substituent means a substituent with a negative value as the Hammet's σm. Preferable examples of the substituent for R₁, R₂ and R₁ include for example alkyl groups substituted with electron attractive groups (preferably C1 to C20 alkyl groups, including for example trifluoromethyl, pentafluoroethyl), heterocyclic groups (preferably C1 to C20 heterocyclic groups, including for example pyridyl, pyrimidyl, triazyl, thienyl, furyl, thiazolyl, imidazolyl, pyrrolyl, pyrazolyl), halogen atoms (for example F, Cl, Br, I), cyano group, nitro group, carboxyl group, sulfo group, phosphonate group, acyl groups (preferably C1 to C20 acyl groups including for example acetyl, benzoyl, salicyloyl, pivaloyl), alkylsulfonyl groups (preferably C1 to C20 alkylsulfonyl groups including for example methanesulfonyl, butanesulfonyl), arylsulfonyl groups (preferably C6 to C20 arylsulfonyl groups including for example benzenesulfonyl, p-toluenesulfonyl), sulfamoyl group (preferably C0 to C20 sulfamoyl groups including for example sulfamoyl, N-methylsulfamoyl, N-phenylsulfamoyl, N,N-diethylsulfamoyl), carbamoyl groups (preferably C1 to C20 carbamoyl groups including for example carbamoyl, N-methylcarbamoyl, N,N-dimethylcarbamoyl, N-phenylcarbamoyl), or alkoxycarbonyl groups (preferably C2 to C20 alkoxycarbonyl groups including for example methoxycarbonyl, phenoxycarbonyl). The substituent includes more preferably halogen-substituted alkyl groups, heterocyclic groups, halogen atoms, cyano group, alkylsulfonyl groups, arylsulfonyl groups, or sulfamoyl groups. Still more preferably, the substituent is a halogen atom, trifluoromethyl group or cyano group. The substituent is most preferably chlorine atom.

In the formula (1-2), R₄, R₅ and R₆ independently represent a substituent. Preferable examples of the substituent include alkyl groups (preferably C1 to C20 alkyl groups such as methyl, ethyl, n-propyl, isopropyl, n-butyl, n-pentyl, benzyl, 2-butoxyethyl, 2-(2′-methoxyethoxy)ethyl, 3-sulfopropyl, 4-sulfobutyl, carboxymethyl, 5-carboxypentyl), alkenyl groups (preferably C2 to C20 alkenyl groups such as vinyl, allyl, 2-butenyl, 1,3-butadienyl), cycloalkyl groups (preferably C3 to C20 cycloalkyl groups such as cyclopentyl, cyclohexyl), aryl groups (preferably C6 to C20 aryl groups for example phenyl, 2-chlorophenyl, 4-methoxyphenyl, 3-methylphenyl, 1-naphthyl), heterocyclic groups (preferably C1 to C20 heterocyclic groups such as pyridyl, thienyl, furyl, thiazolyl, imidazolyl, pyrrolyl, pyrazolyl, pyrrolidino, piperidino, morpholino), alkynyl groups (preferably C2 to C20 alkynyl groups such as ethynyl, 2-propinyl, 1,3-butadienyl, 2-phenylethynyl), halogen atoms (for example, F, Cl, Br, I), amino groups (preferably C0 to C20 amino groups such as amino, dimethylamino, diethylamino, dibutylamino, anilino), cyano group, nitro group, hydroxyl group, mercapto group, carboxyl group, sulfo group, phosphonate group, acyl groups (preferably C1 to C20 acyl groups such as acetyl, benzoyl, salicyloyl, pivaloyl), alkoxy groups (preferably C1 to C20 alkoxy groups such as methoxy, butoxy, cyclohexyloxy), aryloxy groups (preferably C6 to C26 aryloxy groups such as phenoxy, 1-naphthoxy), alkylthio groups (preferably C1 to C20 alkylthio groups such as methylthio, ethylthio), arylthio groups (preferably C6 to C20 arylthio groups such as phenylthio, 4-chlorophenylthio), alkylsulfonyl groups (preferably C1 to C20 alkylsulfonyl groups such as methanesulfonyl, butanesulfonyl), arylsulfonyl groups (preferably C6 to C20 arylsulfonyl groups such as benzenesulfonyl, p-toluenesulfonyl), sulfamoyl groups (preferably C0 to C20 sulfamoyl groups such as sulfamoyl, N-methylsulfamoyl, N-phenylsulfamoyl), carbamoyl groups (preferably C1 to C20 carbamoyl groups, such as carbamoyl, N-methylcarbamoyl, N,N-dimethylcarbamoyl, N-phenylcarbamoyl), acylamino groups (preferably C1 to C20 acylamino groups such as acetylamino, benzoylamino), imino groups (preferably C2 to C20 imino groups such as phthalimino), acyloxy groups (preferably C1 to C20 acyloxy groups such as acetyloxy, benzoyloxy), alkoxycarbonyl groups (preferably C2 to C20 alkoxycarbonyl groups such as methoxycarbonyl, phenoxycarbonyl), or carbamoylamino groups (preferably C1 to C20 carbamoylamino groups such as carbamoylamino, N-methylcarbamoylamino, N-phenylcarbamoylamino). More preferably, the substituent includes for example alkyl groups, alkenyl groups, aryl groups, heterocyclic groups, halogen atoms, cyano group, alkoxy groups, aryloxy groups, alkylsulfonyl groups, arylsulfonyl groups or sulfamoyl group.

More preferably, R₄, R₅ and R₆ are independently electron attractive substituents. Still more preferably, R₄, R₅ and R₆ are independently halogen-substituted alkyl groups, heterocyclic groups, halogen atoms, cyano group, alkylsulfonyl group, arylsulfonyl groups, or sulfamoyl groups. Furthermore preferably, R₄, R₅ and R₆ are independently halogen atoms, trifluoromethyl group or cyano group. Most preferably, R₄, R₅ and R₆ are independently chlorine atom.

In the formula (1-1) or (1-2), a1, a2 and a3 independently represent an integer of 1 through 5; a4 represents an integer of 0 to 5; a5 and a6 independently represent an integer of 0 to 4; R₁ through R₆ independently existing in plurality may be the same or different provided that a1 through a6 are independently 2 or more.

a1, a2 and a3 are preferably 1 or 2, more preferably 1. a4 is preferably an integer of 1 to 5, more preferably 1 or 2, most preferably 1. a5 and a6 are independently preferably an integer of 1 to 4, more preferably 1 or 2 and most preferably 1.

In the formula (1-1) or (1-2), X₁⁻ represents an anion, preferably any anion of PF₆⁻, SbF₆⁻, BF₄⁻; B(C₆F₅)₄⁻, R₇SO₃⁻, (R₈SO₂)N⁻ and (R₉SO₂)₃C⁻. R₇ represents an alkyl group (preferably C1 to C20 alkyl groups such as methyl group, butyl group, octyl group), a fluorine-substituted alkyl group (preferably C1 to C20 fluorine-substituted alkyl groups such as trifluoromethyl group, perfluorobutyl group), aryl groups (preferably C6 to C20 aryl groups, for example 4-methylphenyl group, 3,5-ditrifluoromethylphenyl group), fluorine-substituted aryl groups (preferably C6 to C20 fluorine-substituted aryl groups such as pentafluorophenyl group). R₈ and R₉ independently represent fluorine-substituted alkyl groups (preferably C1 to C20 fluorine-substituted alkyl groups such as trifluoromethyl group, perfluorobutyl group).

X₁⁻ represents preferably any anion of PF₆⁻; SbF₆⁻, BF₄⁻, CF₃SO₃⁻, C₄F₉SO₃⁻, (CF₃SO₂)N⁻, (C₄F₉SO₂)N⁻, and (CF₃SO₂)₃C⁻. Most preferably, X₁⁻ is PF₆⁻.

The acid generator represented by the formula (1-1) in accordance with the invention is more preferably represented by the formula (1-3), while the acid generator represented by the formula (1-2) in accordance with the invention is more preferably represented by the formula (1-4). Herein, R₁, R₄, a1, a4 and X₁⁻ in the formulae (1-3) and (1-4) have independently the same meanings as in the formulae (1-1) and (1-2), respectively.

The acid generator represented by the formula (1-1) in accordance with the invention is more preferably represented by the formula (1-5), while the acid generator represented by the formula (1-2) in accordance with the invention is more preferably represented by the formula (1-6). Herein, X₁⁻ in the formulae (1-5) and (1-6) has the same meanings as in the formulae (1-1) and (1-2), respectively.

Specific examples of the sulfonium salt-series acid generator represented by the formulae (1-1) through (1-6) are shown below. However, the invention is never limited by them.

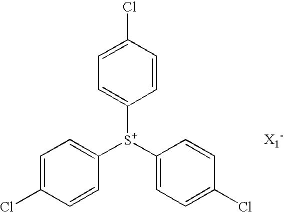

| | X₁⁻ |
|---|---|
| PI-1 | PF₆⁻ |
| PI-2 | SbF₆⁻ |
| PI-3 | BF₄⁻ |
| PI-4 | B(C₆F₅)₄⁻ |
| PI-5 | CF₃SO₃⁻ |
| PI-6 | C₄F₉SO₃⁻ |
| PI-7 | CH₃SO₃⁻ |
| PI-8 | 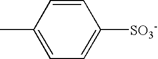 |
| PI-9 | (CF₃SO₂)₂N⁻ |
| PI-10 | (C₄F₉SO₃)₂N⁻ |
| PI-11 | (C₄F₉SO₃)₃C⁻ |
| PI-12 | 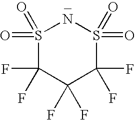 |

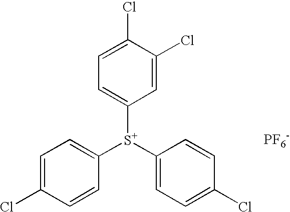

PI-13

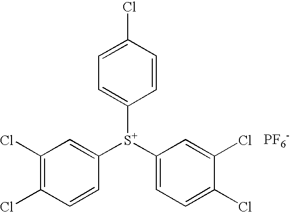

PI-14

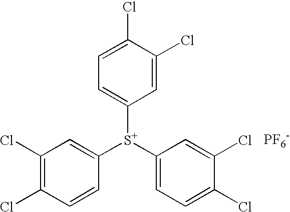

PI-15

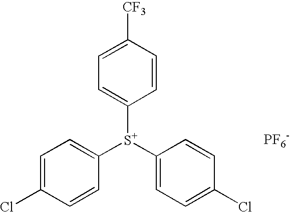

PI-16

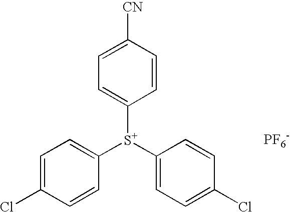

PI-17

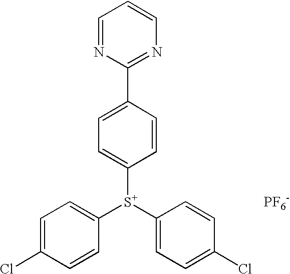

PI-18

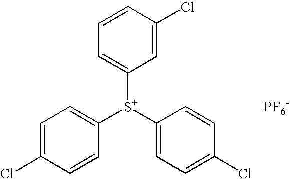

PI-19

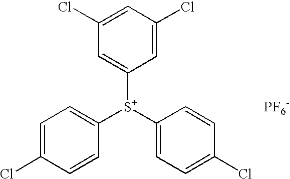

PI-20

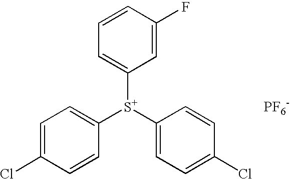

PI-21

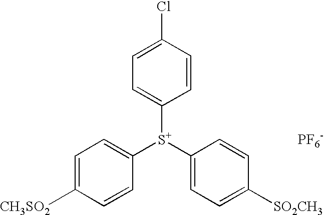

PI-22

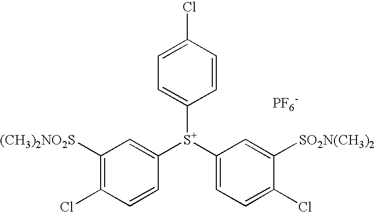

PI-23

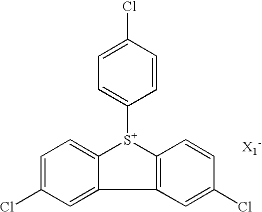

| | X₁⁻ |
|---|---|
| PI-28 | PF₆⁻ |
| PI-29 | SbF₆⁻ |
| PI-30 | BF₄⁻ |
| PI-31 | B(C₆F₅)₄⁻ |
| PI-32 | CF₃SO₃⁻ |
| PI-33 | C₄F₉SO₃⁻ |
| PI-34 | CH₃SO₃⁻ |
| PI-35 | 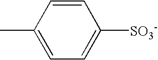 |
| PI-36 | (CF₃SO₂)₂N⁻ |
| PI-37 | (C₄F₉SO₃)₂N⁻ |
| PI-38 | (C₃F₉SO₃)₃C⁻ |
| PI-39 | 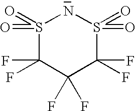 |

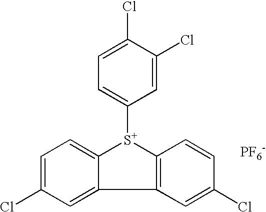

PI-40

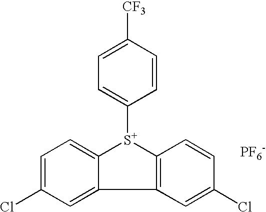

PI-41

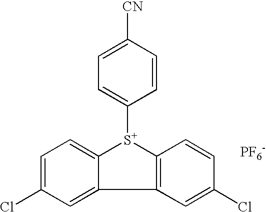

PI-42

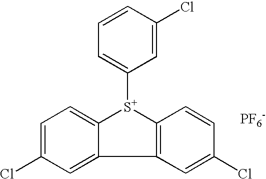

PI-43

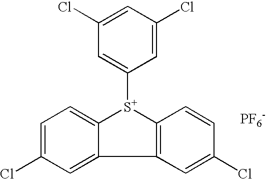

PI-44

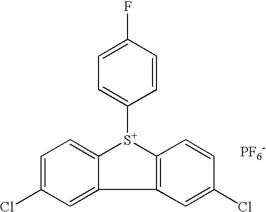

PI-45

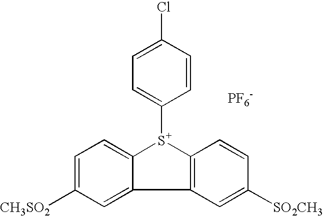

PI-46

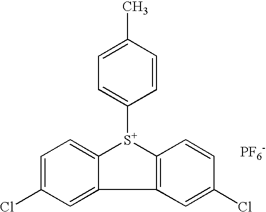

PI-47

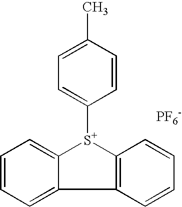

PI-48

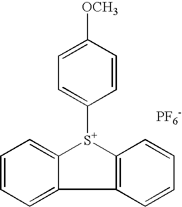

PI-49

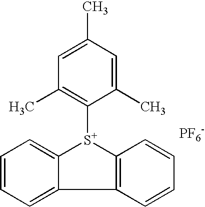

PI-50

The sulfonium salt-series acid generator represented by the formulae (1-1) through (1-9) in accordance with the invention can be synthetically prepared by conventionally known synthetic methods.

When any of sensitizing dyes represented by the formulae (2-1) through (2-5) is used as the sensitizing dye in the hologram recording material of the invention, a radical polymerization initiator (radical generator) or a cation polymerization initiator (acid generator) as any of ketone series, organic peroxide series, trihalomethyl-substituted triazine series, diazonium salt series, diaryliodonium salt series, sulfonium salt series, borate salt series, diaryliodonium/organic boron complex series, sulfonium/organic boron complex series, cationic sensitizing dye/organic boron complex series, anionic sensitizing dye/onium salt complex series, metal allene complex series, and sulfonate ester series or a polymerization initiator with both the functions thereof may preferably be used as the polymerization initiator for use in recording interference fringes via the polymerization reaction of the invention.

Additionally, an acid propagator is also preferably used in view of high sensitization. Specifically, preferable examples of such acid propagator specifically include those described in JP-A-2005-17730.

Additionally, anion polymerization and an anion polymerization initiator (base generator) are preferably used. In that case, a base propagator is preferably used in view of high sensitization. In that case, preferable examples of the anion polymerization initiator and the base propagator specifically include those described in JP-A-2005-17354.

Preferable examples of the polymerization initiators, the polymerizable compounds and the binders in accordance with the invention specifically include for example those described in JP-A-2005-99753.

Preferable specific examples of the polymerization initiators in accordance with the invention include those described below. However, the invention is never limited by them.

<Radical polymerization initiators (radical generators),
cation polymerization initiators (acid generators)>

I-1

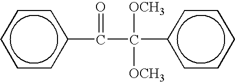

I-2

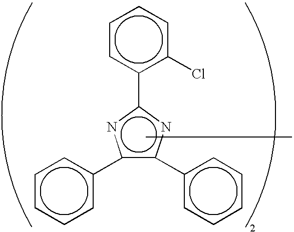

I-3

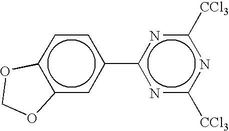

I-4

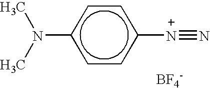

I-5

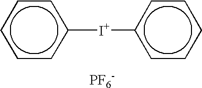

I-6

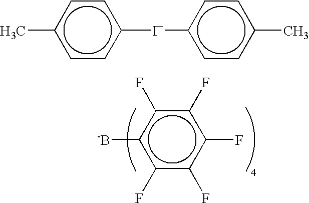

I-7

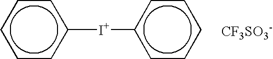

I-8

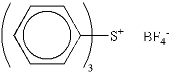

I-9

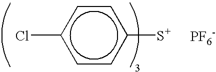

I-10

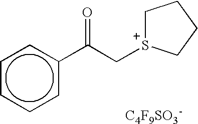

I-11

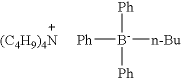

I-12

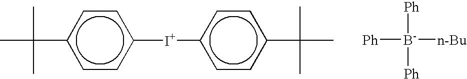

I-13

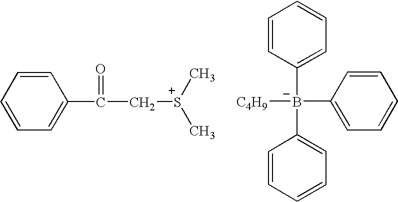

I-14

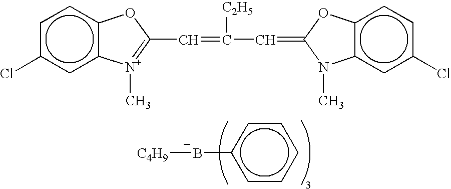

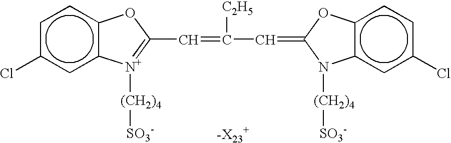

| | X₂₃⁺ | |
|---|---|---|
| I-15 | 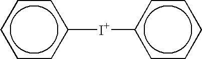 | (=C-1) |
| I-16 | 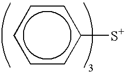 | (=C-2) |
| I-17 | 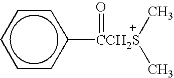 | (=C-3) |

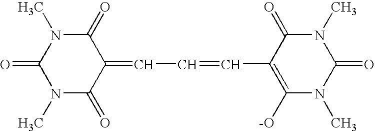

| X₂₃⁺ | |
|---|---|
| I-18 | (C-1) |
| I-19 | (C-2) |
| I-20 | (C-3) |

I-21

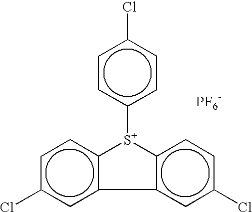

I-22

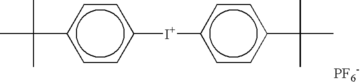

I-23

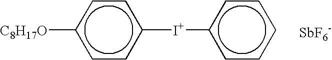

I-24

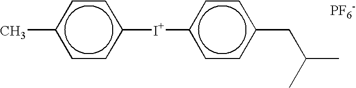

I-25

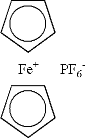

I-26

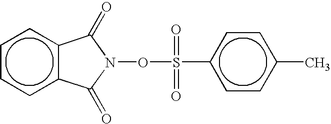

I-27

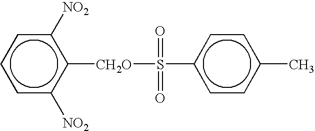

Anion polymerization initiators (base generators)
PB-1

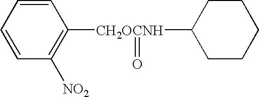

PB-2

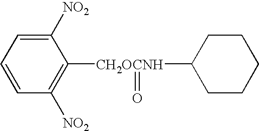

PB-3

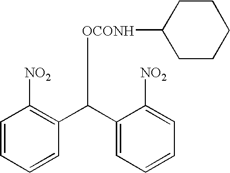

PB-4

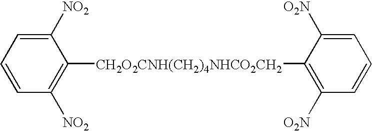

PB-5

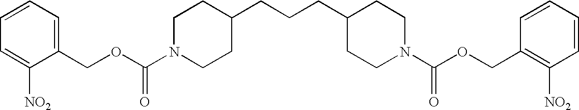

PB-6

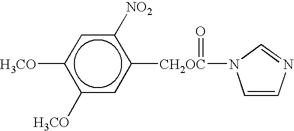

PB-7

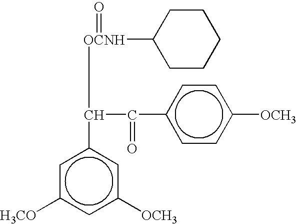

PB-8

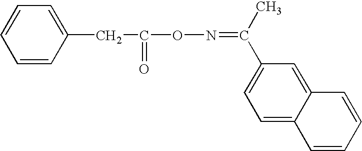

PB-9

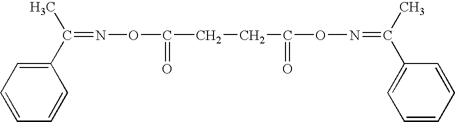

PB-10

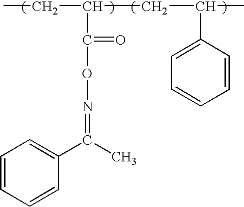

PB-11

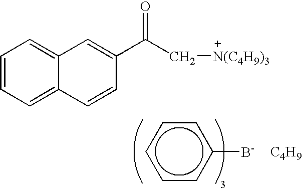

PB-12

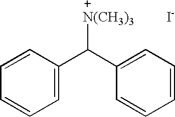

### 2) Recording Interference Fringes via Color Developing Reaction

In accordance with the invention, the term “color developing reaction” means a reaction causing the change of absorption spectrum shape in ultraviolet, visible and infrared rays at 200 to 2,000 nm. More preferably, the color developing reaction means a reaction causing any of the change of λmax into a longer wavelength and the increase of ε. Still more preferably, the term means a reaction causing both of the changes. Additionally, the color developing reaction occurs in a wavelength region of preferably 200 to 1,000 nm, more preferably 300 to 900 nm.

When recording is done via a color developing reaction, the hologram recording material of the invention preferably contains at least a component of recording interference fringes containing:

1) a sensitizing dye absorbing light via hologram exposure to generate an excited state of the sensitizing dye itself, and

2) a dye precursor capable of converting to a color developing substance with absorption in a wavelength longer than that in the initial state but with no absorption in the wavelength of the hologram reproducing light,

where the component for recording interference fringes can record interference fringes using refractive index modulation due to color developing through electron transfer or energy transfer from the excited state of the sensitizing dye.

Further when recording is done via a color developing reaction, the hologram recording material of the invention contains at least:

1) a sensitizing dye absorbing light via hologram exposure to generate an excited state of the sensitizing dye itself,

2) an acid generator generating an acid via electron transfer or energy transfer from the excited state of the sensitizing dye or the excited state of a color developing substance comprising a dye precursor, and

3) the dye precursor capable of converting to the color developing substance with absorption in a wavelength longer than that in the initial state via the addition of the acid but with no absorption in the wavelength of the hologram reproducing light.

In the hologram recording material of the invention, either one or both of a sensitizing dye represented by any one of the formulae (2-1) to (2-5) as the sensitizing dye described in 1) and an acid generator represented by any one of the formulae (1-1) to (1-6) as the acid generator described in 2) is used. More preferably, both of the two are used in accordance with the invention.

Herein, the refractive index of a dye is at a large value in a region around the linear absorption peak wavelength (λmax) to a longer wavelength region. The refractive index thereof is at a very large value at λmax and in a wavelength region longer by about 200 nm than λmax. Depending on the dye, the refractive index exceeds 1.8. Sometimes, the refractive index is at a large value exceeding 2. Meanwhile, organic compounds such as binder polymer, which are never dyes, generally are at refractive indices of about 1.4 to 1.6.

Thus, the dye precursor when developed of the color via hologram exposure can appropriately form the difference in absorbance and can additionally form a large difference in refractive indices.

The hologram recording material of the invention is preferably a phase hologram recording material recording interference fringes via refractive index modulation in terms of high diffraction efficiency. During hologram reproducing, preferably, the hologram recording material has no or almost no absorption in the wavelength of the hologram reproducing light.

When the dye precursor of the invention is converted to a color developing substance after hologram exposure, therefore, the color developing substance has no absorption in the wavelengths of the hologram recording light and the hologram reproducing light but has absorption in a wavelength shorter than those wavelengths. Additionally, preferably, the sensitizing dye is decomposed during hologram recording or subsequent fixing, so that the sensitizing dye loses the absorption and sensitizing functions.

So as to give a large refractive index modulation level to raise the sensitivity and the dynamic range, the dye precursor of the invention is converted to a color developing substance with no absorption in the wavelengths for hologram recording and reproducing but with the absorption peak in a region from the hologram recording wavelength to a wavelength shorter preferably by 200 nm, more preferably by 150 nm from the hologram recording wavelength.

The sensitizing dye is preferably the same as described above.

Preferably, the component of recording interference fringes includes the following combinations. Specific examples of such combinations are described in JP-A-2005-99751.

i) A combination at least containing a dye precursor of a type of developing color with acid and additionally containing an acid generator; if necessary, the combination further containing an acid propagator.

As the acid generator, the sulfonium salt-series acid generators represented by the formulae (1-1) to (1-6) are preferably used as the acid generator. When sensitizing dyes represented by the formulae (2-1) to (2-5) are used as the acid generator, diaryliodonium salts, sulfonium salt, trihalomethyl-substituted triazine, and sulfonate ester are preferably used as the acid generator. The acid generator described above (cation polymerization initiator) can preferably be used.

When those represented by the formulae (1-1) to (1-6) are used as the acid generator, preferably, a sensitizing dye represented by any one of the formulae (2-1) to (2-3) and (2-5) is used as the sensitizing dye. When diaryliodonium salt is used as the acid generator, a sensitizing dye represented by the formula (2-4) is preferably used as the sensitizing dye.

The color developing substance generated from the dye precursor of a type of developing color with acid is preferably xanthene dye, fluoran dye or triphenylmethane dye. Particularly preferable specific examples of the dye precursor of a type of developing color with acid are described below. However, the invention is not limited by them.

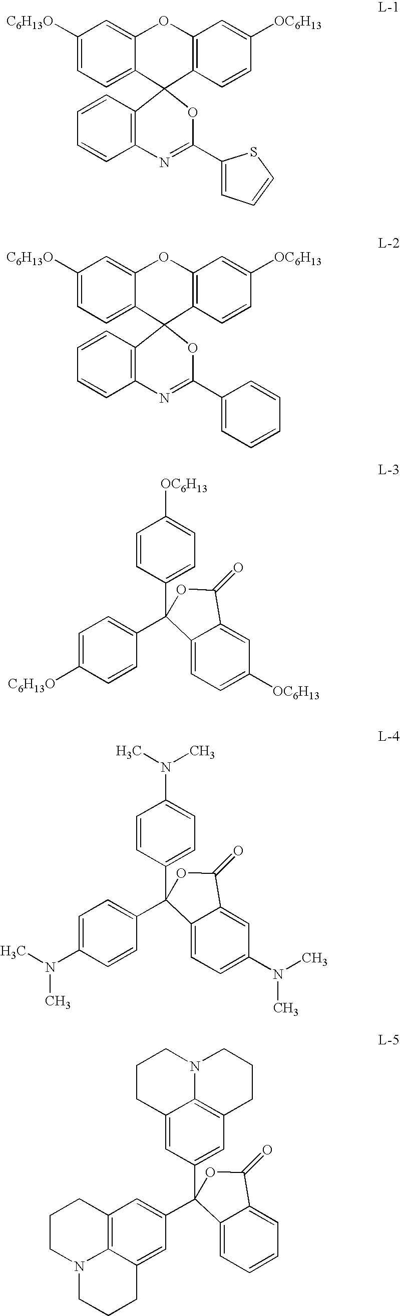

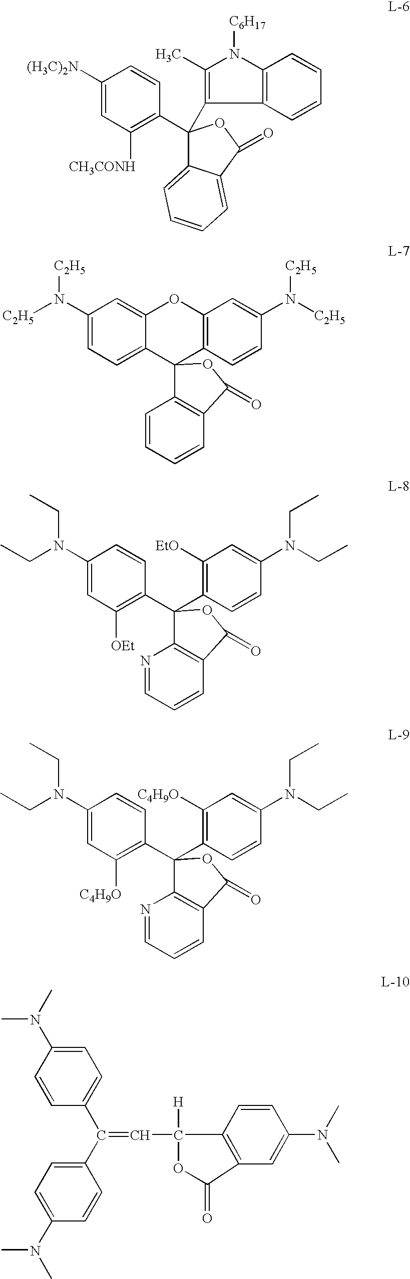

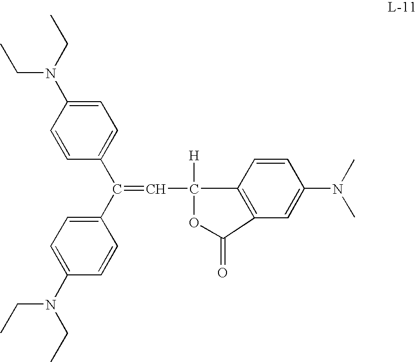

Additionally, cyanine base (leucocyanine dye) developing color via the addition of acid (proton) may preferably be used as the dye precursor of a type of developing color with acid in accordance with the invention. Specific preferable examples of the cyanine base are described below. However, the invention is not limited by them.

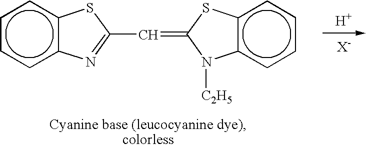

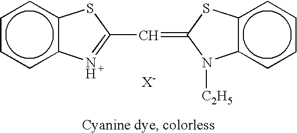

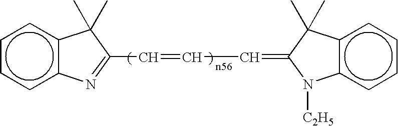

| | n₅₆ |
|---|---|
| LC-1 | 0 |
| LC-2 | 1 |
| LC-3 | 2 |

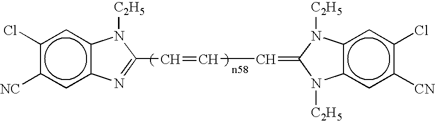

| | n₅₈ |
|---|---|
| LC-4 | 0 |
| LC-5 | 1 |
| LC-6 | 2 |

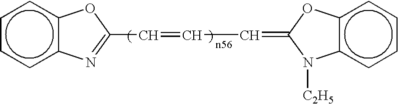

| | n₅₆ |
|---|---|
| LC-7 | 0 |
| LC-8 | 1 |

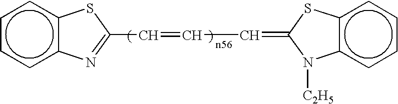

| | n₅₈ |
|---|---|
| LC-9 | 0 |
| LC-10 | 1 |

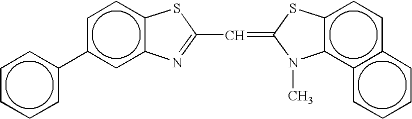

LC-11

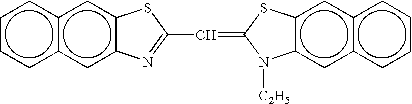

LC-12

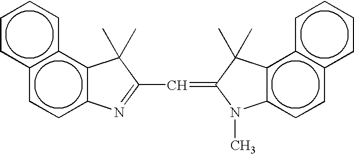

LC-13

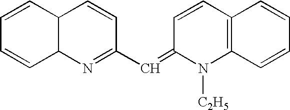

LC-14

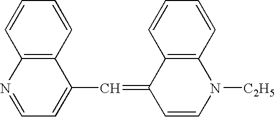

LC-15

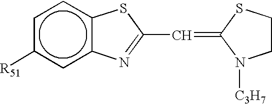

| | R₅₁ |
|---|---|
| LC-16 | —H |
| LC-17 | —Cl |

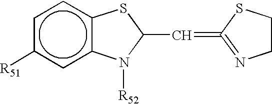

| | R₅₁ | R₅₂ |
|---|---|---|
| LC-18 | —H | —C₃H₇ |
| LC-19 | —Cl | —C₃H₇ |
| LC-20 | —Cl | —C₈H₁₇ |
| LC-21 | —CN | —C₃H₇ |
| LC-22 | 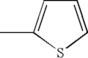 | —C₈H₁₇ |

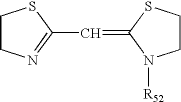

| | R₅₂ |
|---|---|
| LC-23 | —C₈H₁₇ |
| LC-24 | CH₂₂OCH₂546 ₂OCH₂₂OCH₃ |

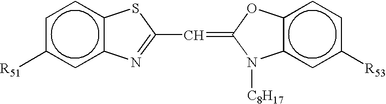

| | R₅₁ | R₅₃ |
|---|---|---|
| LC-25 | —H | —H |
| LC-26 | —Cl | —H |
| LC-27 | —Cl | —Cl |

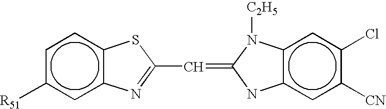

| | R₅₁ |
|---|---|
| LC-28 | —H |
| LC-29 | —Cl |

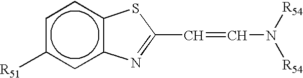

| | R₅₁ | R₅₄ |
|---|---|---|
| LC-30 | —H | —C₁₂H₂₅ |
| LC-31 | —H | —CH₂COOC₂H₅ |
| LC-32 | —H | —CH₂COOC₈H₁₇ |
| LC-33 | —CN | —CH₂COOC₂H₅ |

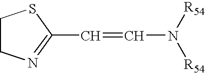

| | R₅₄ |
|---|---|
| LC-34 | —C₆H₁₃ |
| LC-35 | —CH₂COOC₂H₅ |
| LC-36 | —CH₂COOC₆H₁₃ |

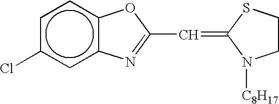

LC-37

ii) A combination at least containing a dye precursor of a type of developing color with base and additionally containing a base generator, if necessary, the combination further containing a base propagator.

In this case, sensitizing dyes represented by the formulae (2-1) to (2-5) are used as the sensitizing dye.

The base generator preferably includes the base generators (anion polymerization initiators) described above. The dye precursor of a type of developing color with base include non-dissociation products of dissociation-type azo dyes, dissociation-type azomethine dye, dissociation-type oxonol dye, dissociation-type xanthene dye, dissociation-type fluoran type or dissociation-type triphenyl methane type dye.

Particularly preferable specific examples of the dye precursor of a type of developing color with base are described below. However, the invention is never limited by them.

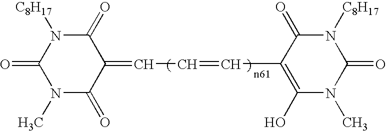

| | n61 |
|---|---|
| DD-1 | 1 |
| DD-2 | 2 |
| DD-3 | 3 |

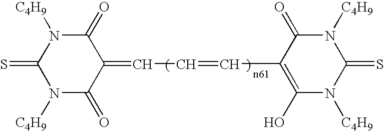

| | n61 |
|---|---|
| DD-4 | 0 |
| DD-5 | 1 |
| DD-6 | 2 |

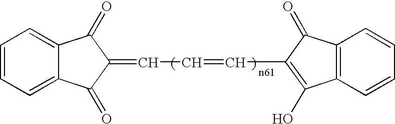

| | n61 |
|---|---|
| DD-7 | 0 |
| DD-8 | 1 |
| DD-9 | 2 |

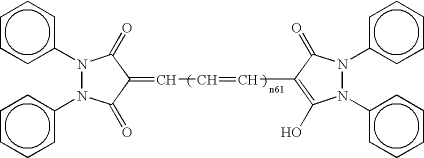

| | n61 |
|---|---|
| DD-10 | 0 |
| DD-11 | 2 |
| DD-12 | 3 |

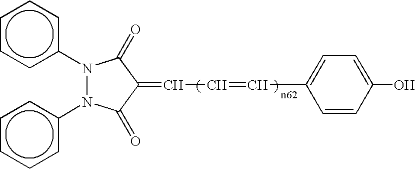

| | n62 |
|---|---|
| DD-13 | 0 |
| DD-14 | 1 |

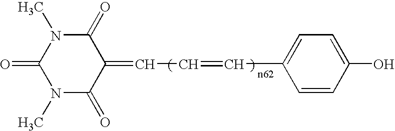

| | n62 |
|---|---|
| DD-15 | 0 |
| DD-16 | 1 |

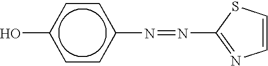

DD-17

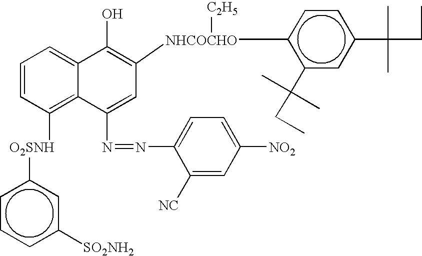

DD-18

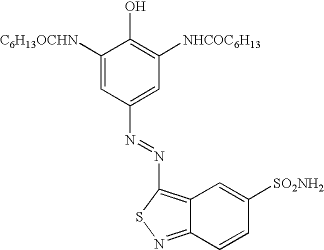

DD-19

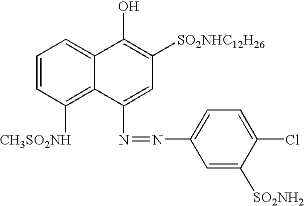

DD-20

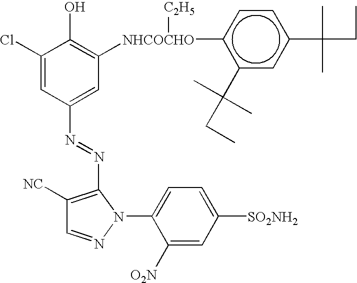

DD-21

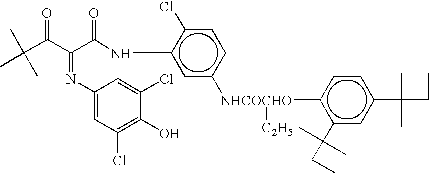

DD-22

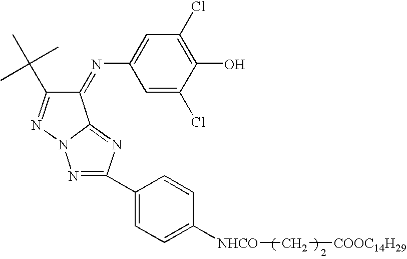

DD-23

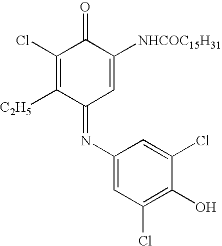

DD-24

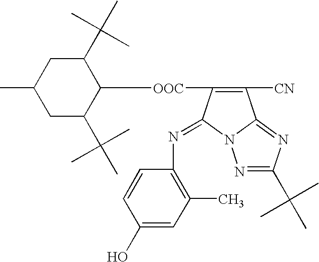

DD-25

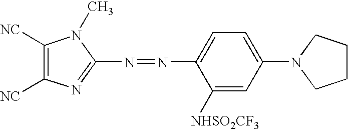

DD-26

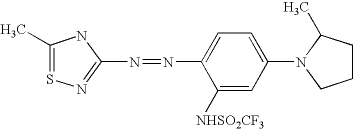

DD-27

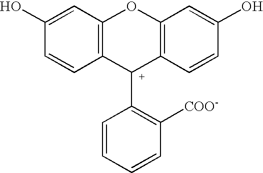

DD-28

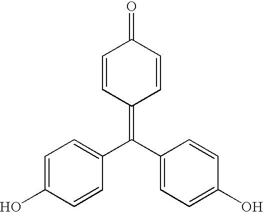

DD-29

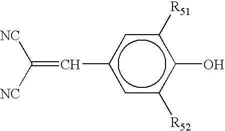

| | R₅₁ | R₅₂ |
|---|---|---|
| DD-30 | —H | —H |
| DD-31 | —Cl | —H |
| DD-32 | —Cl | —Cl |

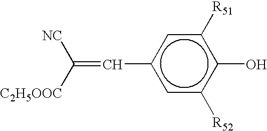

| | R₅₁ | R₅₂ |
|---|---|---|
| DD-33 | —H | —H |
| DD-34 | —Cl | —H |
| DD-35 | —Cl | —Cl |
| DD-36 | —H | —OCH₃ |
| DD-37 | —CH₃ | —CH₃ |
| DD-38 | —C₃H₇-i | —C₃H₇-i |

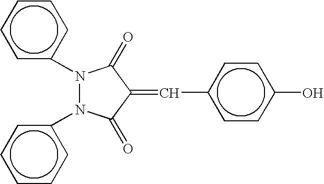

DD-39

Herein, the base includes preferably tributylamine, trihexylamine, trioctylamine, N,N-dimethyldodecylamine, tribenzylamine, tetrabenzylethylenediamine, and 4-(dimethylamino)pyridine.

iii) A combination containing a compound with a covalent bond between an organic compound moiety with a function to cleave the covalent bond via electron transfer or energy transfer from the excited state of a sensitizing dye and an organic compound moiety with a characteristic profile that the organic compound moiety can be converted to a color developing substance when in covalent bonding or when is dissociated, and additionally containing a base if necessary.

In this case, sensitizing dyes represented by the formulae (2-1) to (2-5) are used as the sensitizing dye.

Particularly preferable specific examples thereof are described below. However, the invention is never limited by them.

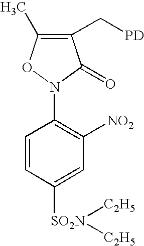

| | PD | | PD | | PD |
|---|---|---|---|---|---|
| E-1 | PD-1 | E-6 | PD-10 | E-11 | PD-31 |
| E-2 | PD-2 | E-7 | PD-12 | E-12 | PD-33 |
| E-3 | PD-22 | E-8 | PD-13 | E-13 | PD-34 |
| E-4 | PD-27 | E-9 | PD-16 | E-14 | PD-35 |
| E-5 | PD-8 | E-10 | PD-18 | E-15 | PD-36 |

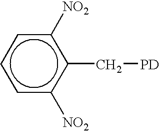

| | PD | | PD | | PD |
|---|---|---|---|---|---|
| E-16 | PD-22 | E-21 | PD-11 | E-26 | PD-31 |
| E-17 | PD-2 | E-22 | PD-14 | E-27 | PD-34 |
| E-18 | PD-27 | E-23 | PD-15 | E-28 | PD-35 |
| E-19 | PD-7 | E-24 | PD-17 | E-29 | PD-36 |
| E-20 | PD-8 | E-25 | PD-18 | E-30 | PD-41 |

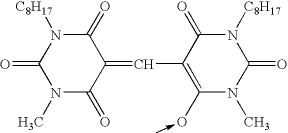

PD-1

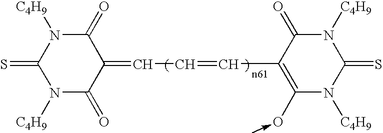

| | n61 |
|---|---|
| PD-2 | 0 |
| PD-3 | 1 |
| PD-4 | 2 |

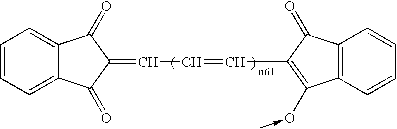

| | n61 |
|---|---|
| PD-5 | 0 |
| PD-6 | 2 |

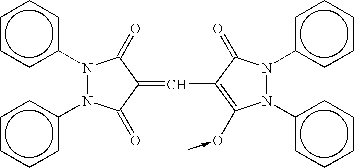

PD-7

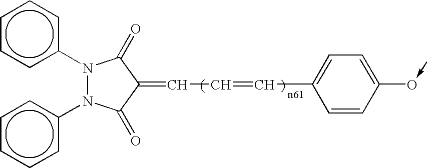

| | n61 |
|---|---|
| PD-8 | 0 |
| PD-9 | 1 |

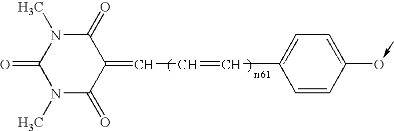

| | n61 |
|---|---|
| PD-10 | 0 |
| PD-11 | 1 |

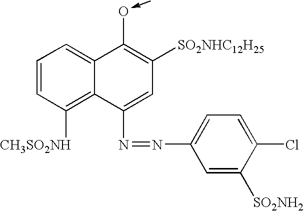

PD-12

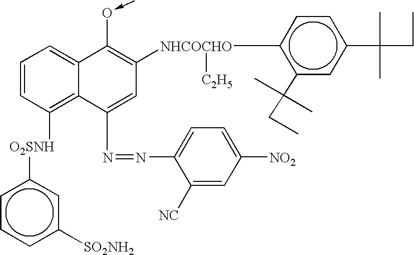

PD-13

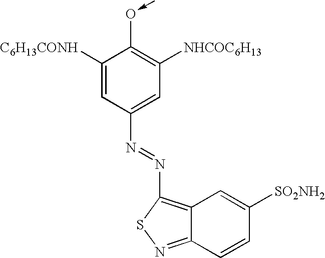

PD-14

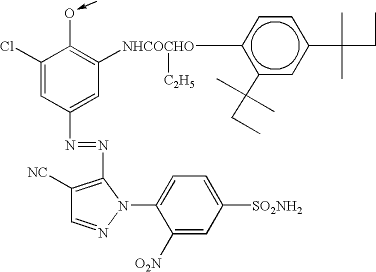

PD-15

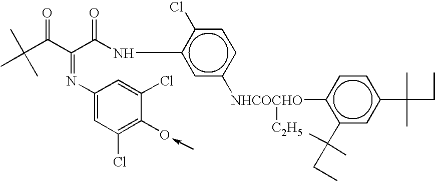

PD-16

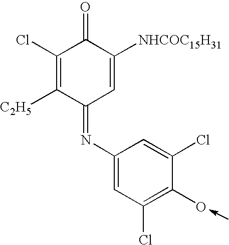

PD-17

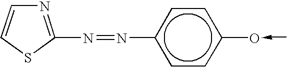

PD-18

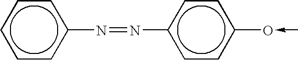

PD-19

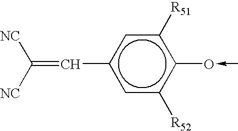

| | R₅₁ | R₅₂ |
|---|---|---|
| PD-20 | —H | —H |
| PD-21 | —Cl | —H |
| PD-22 | —Cl | —Cl |
| PD-23 | —Cl | —COOC₂H₅ |
| PD-24 | —Cl | —CN |

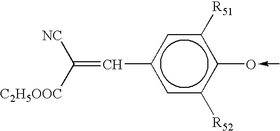

| | R₅₁ | R₅₂ |
|---|---|---|
| PD-25 | —H | —H |
| PD-26 | —Cl | —H |
| PD-27 | —Cl | —Cl |
| PD-28 | —OCH₃ | —H |
| PD-29 | —CH₃ | —CH₃ |
| PD-30 | —C₃H₇-i | —C₃H₇-i |

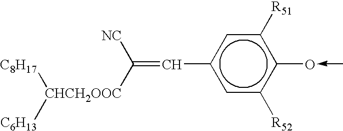

| | R₅₁ | R₅₂ |
|---|---|---|
| PD-31 | —Cl | —Cl |
| PD-32 | —Br | —Br |
| PD-33 | —I | —I |
| PD-34 | —Cl | —CN |

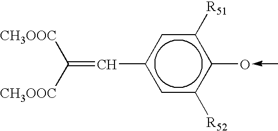

| | R₅₁ | R₅₂ |
|---|---|---|
| PD-35 | —Cl | —Cl |
| PD-36 | —I | —I |
| PD-37 | —Cl | —CN |

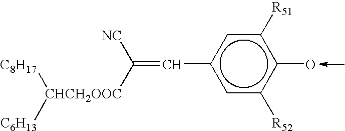

| | R₅₁ | R₅₂ |
|---|---|---|
| PD-38 | —Cl | —Cl |
| PD-39 | —Br | —Br |
| PD-40 | —I | —I |
| PD-41 | —Cl | —CN |

iv) A combination containing a reactive compound via electron transfer from the excited state of a sensitizing dye to modify its absorption shape. So-called electrochromic compounds are preferably used.

In this case, sensitizing dyes represented by the formulae (2-1) through (2-5) are used as the sensitizing dyes therefor.

Further, the combination preferably contains a binder polymer. The binder polymer preferably includes for example, the examples described above in the section 1) polymerization reaction and the examples described in JP-A-2005-99751.

### 3) Recording Interference Fringes via Color Developing Latent Image-Color Developing Reaction via Self-Sensitization and Amplification of Color Developing Substance

Preferably, the recording process includes a first step of generating a color developing substance with no absorption in the wavelength of the hologram reproducing light via hologram exposure, and a second step of irradiating light in a wavelength region where a 5,000 or less molar absorption coefficient of a sensitizing dye on the latent image of the color developing substance to generate the color developing substance via the self-sensitization and amplification thereof to record interference fringes as refractive index modulation, where these steps are done by dry processes. The recording process is preferable in terms of for example high-speed writing and reproducing at a high S/N ratio.

Herein, the term “latent image” means “an image with a difference in refractive index, which is preferably ½-fold or less the difference in refractive index as formed after the second step” (ie. that an amplification step at preferably 2-fold or more is done at the second step), more preferably ⅕-fold or less, still more preferably 1/10-fold or less, most preferably 1/30-fold or less (ie. that an amplification step at preferably 5-fold or more, more preferably 10-fold or more, most preferably 30-fold or more is done at the second step).

Additionally, the second step is done by preferably either one or both of optical irradiation and thermal application, more preferably optical irradiation, where the irradiating light is preferably for overall exposure (so-called solid exposure, blanket exposure, non-image-wise exposure). The light source for use preferably includes visible laser, ultraviolet laser, infrared laser, carbon arc, high-pressure mercury lamp, xenon lamp, metal halide lamp, fluorescence lamp, tungsten lamp, LED and organic EL. So as to irradiate light in a specific wavelength region, for example, sharp-cut filters, band-pass filters and diffraction lattices are used if necessary.

A hologram recording material for the hologram recording method preferably contains a component of recording interference fringes containing at least:

1) a sensitizing dye absorbing light via hologram exposure to generate an excited state of the sensitizing dye itself, and

2) a dye precursor capable of converting to a color developing substance with absorption gets in a wavelength longer than that in the initial state but with no absorption in the wavelength of the hologram reproducing light, where the component of recording interference fringes can record interference fringes using refractive index modulation through color developing, via electron transfer or energy transfer from the excited state of the sensitizing dye or the color developing substance.

Further, the hologram recording material for the hologram recording method preferably contains at least:

1) a sensitizing dye absorbing light via hologram exposure to generate an excited state of the sensitizing dye itself,

2) an acid generator generating acid via electron transfer or energy transfer from the excited state of the sensitizing dye or the excited state of a color developing substance comprising a dye precursor, and

3) the dye precursor capable of converting to the color developing substance with absorption in a wavelength longer than that in the initial state via the addition of the acid but with no absorption in the wavelength of the hologram reproducing light.

Further, either one of a sensitizing dye represented by any one of the formulae (2-1) to (2-5) and an acid generator represented by any one of the formulae (1-1) to (1-6) is preferably used as the sensitizing dye described in 1) and as the acid generator described in 2), respectively.

Preferable examples of the sensitizing dye, the component of recording interference fringes, the acid generator and the dye precursor are the same as described above in the section 2) color developing reaction.

In the wavelength region of the light for irradiation at the second step, the linear molar absorption coefficient of the sensitizing dye is preferably 1,000 or less, more preferably 500 or less.

In the wavelength region of the light for irradiation at the second step, the molar absorption coefficient of the color developing substance is preferably 1,000 or more.

The term “the color developing reaction mode comprising latent image formation via color developing and the self-sensitization and amplification of a color developing substance” is schematically described below.

For example, a YAG-SHG laser of 532 nm irradiates a hologram recording material to allow a sensitizing dye to absorb the light to generate an excited state. Via energy transfer or electron transfer from the excited state of the sensitizing dye to a component of recording interference fringes, the dye precursor contained in the component of recording interference fringes is converted to a color developing substance to form a latent image via color developing (the first step). Then, irradiation of light in a wavelength region of 350 to 420 nm allows a color developing substance to absorb the energy, to amplify and generate the color developing substance via the self-sensitization of the color developing substance (the second step). Because the latent image is not so much generated in the dark part of interference at the first step, almost no self-sensitization and color developing reaction occurs, so that a high level of refractive index modulation can be formed in the bright part of interference and in the dark part of interference, to record interference fringes. Using again a 532-nm laser for irradiating the hologram recording material once used for recording, the recorded information, image and the like are reproduced or the hologram recording material can function as a desired optical material.

Specific examples of the mode of color developing latent image-color developing via self-sensitization and amplification of color developing substance are listed in JP-A-2005-99753.

### 4) Recording Interference Fringes via 4) the Polymerization Reaction Mode Comprising Latent Image Formation via Color Developing and Sensitizing a Color Developing Substance.

Preferably, the hologram recording method comprises a first step of generating a color developing substance with no absorption in the wavelength of the hologram reproducing light as a latent image via hologram exposure and a second step of triggering polymerization by irradiating light in a wavelength different from the wavelength for hologram exposure on the latent image of the color developing substance to record interference fringes as refractive index modulation, where these steps are done by dry processes. The method is excellent in terms of high-speed writing, storability and the like.

A method for generating a color developing substance by self-sensitization and amplification and simultaneously triggering polymerization at the second step is also preferable.

A hologram recording material for the hologram recording method preferably contains at least:

1) a sensitizing dye absorbing light via hologram exposure at the first step to generate an excited state of the sensitizing dye itself,

2) a dye precursor group capable of converting to a color developing substance with absorption in a wavelength longer than that in the initial state via electron transfer or energy transfer from the excited state of the sensitizing dye at the first step or from the excited state of the color developing substance at the second step and with absorption in a wavelength region where the sensitizing dye has a molar absorption coefficient of 5,000 or less but with no absorption in the wavelength of the hologram reproducing light,

3) a polymerization initiator capable of initiating the polymerization of a polymerizable compound via electron transfer or energy transfer from the excited state of the sensitizing dye at the first step or the excited state of the color developing substance at the second step,

4) a polymerizable compound, and

5) a binder.

A hologram recording material for the hologram recording method preferably contains at least:

1) a sensitizing dye absorbing light via hologram exposure at the first step to generate an excited state of the sensitizing dye itself,

2) an acid generator generating an acid via electron transfer or energy transfer from the excited state of die sensitizing dye at the first step or the excited state of a color developing substance comprising a dye precursor at the second step,

3) the dye precursor capable of converting to the color developing substance with absorption in a wavelength longer than that in the initial state via the addition of the acid but with no absorption in the wavelength of the hologram reproducing light,

4) a polymerization initiator capable of initiating the polymerization of a polymerizable compound via electron transfer or energy transfer from the excited state of the sensitizing dye at the first step or the excited state of the color developing substance at the second step (the polymerization initiator sometimes also functioning as the acid generation described above in 2))

5) a polymerizable compound, and

6) a binder.

Further, either one of a sensitizing dye represented by any one of the formulae (2-1) to (2-5) and an acid generator represented by any one of the formulae (1-1) to (1-6) is preferably used as the sensitizing dye described above in 1) and the acid generator described above in 2), respectively.

Preferable examples of the sensitizing dye, the component of recording interference fringes, the acid generator and the dye precursor are the same as described above in the section 2) color developing reaction.

Preferable examples of the polymerization initiator, the polymerizable compound and the binder are the same as described above in the section 1) polymerization reaction.

In the wavelength region of the light for irradiation at the second step, the linear molar absorption coefficient of the sensitizing dye is preferably 1,000 or less, more preferably 500 or less.

In the wavelength region of the light for irradiation at the second step, the molar absorption coefficient of the color developing substance is preferably 1,000 or more.

For the hologram recording method and the hologram recording material for recording by the hologram recording method, preferably, the sensitizing dye is decomposed and fixed at any of the first step, the second step or the subsequent fixing step by optical irradiation, thermal application or both of the two, in terms of storability and reproducing without damaging. More preferably, the sensitizing dye is decomposed and fixed at any of the first step, the second step or the subsequent fixing step by optical irradiation, thermal application or both of the two, while the color developing substance is decomposed and fixed at the second step or the subsequent fixing step by optical irradiation, thermal application or both of the two.

The term “polymerization reaction mode comprising latent image formation via color developing and sensitizing a color developing substance is schematically described below.

For example, a YAG-SHG laser of 532 nm irradiates a hologram recording material to allow a sensitizing dye to absorb the light to generate an excited state. Via energy transfer or electron transfer from the excited state of the sensitizing dye to a component of recording interference fringes, a dye precursor contained in the component of recording interference fringes is converted to a color developing substance to form a latent image via color developing (the first step). Then, irradiation of light in a wavelength region of 350 to 420 nm allows a color developing substance to absorb the energy, to activate the polymerization initiator via electron transfer or energy transfer to initiate polymerization. In case that a polymerizable compound has a large refractive index than that of a binder, the polymerizable compound accumulates in a part with the occurrence of polymerization, so that the refractive index gets larger (the second step). Because the latent image is not so much generated in the dark part of interference at the first step, the polymerization occurs at a very low level at the second step to increase the existing binder ratio, so that a high level of refractive index modulation can be formed in the bright part of interference and the dark part of interference to enable recording as interference fringes. When the sensitizing dye and the color developing substance can be decomposed and discolored at the first and second steps or the subsequent fixing step, a hologram recording material with excellent reproducing without damaging and with good storability can be provided.

Using again a 532-nm laser for irradiating the hologram recording material once used for recording, the recorded information, image and the like are reproduced or the hologram recording material can function as a desired optical material.

Specific examples of the mode of color developing latent image-polymerization reaction by sensitizing color developing substance are listed in JP-A-2005-99753.

### 5) Recording Interference Fringes via the Orientation Change of a Compound with Intrinsic Birefringence

The hologram recording method preferably comprises triggering the orientation change of a compound with intrinsic birefringence via hologram exposure, and fixing the orientation change with a chemical reaction, to record interference fringes as refractive index modulation by a not-rewritable mode. As a compound with intrinsic birefringence, liquid crystal compounds are preferable. Low-molecular liquid crystal compounds are more preferable as such. Low-molecular crystal compounds with a polymerizable group are still more preferable. Low-molecular liquid crystal compounds with a polymerizable group are preferably any one of nematic liquid crystal compounds, smectic liquid crystal compounds, discotic nematic liquid crystal compounds, discotic liquid crystal compounds, and cholesteric liquid crystal compounds, more preferably nematic liquid crystal compounds or smectic liquid crystal compounds.

Preferably, the hologram recording material by the mode of recording interference fringes via the orientation change of a compound with intrinsic birefringence contains at least a low-molecular liquid crystal compound with a polymerizable group, a photo-reactive compound and a polymerization initiator and further contains a sensitizing dye, a binder polymer and the like. Preferable examples of for example the polymerization initiator, the sensitizing dye and the binder polymer are as described above. Further, either one of a sensitizing dye represented by any one of the formulae (2-1) to (2-5) and an acid generator represented by any one of the formulae (1-1) to (1-6) is preferably used as the sensitizing dye described above in 1) and the acid generator described above in 2), respectively.

Additionally, the photo-reactive compound includes preferably an optically isomerized compound and more preferably azobenzene-series compounds, stilbene-series compounds, spiropyran-series compounds, spiro-oxazine-series compounds, diarylethene-series compounds, fulgide-series compounds, fulgimide-series compounds, cinnamic acid-series compounds, coumarine-series compounds, or chalcone-series compounds, most preferably azobenzene-series compounds.

The photo-reactive compounds may satisfactorily be low-molecular compounds or high-molecular compounds. When the photo-reactive compounds are high-molecular compounds, the high-molecular compounds are preferably pendant with a photo-reactive site.

Herein, specific examples of the mode of recording interference fringes via the orientation change of a compound with an intrinsic birefringence and a material thereof preferably include those listed in JP-A-2005-115361,

### 6) Dye Discoloring Reaction

Preferably, the hologram recording material contains at least one type or more discolorable dyes, where the discolorable dyes are discolored by hologram exposure. The hologram recording method comprises forming interference fringes with refractive index modulation using the discoloring of the discolorable dyes.

In accordance with the invention, the term “discolorable dye” generically means dyes with absorption in ultraviolet, visible and infrared wavelength regions of 200 to 2,000 nm and with the occurrence of either one to directly or indirectly modify % max into a shorter wavelength region or to decrease the molar absorption coefficient on photo-irradiation. Additionally, the discolorable dye preferably means dyes with the occurrence of the two phenomena. Additionally, the discoloring reaction occurs preferably in a wavelength region of 200 to 1,000 nm, more preferably in a wavelength region of 300 to 900 nm.

A preferable combination includes

(A) a hologram recording method comprising forming interference fringes via refractive index modulation, where the discolorable dye is a sensitizing dye with absorption in the wavelength for hologram exposure to absorb the light so that the discolorable dye is discolored; and
(B) a hologram recording method forming interference fringes via refractive index modulation by using at least a sensitizing dye with absorption in the wavelength for hologram exposure and a discolorable dye with a molar absorption coefficient of 1,000 or less, preferably 100 or less in the wavelength of the hologram reproducing light, where the sensitizing dye absorbs light during hologram exposure to discolor the discolorable dye via electron transfer or energy transfer using the excited energy thereof. Preferably, the method (B) is more preferable.

Further, a hologram recording method for forming interference fringes via refractive index modulation is preferable, which uses a discoloring agent precursor different from a discolorable dye and a sensitizing dye, the hologram recording method comprising generating an excited state of the sensitizing dye or the discolorable dye via hologram exposure, generating a discoloring agent from the discoloring agent precursor via energy transfer or electron transfer to the discoloring agent precursor, and allowing the discoloring agent to discolor the discolorable dye. Then, the discoloring agent is preferably any of radicals, acids, bases, nucleophilic agents, electrophilic agents, and singlet oxygen. Hence, the discoloring agent precursor is preferably any of radical generators, acid generators, base generators, nucleophilic agent-generating agents, electrophilic agent-generating agents, and triplet oxygen. The discoloring agent precursor is preferably any of radical generators, acid generators, and base generators, more preferably acid generators.

In any of the cases, more preferably, a binder polymer is additionally contained. The binder polymer preferably includes the examples described above in the section 1) polymerization reaction and the examples described in JP-A-2005-99751.

Then, the discolorable dye for forming a difference in refractive index in between the bright part of interference fringes and the dark part of interference fringes is now described below according to the “mode of dye discoloring reaction”.

According to the mode “A” described above, the discolorable dye also functions as a sensitizing dye. Therefore, preferable examples of the discolorable dye include examples of the sensitizing dye as described above. λmax of the discolorable dye also functioning as a sensitizing dye is preferably in the wavelength of the hologram recording light to a wavelength shorter by 100 nm from the wavelength of the hologram recording light.

According to the mode “B”, meanwhile, a discolorable dye different from the sensitizing dye is used. In that case, a discolorable dye with a molar absorption coefficient of preferably 1,000 or less, more preferably 100 or less, most preferably zero in the wavelength of the hologram recording light. Preferably, % max of the discolorable dye also functioning as a sensitizing dye is preferably in the wavelength of the hologram recording light to a wavelength shorter by 200 nm from the wavelength of the hologram recording light.

According to the mode “B”, the discolorable dye preferably includes for example cyanine dye, squalirium cyanine dye, styryl dye, pyrilium dye, merocyanine dye, benzylidene dye, oxonol dye, coumarine dye, pyran dye, xanthene dye, thioxanthene dye, phenothiazine dye, phenoxazine dye, phenazine dye, phthalocyanine dye, azaporphylline dye, porphylline dye, condensed-ring aromatic dyes, perylene dye, azomethine dye, azo dye, anthraquinone dye, and metal complex dyes, and is more preferably any of cyanine dye, styryl dye, merocyanine dye, benzylidene dye, oxonol dye, coumarine dye, xanthene dye, azomethine dye, azo dyes, and metal complex dyes.

Particularly when the discoloring agent is an acid, the discolorable dye is preferably dissociation products of dissociation-type benzylidene dye, dissociation-type oxonol dye, dissociation-type xanthene dye, and dissociation-type azo type, more preferably dissociation products of dissociation-type benzylidene dye, dissociation-type oxonol dye, and dissociation-type azo type. Herein, the term “dissociation-type dye” generically means dyes with an active hydrogen of pKa in a range between about 2 to 14, including those in —OH group, —SH group, —COOH group, —NHSO₂R group, and —CONHSO₂R group, from which proton is dissociated to modify the absorption into a longer wavelength or to have a large ε value. Thus, preliminary treatment of such dissociation-type dyes with a base to convert the dyes to the dissociated types thereof can allow the preliminary preparation of dyes with absorption in a longer wavelength or with a larger value of ε, which can be converted to non-dissociated types thereof via optical acid generation for discoloring (converted to have a shorter wavelength or small ε).

As described above, the hologram recording method uses at least:

1) a sensitizing dye absorbing light via hologram exposure to generate an excited state of the sensitizing dye itself,

2) an acid generator generating an acid via electron transfer or energy transfer from the excited state of the sensitizing dye itself, and

3) a discolorable dye with no absorption in the wave length of the hologram reproducing light, which is discolored with the acid,

where the sensitizing dye generates an excited state via hologram exposure to subsequently transfer electrons to the acid generator to generate an acid, which discolors the discolorable dye to form interference fringes by refractive index modulation. Further, either one or both of a sensitizing dye represented by any one of the formulae (2-1) to (2-5) and an acid generator represented by any one of the formulae (1-1) to (1-6) are used as the sensitizing dye described in 1) and an acid generator described in 2), respectively.

When the discoloring agent is a base, meanwhile, color developing substances of dyes developing colors with acids, such as triphenylmethane dye, xanthene dye and fluoran dye, after preliminary acid treatment to prepare the color developing substances, are used as discolorable dyes. In that case, the discolorable dyes are converted to a non-proton adduct via optical base generation, for discoloring (converted to shorter wavelength or smaller ε).

Specific examples of the discolorable dye in accordance with the invention are described below. However, the invention is never limited by them.

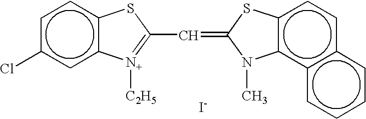

G-1

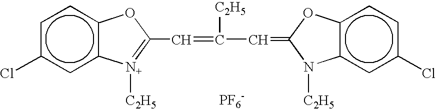

G-2

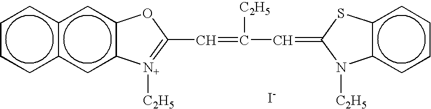

G-3

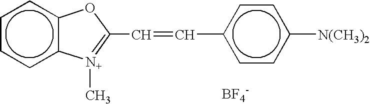

G-4

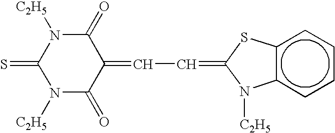

G-5

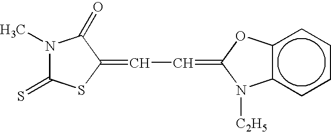

G-6

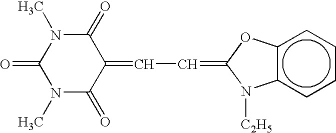

G-7

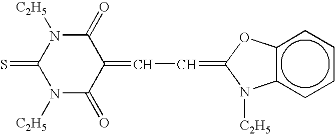

G-8

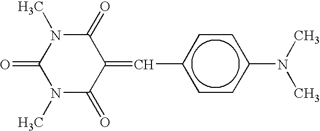

G-9

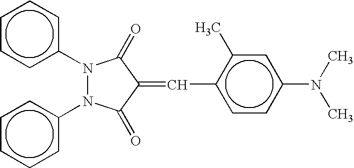

G-10

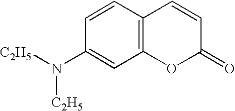

G-11

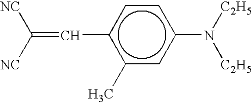

G-12

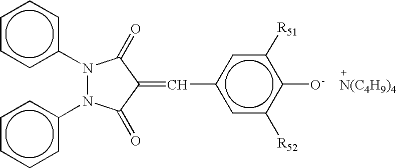

| | R₅₁ | R₅₂ |
|---|---|---|
| G-13 | —H | —H |
| G-14 | —Cl | —H |
| G-15 | —Cl | —Cl |

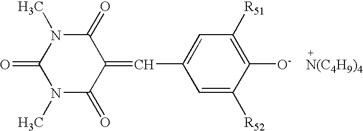

| | R₅₁ | R₅₂ |
|---|---|---|
| G-16 | —H | —H |
| G-17 | —Cl | —H |
| G-18 | —Cl | —Cl |

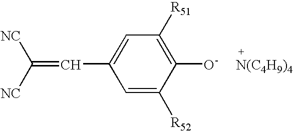

| | R₅₁ | R₅₂ |
|---|---|---|
| G-19 | —H | —H |
| G-20 | —Cl | —H |
| G-21 | —Cl | —Cl |

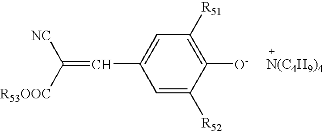

| | R₅₁ | R₅₂ | R₅₃ |
|---|---|---|---|
| G-22 | —H | —H | —C₂H₅ |
| G-23 | —Cl | —Cl | ″ |
| G-24 | —H | —H | 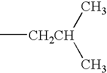 |
| G-25 | —H | —Cl | ″ |
| G-26 | —Cl | —Cl | ″ |
| G-27 | —Br | —Br | ″ |
| G-28 | —I | —I | ″ |
| G-29 | —Cl | —CN | ″ |
| G-30 | —H | —H | 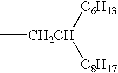 |
| G-31 | —H | —Cl | ″ |
| G-32 | —Cl | —Cl | ″ |
| G-33 | —CH₃ | —CH₃ | 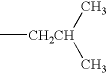 |
| G-34 | —C₃H₇-i | —C₃H₇-i | ″ |

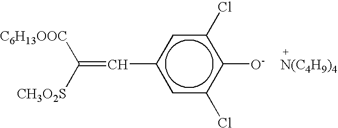

G-41

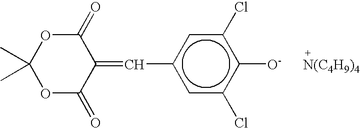

G-42

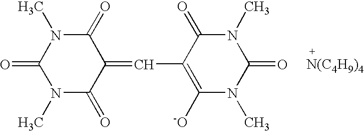

G-43

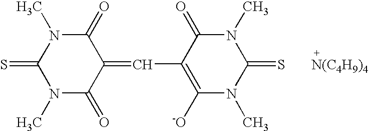

G-44

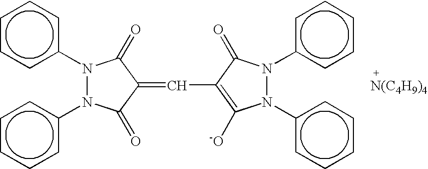

G-45

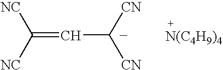

G-46

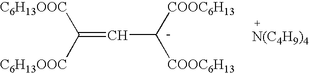

G-47

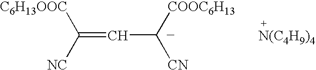

G-48

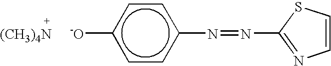

G-49

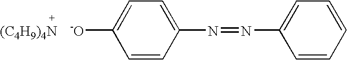

G-50

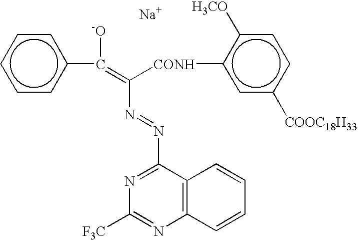

G-51

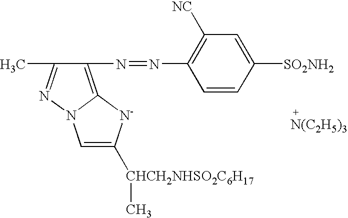

G-52

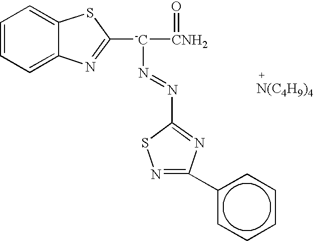

G-53

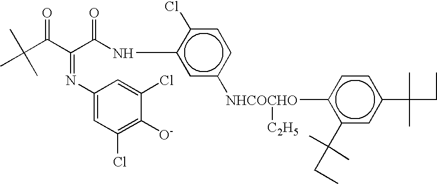

G-54

### <Color Developing Substances of Dyes Developing Color with Acids, Mainly Discolored with Bases>

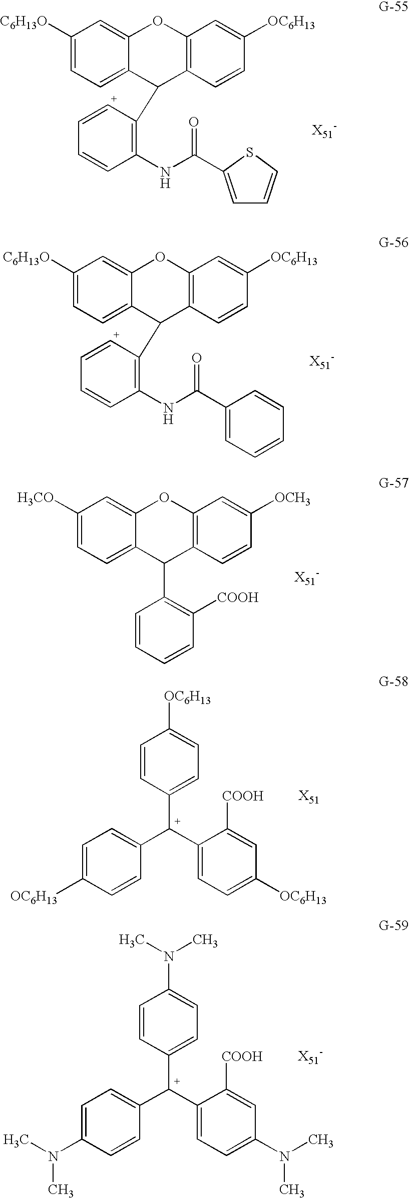

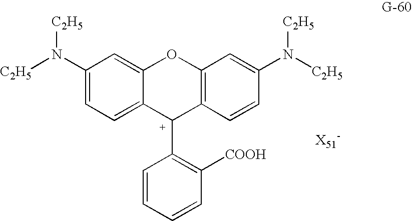

### <Cyanine-Based Color Developing Substances with Acids, Mainly Discolored with Bases>

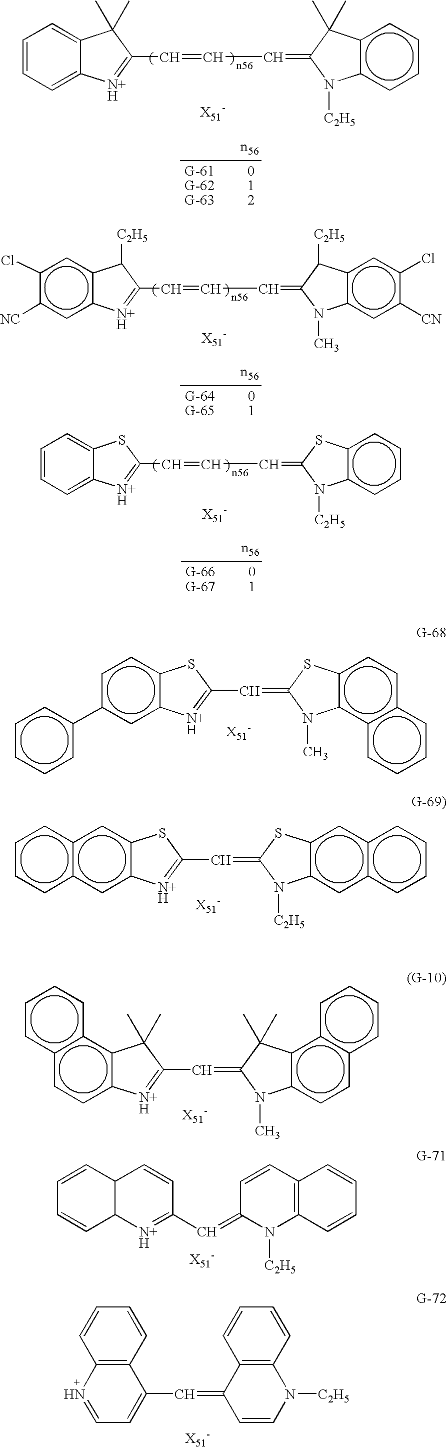

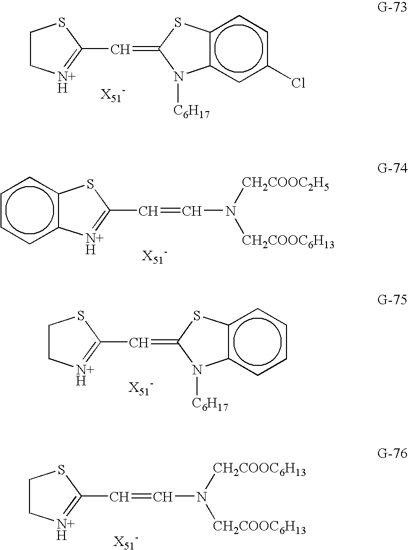

The discolorable dye in accordance with the invention preferably includes the following discolorable dye examples, which are cleaved of their bonds via electron transfer from the excited state of a sensitizing dye as generated via hologram exposure, so that the discolorable dyes are discolored.

These discolorable dyes are originally cyanine dyes, which are converted to cyanine bases (leucocyanine dyes) via bond cleavage through electron transfer, for discoloring the absorption or allowing a shorter wavelength.

<Discoloring via bond cleavage through electron transfer>

| R₅₁ | 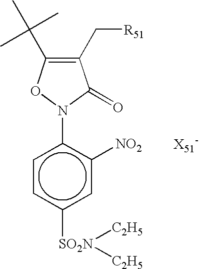 | 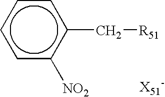 |
|---|---|---|
| GD-1 | G-77 | G-84 |
| GD-2 | G-78 | G-85 |
| GD-3 | G-79 | G-86 |
| GD-4 | G-80 | G-87 |
| GD-5 | G-81 | G-88 |
| GD-6 | G-82 | G-89 |
| GD-7 | G-83 | G-90 |

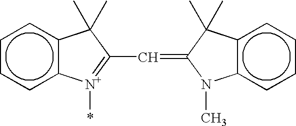

GD-1

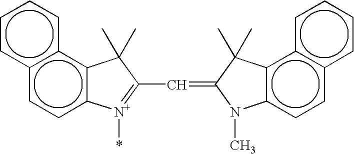

GD-2

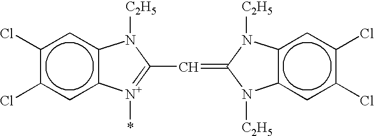

GD-3

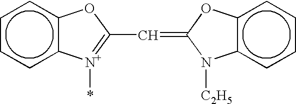

GD-4

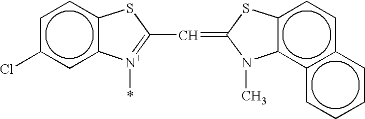

GD-5

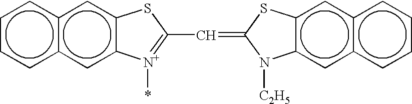

GD-6

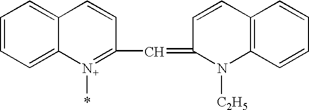

GD-7
Substituted at the position marked with *.
X₅₁⁻ means anion.

In case that the precursor of a discoloring agent is an acid generator, preferable examples thereof are sulfonium salt-series acid generators represented by the formulae (1-1) to (1-6) and are additionally the aforementioned examples of the cation polymerization initiator.

In case that the precursor is a radical generator, preferable examples thereof are the aforementioned examples of the radical polymerization initiator. In case that the precursor is a base generator, preferable examples thereof are the aforementioned examples of the anion polymerization initiator.

Further, sulfonium salt-series acid generators represented by the formulae (1-1) to (1-6) are preferably used as the precursors of discoloring agents (acid generators). In case that sensitizing dyes represented by the formulae (2-1) to (2-5) are used as the sensitizing dyes, preferably, the precursors of discoloring agents (acid generators) are aryliodonium salts, sulfonium salts, trihalomethyl-substituted triazine and sulfonate ester. Preferably, the aforementioned acid generator (cation polymerization initiator) can be used preferably.

Additionally in case that those of the formulae (1-1) to (1-6) are used as the acid generators, a sensitizing dye represented by any one of the formulae (2-1) to (2-3), and (2-5) is preferably used as the sensitizing dye. In case that diaryliodonium salt is used as the acid generator, a sensitizing dye represented by the formula (2-4) is preferably used as the sensitizing dye.

For a discoloring reaction using a base generator along with a base-discolorable dye or the following discolorable dyes of which the bonds are cleaved via electron transfer from the excited state of a sensitizing dye as generated via hologram exposure for discoloring with no use of acid generators, sensitizing dyes represented by the formulae (2-1) to (2-5) are used as the sensitizing dyes.

Specific examples of the dye discoloring reaction are preferably examples described in Japanese Patent Application No. 2004-88790.

### 7) Polymerization Reaction Comprising Forming Latent Image of Residual Discolorable Dye and Sensitizing the Latent Image.

A hologram recording method preferably comprises a first step of allowing a sensitizing dye with absorption in the wavelength of hologram exposure to absorb light during hologram exposure to generate an excited state of the sensitizing dye itself, discoloring a discolorable dye with a molar absorption coefficient of 1,000 or less, preferably 100 or less, most preferably zero in the wavelength of the hologram reproducing light, using the excitation energy, and preparing a latent image of a not-discolored residual discolorable dye, and a second step of irradiating light with a wavelength different from the hologram exposure light on the latent image of the residual discolorable dye to induce polymerization to record interference fringes as refractive index modulation. The hologram recording method is very excellent in terms high-speed recording, multiple recording profile, post-recording storability and the like.

Further, a hologram recording method is also preferable, comprising a first step of allowing a sensitizing dye with absorption in the wavelength of hologram exposure to absorb light during hologram exposure to generate an excited state of the sensitizing dye itself, generating a discoloring agent from a precursor of the discoloring agent via energy transfer or electron transfer to the precursor of the discoloring agent described above in 6), allowing the discoloring agent to discolor the discolorable dye and preparing a latent image of a not-discolored residual discolorable dye, and a second step of irradiating light with a wavelength different from the hologram exposure light on the latent image of the residual discolorable dye to activate a polymerization initiator to induce the polymerization to record interference fringes as refractive index modulation.

A group of compounds enabling such hologram recording methods preferably includes at least:

1) a sensitizing dye absorbing light via hologram exposure at the first step to generate an excited state of the sensitizing dye itself,

2) a discolorable dye with a molar absorption coefficient of 1,000 or less in the wavelength of the hologram reproducing light, which can be discolored as the consequence of direct electron transfer from the excited state of the sensitizing dye at the first step or to electron transfer to a precursor of a discoloring agent to generate a discoloring agent,

3) a polymerization initiator capable of initiating the polymerization of a polymerizable compound via electron transfer or energy transfer from the excited state of the residual discolorable dye at the second step (the polymerization initiator sometimes also functioning as the precursor of the discoloring agent described above in 2)),

4) a polymerizable compound, and

5) a binder.

In case of the energy transfer or electron transfer to the precursor of the discoloring agent as described above in 2), the group of such compounds preferably includes 6) the precursor of a discoloring agent capable of generating the discoloring agent via electron transfer or energy transfer from the excited state of a sensitizing dye at the first step.

A group of compounds enabling such hologram recording methods preferably includes at least:

1) a sensitizing dye absorbing light via hologram exposure at the first step to generate an excited state of the sensitizing dye itself,

2) an acid generator generating an acid via electron transfer or energy transfer from the excited state of the sensitizing dye itself,

3) a discolorable dye with no absorption in the wavelength of the hologram reproducing light,

4) a polymerization initiator capable of initiating the polymerization of a polymerizable compound via electron transfer or energy transfer from the excited state of the residual discolorable dye at the second step (the polymerization initiator sometimes also functioning as the acid generator described above in 2)),

5) a polymerizable compound, and

6) a binder.

Further, either one of a sensitizing dye represented by any one of the formulae (2-1) to (2-5) and an acid generator represented by any one of the formulae (1-1) to (1-6) is preferably used as the sensitizing dye described above in 1) and the acid generator described above in 2), respectively.

Preferable examples of the sensitizing dye are the same as described above in the section 2) color developing reaction.

Preferable examples of the polymerization initiator, the polymerizable compound and the binder are the same as described above in the section 1) polymerization reaction.

Preferable examples of the discolorable dye and the precursors of discoloring agents are the same as described above in the section 6) discoloring reaction.

In the wavelength region of the light for irradiation at the second step, herein, the linear molar absorption coefficient of the sensitizing dye is preferably 1,000 or less, more preferably 500 or less.

In the wavelength region of the light for irradiation at the second step, herein, the molar absorption coefficient of the discolorable dye is preferably 1,000 or less.

According to the “polymerization reaction mode comprising forming latent image of residual discolorable dye and sensitizing the latent image”, preferably, the precursor of a discoloring agent and the polymerization initiator are partially or wholly identical to each other and have therefore both the functions thereof.

In case that a discolorable dye is added separately from the sensitizing dye and in case that the precursor of a discoloring agent and a polymerization initiator are different (for example, the case that the precursor of a discoloring agent is an acid generator or a base generator while the polymerization initiator is a radical polymerization initiator or the case that the precursor of a discoloring agent is a radical generator or a nucleophilic agent-generating agent while the polymerization initiator is an acid generator or a base generator), preferably, the sensitizing dye can transfer electron for enhancement to the precursor of a discoloring agent alone, while the polymerization initiator can transfer electron for enhancements only by a discolorable dye.

According to the hologram recording method and the hologram recording material for recording by the hologram recording method in accordance with the invention, the sensitizing dye is decomposed and fixed at any of the first step, the second step or the subsequent fixing step by optical irradiation, thermal application or both of the two, in terms of storability and reproducing without damaging. More preferably, the sensitizing dye is decomposed and fixed at any of the first step, the second step or the subsequent fixing step by optical irradiation, thermal application or both of the two, while the color developing substance is deco posed and fixed at the second step or the subsequent fixing step by optical irradiation, thermal application or both of the two.

The term “polymerization reaction mode comprising forming latent image of residual discolorable dye and sensitizing the latent image” is schematically described below.

For example, a YAG-SHG laser of 532 nm irradiates a hologram recording material to allow a sensitizing dye to absorb the light to generate an excited state. Via energy transfer or electron transfer from the excited state of the sensitizing dye to the precursor of a discoloring agent, a discoloring agent is generated to discolor the discolorable dye. Consequently, a latent image of the residual discolorable dye can be formed (the first step). Then, irradiation of light in a wavelength region of 350 to 420 nm allows the latent image of the residual discolorable dye to absorb the light, to transfer electron or energy to the polymerization initiator to activate the polymerization initiator to initiate polymerization. In case that a polymerizable compound has a smaller refractive index than that of a binder, for example, the polymerizable compound accumulates in a part with the occurrence of polymerization, so that the refractive index gets smaller (the second step). Because the latent image is not so much generated in the dark part of interference at the first step, the polymerization occurs at a very low level at the second step to increase the existing binder ratio, so that a high level of refractive index modulation can be formed in the bright part of interference and the dark part of interference to enable recording as interference fringes. When the sensitizing dye and the residual discolorable dye are decomposed and discolored at the first and second steps or at the subsequent fixing step, a hologram recording material with excellent reproducing without damaging and with good storability can be provided.

Using again for example a 532-nm laser for irradiating the hologram recording material once used for recording, the recorded information, image and the like are generated or the hologram recording material can function as a desired optical material.

Specific examples of the polymerization reaction mode comprising forming latent image of residual discolorable dye and sensitizing the latent image are listed in Japanese Patent Application 2004-88790.

In the hologram recording material of the invention, additives such as electron donating compounds, electron accepting compounds, chain transfer agents, crosslinking agents, thermal stabilizers, plasticizers, and solvents may be used if necessary, in addition to sensitizing dyes, components of recording interference fringes, polymerization initiators, polymerizable compounds, binders, discolorable dyes, and precursors of discoloring agents.

Electron donating compounds have a potency of reducing radical cations of sensitizing dyes, color developing substances or discolorable dyes, while electron accepting compounds have a potency of oxidizing radical anions of sensitizing dyes, color developing substances or discolorable dyes. Both of the two compounds have a function to regenerate sensitizing dyes, color developing substances or discolorable dyes. Specifically, preferable examples thereof are disclosed in JP-A-2005-99751.

In particular, electron donating compounds are useful in terms of their high sensitivity because the compounds can rapidly regenerate radical cations of sensitizing dyes, color developing substances or discolorable dyes after electron transfer to a group of dye precursors. The electron donating compounds are preferably at lower oxidation potentials than those of sensitizing dyes, color developing substances or discolorable dyes. Preferable specific examples of the electron donating compounds are listed below. However, the invention is never limited by them.

### Examples of Electron Donating Compounds for Reproducing Sensitizing Dyes

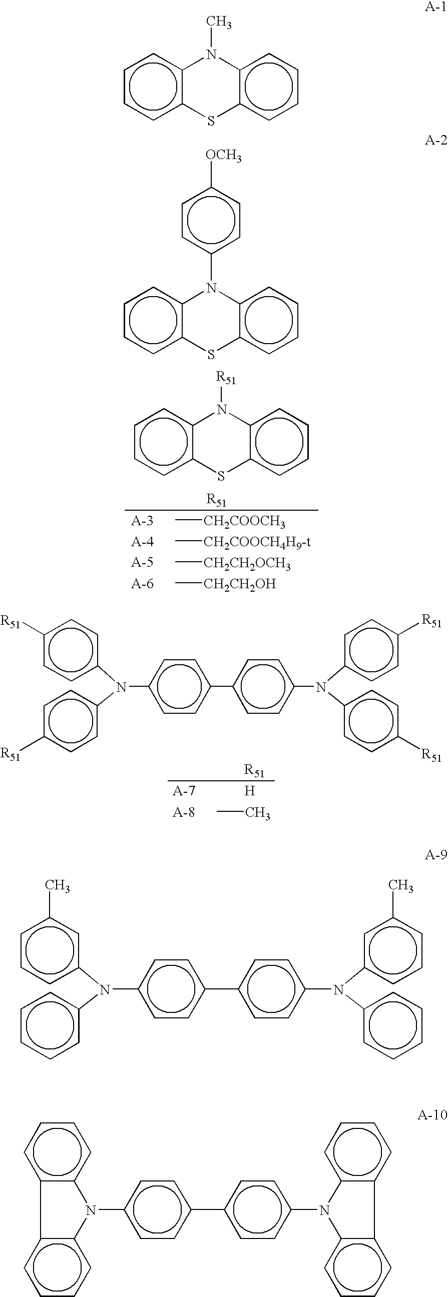

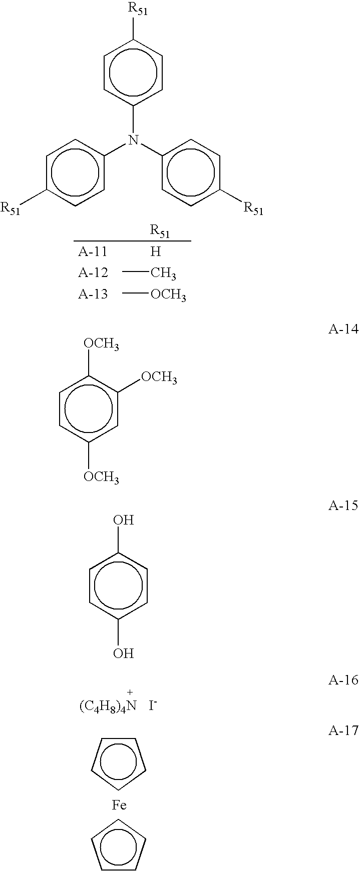

Particularly, the electron donating compounds preferably include phenothiazine-series compounds (for example, 10-methylphenothiazine, 10-(4′-methoxyphenyl)phenothiazine), triphenylamine-series compounds (for example, triphenylamine, tri(4′-methoxyphenyl)amine), TPD-series compounds (for example, TPD), more preferably phenothiazine-series compounds.

Herein, the sensitizing dye, the acid generator, the base generator, the dye precursor, the discolorable dye, the precursors of discoloring agents, the electron donating compounds and the like may be in oligomers or polymers, where these may be contained in the main chains or side chains thereof. These may be in the form of copolymers.

The main polymer chains may be in any structures, and preferably include for example polyether, polyester, polyamide, cellulose and acylated cellulose, such as polyacrylate and polymethacrylate, polystyrene, and polyethylene oxide.

The polymers or oligomers in accordance with the invention include repeat units of 2 or more to 1,000,000 or less, preferably 3 or more to 1,000,000 or less, more preferably 5 or more to 500,000 or less, most preferably 10 or more to 100,000 or less.

The polymers or oligomers of the invention have a molecular weight of 500 or more to 10,000,000 or less, preferably 1,000 or more to 5,000,000 or less, more preferably 2,000 or more to 1,000,000 or less, most preferably 3,000 or more to 1,000,000 or less.

Specific preferable examples of the chain transfer agents, the crosslinking agents, the thermal stabilizers, the plasticizers, and the solvents are disclosed in JP-A-2005-99753.

The chain transfer agents are preferably thiols, including for example 2-mercaptobenzoxazole, 2-mercaptobenzothiazole, 2-mercaptobenzimidazole, 4-methyl-4H-1,2,4-triazol-3-thiol, p-bromobenzenethiol, thiocyanuric acid, 1,4-bis(mercaptomethyl)benzene, and p-toluenethiol.

In case that the polymerization initiator is 2,4,5-triphenylimidazolyl dimer, in particular, a chain transfer agent is preferably used.

To the hologram recording material of the invention may be added a thermal stabilizer so as to improve the storability thereof during storage.

Useful thermal stabilizers include for example hydroquinone, phenidone, p-methoxyphenol, alkyl- and aryl-substituted hydroquinone and alkyl- and aryl-substituted quinine, catechol, t-butylcatechol, pyrogallol, 2-naphthol, 2,6-di-t-butyl-p-creasol, phenothiazine, and chloroanisole.

The plasticizers may be used so as to modify the adhesiveness, softness, hardness and other various mechanical properties of the hologram recording material. The plasticizers include for example triethylene glycol dicaprylate, triethylene glycol bis(2-ethylhexanoate), tetraethylene glycol diheptanoate, diethyl sebacate, dibutyl suberate, tris(2-ethylhexyl) phosphate, tricresyl phosphate, dibutyl phthalate, alcohols and phenols.

The hologram recording material of the invention may be prepared by general methods.

For example, a method for filming the hologram recording material may comprise dissolving the binder and the individual components in a solvent or the like and coating the resulting mixture with a spin coater or a bar coater.

Then, the solvent preferably includes for example ketone-series solvents such as methyl ethyl ketone, methyl isobutyl ketone, acetone, and cyclohexanone, ester-series solvents such as ethyl acetate, butyl acetate, ethylene glycol diacetate, ethyl lactate, and Cellosolve acetate; hydrocarbon-series solvents such as cyclohexane, toluene and xylene; ether-series solvents such as tetrahydrofuran, dioxane, and diethyl ether; Cellosolve-series solvents such as methyl Cellosolve, ethyl Cellosolve, butyl Cellosolve, and dimethyl Cellosolve; alcohol-series solvents such as methanol, ethanol, n-propanol, 2-propanol, n-butanol, and diacetone alcohol; fluorine-series solvents such as 2,2,3,3-tetrafluoropropanol; halogenated hydrocarbon-series solvents such as dichloromethane, chloroform and 1,2-dichloroethane; amide-series solvents such as N,N-dimethylformamide; and nitrile-series solvents such as acetonitrile and propionitrile.

The hologram recording material of the invention can be coated directly on a substrate using a spin coater, a roll coater or a bar coater or be cast as a film and then be laminated on a substrate. In such manner, the resulting material may be used as a hologram recording material.

Herein, the term “substrate” means an appropriate support naturally occurring or synthetically prepared preferably those capable of existing in soft or rigid film, sheet or plate.

The substrate preferably includes for example polyethylene terephthalate, resin-undercoated type polyethylene terephthalate, polyethylene terephthalate treated by flame or electrostatic discharge, cellulose acetate, polycarbonate, polymethyl methacrylate, polyester, polyvinyl acetate and glass.

The solvent used can be evaporated off during drying. For evaporation and removal, heating and reduced pressure may be used.

Additionally, the hologram recording material of the invention may be filmed by elevating the temperature of a binder containing the individual components to the glass transition temperature of the binder or more or to the melting point thereof for melting the binder and then melt-extruding or injecting and molding the resulting melt. Then, a reactive crosslinking binder is used as the binder for crosslinking after extrusion or molding, to cure the film to increase the film intensity. In that case, for example, radical polymerization reaction, cation polymerization reaction, condensation polymerization reaction and addition polymerization reaction may be used for the crosslinking reaction. Additionally, methods described in for example JP-A-2000-250382 and JP-A-2000-172154 are also preferably used.

Additionally, a method comprising dissolving the individual components in a monomer solution forming a binder and then thermally or optically polymerizing the monomer to prepare a polymer, and then using the polymer as the binder may also be used. As the polymerization method, then, radical polymerization reaction, cation polymerization reaction, condensation polymerization reaction and addition polymerization reaction may be used.

Further, a protective layer for oxygen blocking may be formed on the hologram recording material. The protective layer may be prepared by laminating together a plastic film or plate of polyolefin such as polypropylene and polyethylene, polyvinyl chloride, polyvinylidene chloride, polyvinyl alcohol, polyethylene terephthalate or cellophane via electrostatic adhesion or lamination with an extruder, or may be prepared by coating the polymer solution. Additionally, a glass plate may be laminated as the protective layer. Additionally, an adhesive or a fluid substance may exist in between the protective layer and a photosensitive film and/or in between the substrate and a photosensitive film, so as to raise the sealability.

In case that the hologram recording material of the invention is used for holographic optical memories, the hologram recording material preferably never shrinks before and after hologram recording, in terms of the improvement of the S/N ratio during signal reproducing.

Thus, for example, expanding agents described in JP-A-2000-86914, and shrink-resistant binders described in JP-A-2000-250382, JP-A-2000-172154 and JP-A-1-344917 are preferably used.

Additionally, dispersion elements described in JP-A-346687, JP-A-5-204288 and JP-T-Hei 9-506441 are preferably used to adjust the interval of interference fringes.

When multiple recording is done with known general photopolymers such as those described in JP-A-6-43634, JP-A-2-3082, JP-A-3-50588, JP-A-5-107999, JP-A-8-16078, JP-T-2001-523842 and JP-T-11-512847, recording is done on highly polymerized portions in the late stage of the multiple recording. Compared with the early stage of the multiple recording, a certain exposure time is required for recording even the same signal (sensitivity is lowered), which is a very significant problem in terms of system designing. In other words, it has been a problem that the range of the linear increase of refractive index modulation vs. exposure level is very narrow. In contrast the recording methods via 2) color developing reaction, 3) color developing reaction comprising latent image formation via color developing and the self-sensitization and amplification of a color developing substance and 6) dye discoloring reaction, in accordance with the invention, never involve any polymerization for recording interference fringes, while the recording methods via 4) polymerization reaction comprising latent, image formation via color developing and sensitizing a color developing substance and 7) polymerization reaction comprising forming latent image of residual discolorable dye and sensitizing the latent image almost never involve polymerization reaction during hologram exposure (the first step), while at the second step, refractive index modulation via polymerization is done collectively through whole surface exposure. Therefore, numerous multiple recordings can be done by any one of the methods via 2) through 4), 6) and 7), while multiple recording is done involving the linear increase of refractive index modulation level vs. exposure level where the exposure level for multiple recording is absolutely constant during any multiple recording. Accordingly, a wide dynamic range can be gained. As described above, the recording modes of 2) to 4), and 6) and 7) using the color developing mode, the discoloring mode or the latent image amplification mode are very advantageous in terms of the appropriateness for multiple recording.

This is very preferable from the standpoints of high density (capacity), recording system simplification, the improvement of S/N ratio and the like.

As described above, the hologram recording material of the invention has totally overcome the problems described above, to enable a totally new recording method consistently realizing high sensitivity along with good storability, dry processing applicability, and a multiple recording performance (high recording density). The hologram recording material is preferably used in optically recording medium (holographic optical memory), in particular.

When the hologram recording material of the invention is used as an optical recording medium, the medium composition described in JP-A-2004-265472 may be used. In that case, recording is preferably reproduced using the system described in JP-A-2004-335044. Additionally, recording is preferably reproduced using the systems described in JP-A-2004-177958 and JP-A-2004-272268.

Further, the hologram recording material of the invention may preferably be used as three-dimensional display hologram, holographic optical elements (HOE, for example head-up display (HUD) for vehicles, optical disk pickup lens, head-mount display, color filer for liquid crystal, reflection type liquid crystal reflection plate, lens, diffraction lattice, interference filter, binder for optical fiber, optical depolarizer for facsimile, building window glass), top pages for books and magazines, displays such as POP, gift, credit card and paper money for the security purpose for preventing forgery, and packages.

### EXAMPLES

Specific examples of the invention are described below on the basis of experimental results. It is needless to say that the invention is never limited by these Examples.

### Example 1

### (Hologram Recording Method via Color Developing Mode)

In a red lamp, the sensitizing dyes, the electron donating compounds, the acid generators, the dye precursors, the additives, and the binder PMMA-EA (a copolymer of poly(methyl methacrylate) and 5% ethyl acrylate and with a molecular weight of 101,000) were dissolved in a 2- to 4-fold mass weight of methylene chloride (in combination with acetone or acetonitrile if necessary), to prepare compositions for hologram recording materials, namely 1-1, 1-2, 2-1 through 2-5, 3-1 through 3-3 and compositions for comparative samples 1, 2 and 3. Herein, the term % expresses “% by mass” to the binder PMMA-EA, with no exception.

TABLE I

| | |
|---|---|
| | SO-3 |
| 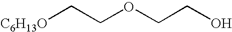 | |

| | | Electron | | | |
|---|---|---|---|---|---|
| | | donating | | | |
| Samples | Sensitizing dye | compound | Acid generator | Dye precursor | Additive |
| Comparative | S-93 at 1.6% | A-1 at 42% | I-5 at 50% | L-2 at 10% | SO-3 at 8% |
| Example 1 | | | | | |
| Example 1-1 | S-93 at 1.6% | A-1 at 42% | PI-1 at 50% | L-2 at 10% | SO-3 at 8% |
| Example 1-2 | SS-6 at 5.1% | A-1 at 42% | PI-1 at 50% | L-2 at 10% | SO-3 at 8% |
| Comparative | S-93 at 1.6% | A-1 at 42% | I-5 at 50% | LC-19 at 10% | SO-3 at 8% |
| Example 2 | | | | | |
| Example 2-1 | S-93 at 1.6% | A-1 at 42% | PI-1 at 50% | LC-19 at 10% | SO-3 at 8% |
| Example 2-2 | SS-6 at 5.1% | A-1 at 42% | PI-1 at 50% | LC-19 at 10% | SO-3 at 8% |
| Example 2-3 | SS-6 at 5.1% | A-1 at 42% | PI-28 at 50% | LC-19 at 10% | SO-3 at 8% |
| Example 2-4 | SS-1 at 1.2% | A-3 at 42% | PI-28 at 50% | LC-19 at 10% | SO-3 at 8% |
| Example 2-5 | SS-26 at 1.2% | A-1 at 42% | PI-1 at 50% | LC-19 at 10% | SO-3 at 8% |
| Comparative | S-93 at 1.6% | A-1 at 42% | I-5 at 50% | LC-31 at 12% | SO-3 at 8% |
| Example 3 | | | | | |
| Example 3-1 | SS-14 at 1.7% | A-1 at 42% | I-5 at 50% | LC-31 at 12% | SO-3 at 8% |
| Example 3-2 | SS-6 at 5.1% | A-1 at 42% | PI-1 at 50% | LC-31 at 12% | SO-3 at 8% |
| Example 3-3 | SS-6 at 5.1% | A-1 at 42% | PI-28 at 50% | LC-31 at 12% | SO-3 at 8% |

Coating the compositions 1-1, 1-2, 2-1 through 2-5, and 3-1 through 3-3 for the hologram recording materials and the compositions for comparative samples 1, 2 and 3 on a glass substrate, using a blade to a final thickness of about 80 μm (overcoating if necessary), to form photosensitive layers, and drying the layers at 40° C. for 2 days, solvents were distilled off. By covering the photosensitive layers with a TAC film, further, the hologram recording materials 1-2, 1-2, 2-1 through 2-5, and 3-1 through 3-3 and the comparative hologram recording materials 1, 2 and 3 were prepared.

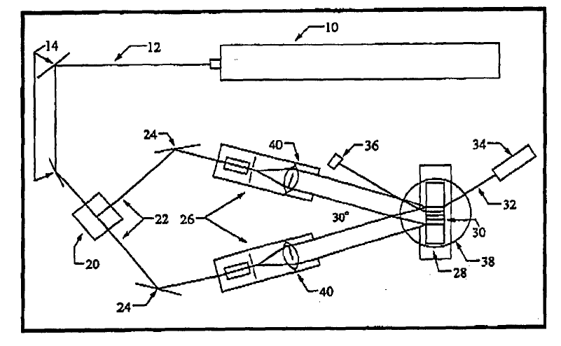

The hologram recording materials were exposed to an optical two-beam system for the transmission type hologram recording as shown in FIG. 1, using as light source YAG-SHG laser (532 nm at an output of 2 W) for recording. The subject light and the reference light make an angle of 30 degrees from each other. The light was at a diameter of 0.6 cm and an intensity of 8 mW/cm², while the exposure was done while the holography exposure time was changed in a range of 0.1 to 2,000 seconds (an irradiation energy level of 0.8 to 16,000 mJ/cm²). During hologram exposure, the light of a He—Ne laser at 632 nm transmitted through the center of the exposure region at the Bragg angle, to measure the ratio of the diffracted light to the transmitting light (relative diffraction efficiency) on real time. Herein, the He—Ne laser never makes the hologram recording materials photo-sensitive because no absorption of the sensitizing dye occurs at 632 nm.

The maximum diffraction efficiency and shrinkage ratio of the hologram recording materials 1-1, 1-2, 2-1 through 2-5, and 3-1 through 3-3 and the comparative hologram recording materials 1, 2 and 3 were examined. The results are shown in Table 2. Herein, the shrinkage ratio was determined on the basis of the change of the maximum diffraction wavelength when reflection type hologram was recorded. Further, the hologram recording material according to the radical polymerization photopolymer mode in Example 1 of JP-A-6-43634 was prepared as Comparative Example 4.

TABLE 2

| | Maximum diffraction | |
|---|---|---|
| Sample | efficiency “η” | Shrinkage ratio |
| Comparative Example 1 | 88% | <0.01% |
| Example 1-1 | 92 | <0.01% |
| Example 1-2 | 93 | <0.01% |
| Comparative Example 2 | 89 | <0.01% |
| Example 2-1 | 93 | <0.01% |
| Example 2-2 | 95 | <0.01% |
| Example 2-3 | 95 | <0.01% |
| Example 2-4 | 94 | <0.01% |
| Example 2-5 | 94 | <0.01% |
| Comparative Example 3 | 88 | <0.01% |
| Example 3-1 | 94 | <0.01% |
| Example 3-2 | 95 | <0.01% |
| Example 3-3 | 95 | <0.01% |
| Comparative Example 4 | 81 | 5.1% |

Table 2 indicates that the hologram recording materials of the invention, namely 1-1, 1-2, 2-1 through 2-5, and 3-1 through 3-3 have higher diffraction efficiencies than those of the Comparative hologram recording materials 1 to 4 and are advantageous in terms of multiple recording.

Additionally, the known hologram recording material as the Comparative Example 4, which is described in JP-A-643634, is according to the photopolymer mode and involves therefore larger shrinkage exceeding 5%. Hence, the hologram recording material is not suitable for use in holographic memories because the S/N ratio thereof is highly deteriorated. In contract, the hologram recording materials of the invention, namely 1-1, 1-2, 2-1 through 2-5, and 3-1 through 3-3 are according to a totally different recording mode from the photopolymer mode, where hologram recording is done via refractive index modulation using a color developing reaction, with no use of substance transfer or polymerization. Therefore, the hologram recording materials of the invention can consistently attain high diffraction efficiency and a shrinkage ratio as small as 0.01% or less and are thus suitable for use in holographic memories.

Further, the hologram recording materials of the invention are advantageous for multiple recording owing to the almost linear increase of Δn (refractive index modulation level in interference fringes as calculated on the basis of the diffraction efficiency and the film thickness, according to the Kugelnik's formula) depending on the exposure level (mJ/cm²).

It was actually confirmed that individual subject lights could be reproduced with the hologram recording materials of the invention, by carrying out ten-time multiple recordings on the same portion at a light level 1/10-fold the exposure level giving the maximum diffraction efficiency while the angle of the reference light was changed by 2 degrees, and subsequently irradiating the reproducing light while the angle of the reproducing light was changed by 2 degrees. In other words, multiple recording can be done on the hologram recording materials of the invention at the same exposure level, indicating the hologram recording materials of the invention have a suitable performance for multiple recording. As described above, the hologram recording materials of the invention enable so numerous multiple recordings thereon that high-density (capacity) recording can be done thereon.

In contrast, the polymerization of photopolymers in known photopolymer-mode hologram recording materials mainly including the hologram recording material in JP-A-643634 is in progress at the late stage of multiple recording, to slow down the monomer transfer needed for recording, so that the photopolymer-mode hologram recording materials require higher irradiation light levels at the late stage compared with the early stage thereof, for the same recording. Accordingly, these hologram recording materials are problematic in improving multiplicity, namely recording density.

Additionally, the hologram recording materials of the invention, namely 1-1, 1-2, 2-1 through 2-5, and 3-1 through 3-3 and the hologram recording materials of the Comparative Examples, namely 1 to 4, were stored in darkness at 80° C. under dry conditions for 2 weeks, to measure the diffraction efficiency. The residual ratio of the diffraction efficiency after 1-week storage to the diffraction efficiency at the initial time of storage is shown collectively below in Table 3.

TABLE 3

| | Residual ratio of diffraction |
|---|---|
| Sample | efficiency η |
| Comparative Example 1 | 80% |
| Example 1-1 | 99 |
| Example 1-2 | 99 |
| Comparative Example 2 | 38 |
| Example 2-1 | 93 |
| Example 2-2 | 94 |
| Example 2-3 | 94 |
| Example 2-4 | 92 |
| Example 2-5 | 92 |
| Comparative Example 3 | 70 |
| Example 3-1 | 82 |
| Example 3-2 | 97 |
| Example 3-3 | 96 |
| Comparative Example 4 | 75 |

Table 3 indicates that the hologram recording materials using the enhancer and the acid generator in accordance with the invention, particularly the hologram recording materials using the acid generator of the invention represented by the formula (1-1) or (1-2) have excellent storability in darkness.

Furthermore, the sensitizing dyes in the samples 1-1, 1-2, 2-1 through 2-5, and 3-1 through 3-3 were replaced with SS-2, SS-3, SS-5, SS-8, SS-11, SS-12, SS-13, SS-15, SS-16, SS-24, SS-25, SS-27, SS-29 and SS-30. The similar effects could then be obtained.

Still furthermore, the sensitizing dyes were replaced with S-1, S-4, S-6, S-8, S-10, S-11, S-19, S-23, S-31, S-33, S-34, S-43, S-45, S-46, S-50, S-58, S-67, S-71, S-73 through S-75, S-77, S-80, S-81, S-88, S-91, S-92, and S-94 to S-96, when the acid generator represented by the formula (1-1) or (1-2) in accordance with the invention was used. The similar effects could then be obtained.

Additionally, the acid generators in the samples 1-1, 1-2, 2-1 through 2-5, and 3-1 through 3-3 were replaced with PI-2 through PI-7, PI-13 through PT-17, PI-19 through PI-21, PI-29 through PI-34, PI-40 through PI-45, and PI-47 through PI-49. The similar effects could then be obtained. Still additionally, the dye precursors of a type of developing color with acid in the samples 1-1, 1-2, 2-1 through 2-5, and 3-1 through 3-3 were replaced with L-1, L-3, LC-9, LC-11, LC-12, LC-16 through LC-18, LC-20, LC-21, LC-23, LC-30, and LC-32 through LC-36. The similar effects could then be obtained.

Further, the electron donors in the samples 1-1, 1-2, 2-1 through 2-5, and 3-1 through 3-3 were replaced with A-2, A-4 through A-9, and A-12 through A-14. The similar effects could be obtained.

Additionally, the binders in the samples 1-1, 1-2, 2-1 through 2-5, and 3-1 through 3-3 were replaced with for example polymethyl methacrylate (Mw of 996,000, 350,000, 120,000), polymethyl methacrylate-butyl acrylate copolymer (Mw of 75,000), polyvinyl acetal (Mw of 83,000), polycarbonate, and cellulose acetate butylate. The similar effects could be obtained.

### Example 2

### (Hologram Recording Method via Discoloring Mode (with Sensitizing Dye+Discolorable Dye))

In a red lamp, the sensitizing dyes, the electron donating compounds, the acid generators, the dye precursors, the additives, and the binder PMMA-EA (a copolymer of polymethyl methacrylate and 5% ethyl acrylate and with a molecular weight of 101,000) as shown in Table 4 were dissolved in a 2- to 4-fold mass weight of methylene chloride (in combination with acetone or acetonitrile, if necessary), to prepare compositions for hologram recording materials, namely 5-1 through 5-5, 6-1 through 6-3 and compositions 5 and 6 for comparative samples. Herein, the “%” expresses “% by mass to the binder PMMA-EA”, with no exception.

TABLE 4

| | | Electron | | Acid- |
|---|---|---|---|---|
| | Sensitizing | donating | Acid | discolorable |
| Samples | dye | compound | generator | dye |
| Comparative | S-93 at 1.6% | A-1 at 42% | I-5 at 50% | G-37 at |
| Example 5 | | | | 13.6% |
| Example 5-1 | S-93 at 1.6% | A-1 at 42% | PI-1 at 50% | G-37 at |
| | | | | 13.6% |
| Example 5-2 | SS-6 at 5.1% | A-1 at 42% | PI-1 at 50% | G-37 at |
| | | | | 13.6% |
| Example 5-3 | SS-6 at 5.1% | A-1 at 42% | PI-28 at 50% | G-37 at |
| | | | | 13.6% |
| Example 5-4 | SS-1 at 1.2% | A-3 at 42% | PI-1 at 50% | G-37 at |
| | | | | 13.6% |
| Example 5-5 | SS-26 at 1.2% | A-1 at 42% | PI-1 at 50% | G-37 at |
| | | | | 13.6% |
| Comparative | S-93 at 1.6% | A-1 at 42% | I-5 at 50% | G-26 at |
| Example 6 | | | | 10.8% |
| Example 6-1 | S-93 at 1.6% | A-1 at 42% | PI-1 at 50% | G-26 at |
| | | | | 10.8% |
| Example 6-2 | SS-6 at 5.1% | A-1 at 42% | PI-1 at 50% | G-26 at |
| | | | | 10.8% |
| Example 6-3 | SS-6 at 5.1% | A-1 at 42% | PI-28 at 50% | G-26 at |
| | | | | 10.8% |

Coating the compositions 5-1 through 5-5, and 6-1 through 6-3 for the hologram recording materials and the compositions 5 and 6 for comparative samples on a glass substrate using a blade to a final thickness of about 80 μm (overcoating if necessary), to form photosensitive layers, and drying the layers at 40° C. for 2 days, solvents were distilled off. By covering the photosensitive layers with a TAC film, further, the hologram recording materials 5-1 through 5-5 and 6-1 through 6-3 and the comparative hologram recording materials 5 and 6 were prepared.

The hologram recording materials were exposed to an optical two-beam system for the transmission type hologram recording as shown in FIG. 1, using as a light source YAG-SHG laser (532 nm at an output of 2 W) for recording. The subject light and the reference light make an angle of 30 degrees from each other. The light is at a diameter of 0.6 cm and an intensity of 8 mW/cm², while the exposure was done while the holography exposure time was changed in a range of 0.1 to 2,000 seconds (an irradiation energy level at 0.8 to 16,000 mJ/cm²). During hologram exposure, the light of a He—Ne laser at 632 nm transmitted through the center of the exposure region at the Bragg angle, to measure the ratio of the diffracted light to the transmitting light (relative diffraction efficiency) on real time. Herein, the He—Ne laser never makes the hologram recording materials photo-sensitive because no absorption of the sensitizing dye occurs at 632 nm.

The maximum diffraction efficiency, sensitivity and shrinkage ratio of the hologram recording materials 5-1 through 5-5, and 6-1 through 6-3 and the comparative hologram recording materials 5 and 6 were examined. The results are shown in Table 5. Herein, the shrinkage ratio was determined on the basis of the change of the maximum diffraction wavelength when reflection type hologram was recorded. Further, the hologram recording material of the radical polymerization photopolymer mode in Example 1 of JP-A-6-43634 was prepared as an comparative example 4.

TABLE 5

| | Maximum diffraction | |
|---|---|---|
| Sample | efficiency “η” | Shrinkage ratio |
| Comparative Example 5 | 88% | <0.01% |
| Example 5-1 | 92 | <0.01% |
| Example 5-2 | 95 | <0.01% |
| Example 5-3 | 94 | <0.01% |
| Example 5-4 | 93 | <0.01% |
| Example 5-5 | 93 | <0.01% |
| Comparative Example 6 | 88 | <0.01% |
| Example 6-1 | 92 | <0.01% |
| Example 6-2 | 95 | <0.01% |
| Example 6-3 | 95 | <0.01% |
| Comparative Example 4 | 81 | 5.1% |

Table 5 indicates that the hologram recording materials of the invention, namely 5-1 through 5-5, and 6-1 through 63 have higher diffraction efficiencies than those of the Comparative hologram recording materials 5 and 6 and are advantageous in terms of multiple recording.

Additionally, the known hologram recording material as the Comparative Example 4, which is described in JP-A-6-43634, is according to the photopolymer mode involving radical polymerization and involves therefore a larger shrinkage ratio exceeding 5%. Hence, the hologram recording material is not suitable for use in holographic memories because the S/N ratio thereof is highly deteriorated. In contract, the hologram recording materials of the invention, namely 5-1 through 5-5, and 6-1 through 6-3 are according to a totally different recording mode from the photopolymer mode, where hologram recording is done via refractive index modulation using a color developing reaction, with no use of substance transfer or polymerization. Therefore, the hologram recording materials of the invention can consistently attain a high diffraction efficiency level and a shrinkage ratio as small as 0.01% or less and are thus suitable for use in holographic memories.

Further, the hologram recording materials of the invention are advantageous for multiple recording owing to the almost linear increase of Δn (refractive index modulation level in interference fringes as calculated on the basis of the diffraction efficiency and the film thickness according to the Kugelnik's formula) depending on the exposure level (mJ/cm²).

It was actually confirmed that individual subject lights could be reproduced with the hologram recording materials of the invention by carrying out ten-time multiple recordings on the same portion at a light level 1/10-fold the exposure level giving the maximum diffraction efficiency while the angle of the reference light was changed by 2 degrees, and subsequently irradiating the reproducing light while the angle of the reproducing light was changed by 2 degrees. In other words, multiple recording can be done on the hologram recording materials of the invention at the same exposure level, indicating the hologram recording materials of the invention have a suitable multiple recording profile. As described above, the hologram recording materials of the invention enable so numerous multiple recordings thereon that high-density (capacity) recording can be done thereon.

In contrast, the polymerization of photopolymers in known photopolymer-mode hologram recording materials mainly including the hologram recording material in JP-A-6-43634 is in progress at the late stage of multiple recording, to slow down monomer transfer needed for recording, so that the photopolymer-mode hologram recording materials require higher irradiation light levels at the late stage thereof, compared with the early stage thereof, for the same recording. Accordingly, these hologram recording materials are problematic in improving multiplicity, namely recording density.

Additionally, the hologram recording materials of the invention, namely 5-1 through 5-5, and 6-1 through 6-3 and the hologram recording materials of the Comparative Examples 4 to 6 were stored in darkness at 80° C. under dry conditions for 2 weeks, to measure the diffraction efficiency. The residual ratio of the diffraction efficiency after 1-week storage to the diffraction efficiency at the initial time of storage is shown collectively below in Table 6.

TABLE 6

| | Residual ratio of diffraction |
|---|---|
| Sample | efficiency η |
| Comparative Example 5 | 28% |
| Example 5-1 | 91 |
| Example 5-2 | 92 |
| Example 5-3 | 90 |
| Example 5-4 | 92 |
| Example 5-5 | 92 |
| Comparative Example 6 | 32 |
| Example 6-1 | 92 |
| Example 6-2 | 93 |
| Example 6-3 | 91 |
| Comparative Example 4 | 75 |

Table 6 indicates that the hologram recording materials using the enhancer and the acid generator in accordance with the invention, particularly the hologram recording materials using the acid generator of the invention represented by the formula (1-1) or (1-2) have excellent storability in darkness.

Furthermore, the sensitizing dyes in the samples 5-1 through 5-5, and 6-1 through 6-3 were replaced with SS-2, SS-3, SS-5, SS-8, SS-11 through SS-16, SS-24, SS-25, SS-27, SS-29 and SS-30. The similar effects could then be obtained.

Still furthermore, the sensitizing dyes were replaced with S-1, S-4, S-6, S-8, S-10, S-11, S-19, S-23, S-31, S-33, S-34, S-43, S-45, S-46, S-50, S-58, S-67, S-71, S-73 through S-75, S-77, S-80, S-81, S-88, S-91, S-92, and S-94 through S-96, when the acid generator represented by the formula (1-1) or (1-2) in accordance with the invention was used. The similar effects could then be obtained.

Additionally, the acid generators in the samples 5-1 through 5-5, and 6-1 through 6-3 were replaced with PI-2 through PI-7, PI-13 through PI-17, PI-19 through PI-21, PI-29 through PI-34, PI-40 through PI-45, and PI-47 through PI-49. The similar effects could then be obtained.

Still additionally, the acid-discolorable dyes in the samples 5-1 through 5-5, and 61 through 6-3 were replaced with G-20 through G-25, G-27 through G-32, G-35, G-36, G-38 through G-41, G-46 through G-48, G51, G-53 and G-54. The similar effects could then be obtained.

Further, the electron donors in the samples 5-1 through 5-5, and 6-1 through 6-3 were replaced with A-2, A-4 through A-9, and A-12 through A-14. The similar effects could be obtained.

Additionally, the binders in the samples 5-1 through 5-5, and 6-1 through 6-3 were replaced with polymethyl methacrylate (Mw of 996,000, 350,000, 120,000), polymethyl methacrylate-butyl acrylate copolymer (Mw of 75,000), polyvinyl acetal (Mw of 83,000), polycarbonate, and cellulose acetate butylate. The similar effects could be obtained.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

What is claimed is:

1. A hologram recording material comprising an acid generator represented by one of formulae (1-1) and (1-2): 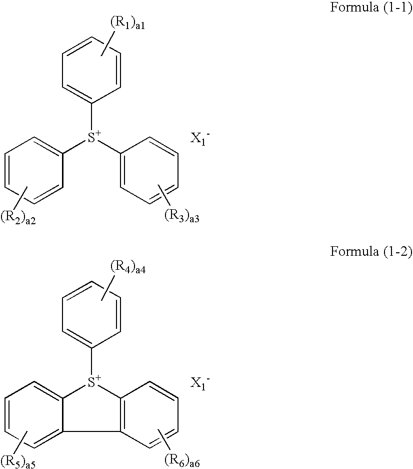
wherein R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; as and a6 independently represent an integer of 0 to 4, provided that R₁, R₂, R₃, R₄, R₅ and R₆ independently existing in plurality may be the same or different when a1 through a6 are 2 or more; and X₁⁻ represents an anion.

2. The hologram recording material according to claim 1 where the acid generators represented by formula (1-1) and (1-2) are represented by the formulae (1-3) and (1-4), respectively: 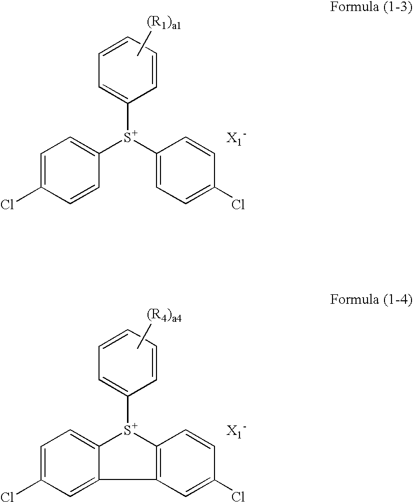
where R₁, R₄, a1, a4, and X₁⁻ have individually the same meanings as in formulae (1-1) and (1-2).

3. The hologram recording material according to claim 2, where the acid generators represented by formulae (1-3) and (14) are represented by formulae (1-5) and (1-6), respectively: 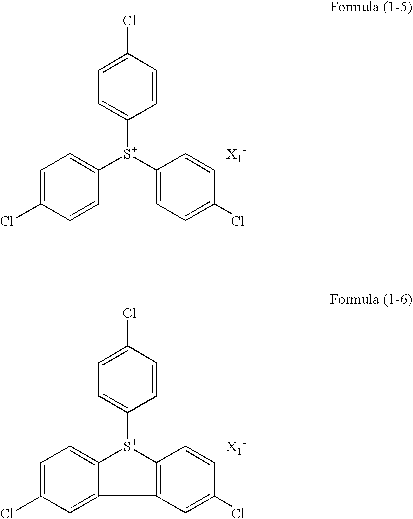
wherein X₁⁻ has the same meaning as in formula (1-1).

4. A hologram recording method comprising recording a refractive index modulation providing interference fringes in an hologram recording material comprising an acid generator represented by one of formulae (1-1) to (1-6): 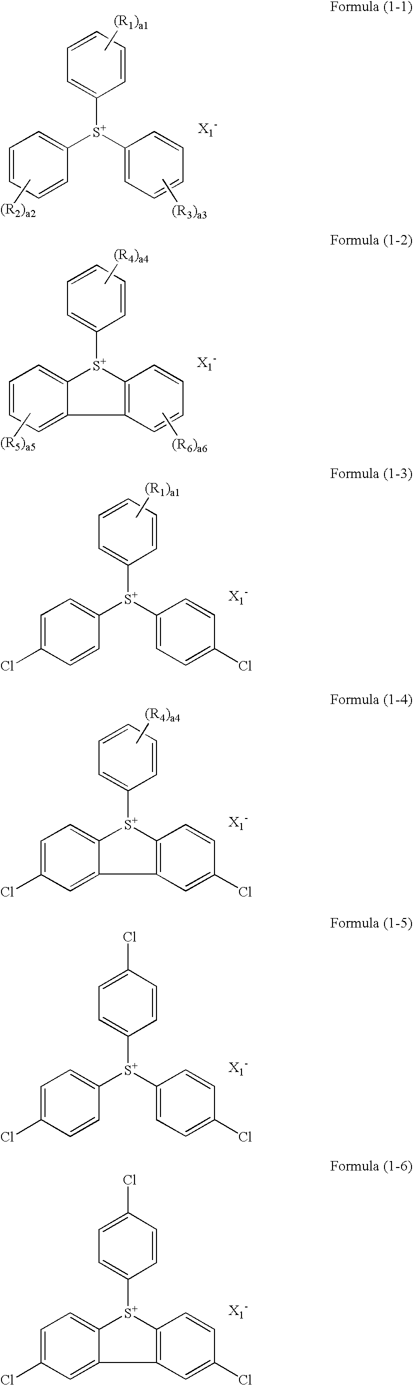
wherein R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; a5 and a6 independently represent an integer of 0 to 4, provided that R₁, R₂, R₃, R₄, R₅ and R₆ independently existing in plurality may be the same or different when a1 through a6 are 2 or more; and X₁⁻ represents an anion,
wherein the recording is performed by one reaction of 1) a polymerization reaction, 2) a color developing reaction, 3) a color developing reaction comprising forming a latent image via a color developing and self-sensitizing and amplifying a color developing substance, 4) a polymerization reaction comprising forming a latent image formation via a color developing and sensitizing a color developing substance, 5) an orientation change of a compound having an intrinsic birefringence, 6) a dye discoloring reaction, and 7) a polymerization reaction comprising forming an latent image of a residual discolorable dye and sensitizing the latent image.

5. A hologram recording material containing a sensitizing dye represented by one of formulae (2-1) through (2-5): 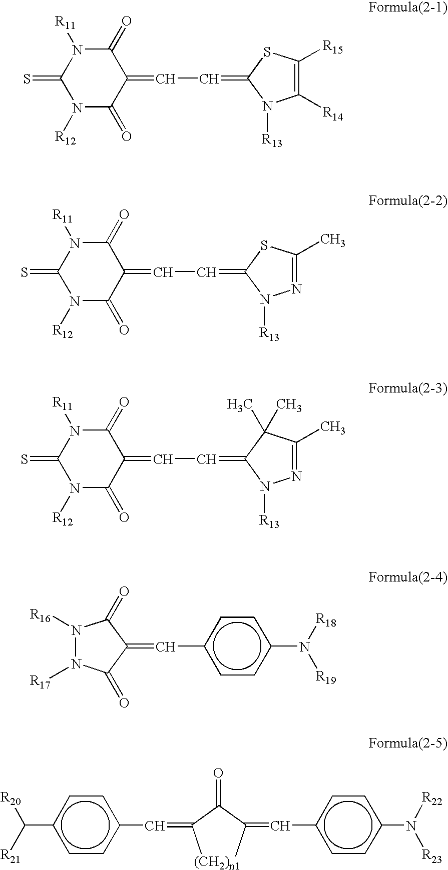
wherein R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group; R₁₈, R₁₉, R₂₀, R₂₁, R₂₂ and R₂₃ independently represent an alkyl group, an alkenyl group, a cycloalkyl group, or an aryl group; R₁₈ and R₁₉, R₂₀ and R₂₁, or R₂₂ and R₂₃ may independently bind together to form a ring; and n1 represents any integer of 0, 1, 3 and 4.

6. The hologram recording material according to claim 5, where R₁₈, R₂₀ and R₂₂ are independently an alkyl group substituted having an electron attractive group.

7. A hologram recording method comprising recording refractive index modulation providing interference fringes in an hologram recording material comprising a sensitizing dye represented by one of formulae (2-1) to (2-5): 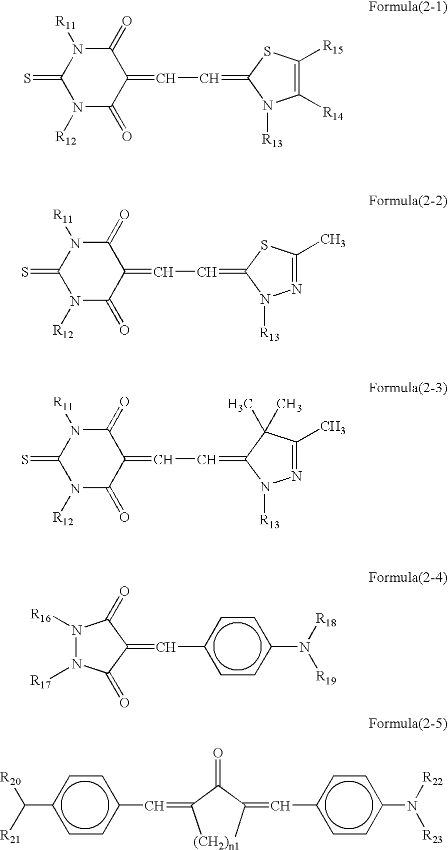
wherein R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group; R₁₈, R₁₉, R₂₀, R₂₁, R₂₂ and R₂₃ independently represent an alkyl group, an alkenyl group, a cycloalkyl group, or an aryl group; R₁₈ and R₁₉, R₂₀ and R₂₁, or R₂₂ and R₂₃ may independently bind together to form a ring; and n1 represents any integer of 0, 1, 3 and 4,
wherein the recording is performed by one reaction of 1) a polymerization reaction, 2) a color developing reaction, 3) a color developing reaction comprising forming a latent image via a color developing and self-sensitizing and amplifying a color developing substance, 4) a polymerization reaction comprising forming a latent image formation via a color developing and sensitizing a color developing substance, 5) an orientation change of a compound having an intrinsic birefringence, 6) a dye discoloring reaction, and 7) a polymerization reaction comprising forming an latent image of a residual discolorable dye and sensitizing the latent image.

8. A hologram recording method comprising recording a refractive index modulation providing interference fringes in an hologram recording material comprising an acid generator and a sensitizing dye,
wherein the acid generator is represented by one of formulae (1-1) to (1-6): 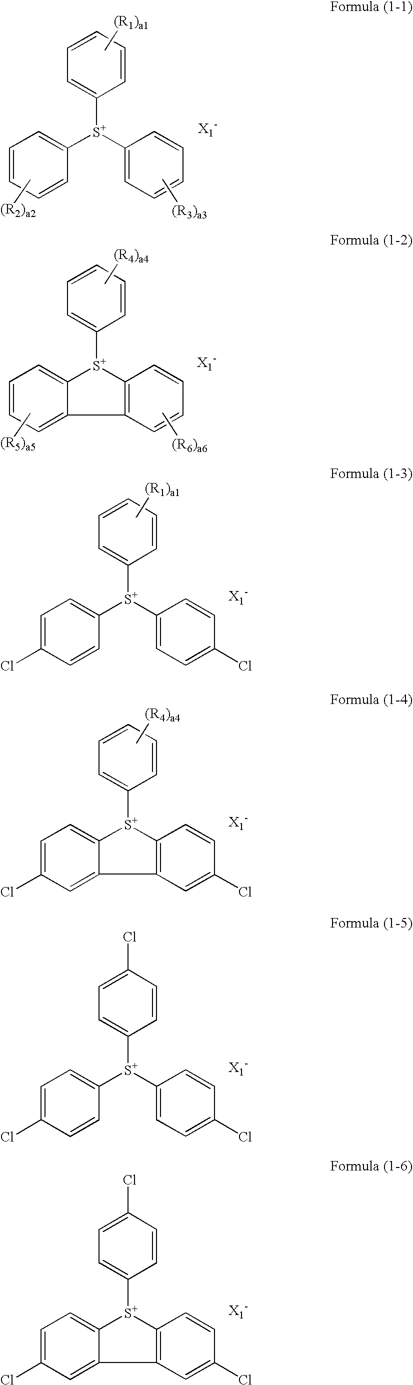
wherein R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; a5 and a6 independently represent an integer of 0 to 4, provided that R₁, R₂, R₃, R₄, R₅ and R₆ independently existing in plurality may be the same or different when a1 through a6 are 2 or more; and X₁⁻ represents an anion,
wherein the sensitizing dye is represented by one of formulae (2-1) to (2-5): 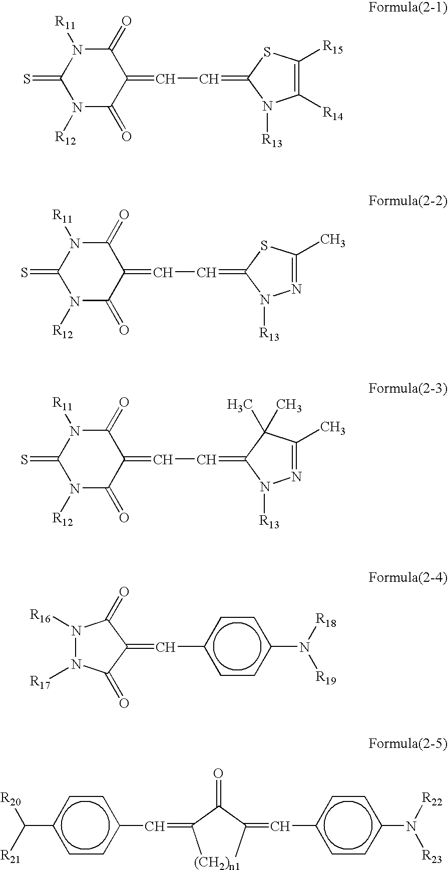
wherein R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group; R₁₈, R₁₉, R₂₀, R₂₁, R₂₂ and R₂₃ independently represent an alkyl group, an alkenyl group, a cycloalkyl group, or an aryl group; R₁₈ and R₁₉, R₂₀ and R₂₁, or R₂₂ and R₂₃ may independently bind together to form a ring; and n1 represents any integer of 0, 1, 3 and 4, and
wherein the recording is performed by one reaction of 1) a polymerization reaction, 2) a color developing reaction, 3) a color developing reaction comprising forming a latent image via a color developing and self-sensitizing and amplifying a color developing substance, 4) a polymerization reaction comprising forming a latent image formation via color developing and sensitizing a color developing substance, 5) an orientation change of a compound having an intrinsic birefringence, 6) a dye discoloring reaction, and 7) a polymerization reaction comprising forming an latent image of a residual discolorable dye and sensitizing the latent image.

9. A hologram recording material for a hologram recording method comprising recording a refractive index modulation providing interference fringes in the hologram recording material by one reaction of 2) a color developing reaction and 3) color developing reaction comprising forming a latent image via color developing and self-sensitizing and amplifying a color developing substance,
the hologram recording material comprising:
1) a sensitizing dye absorbing light upon hologram exposure to generate an excited state of the sensitizing dye,
2) a precursor capable of adding an acid thereto to become the color developing substance having an absorption in a wavelength longer than that of the precursor and having no absorption in a wavelength of hologram reproducing light, and
3) an acid generator generating an acid via an electron transfer from the excited state of the sensitizing dye or from the excited state of the precursor,
wherein the sensitizing dye is represented by one of formulae (2-1) to (2-5) or the acid generation is represented by one of formulae (1-1) to (1-6): 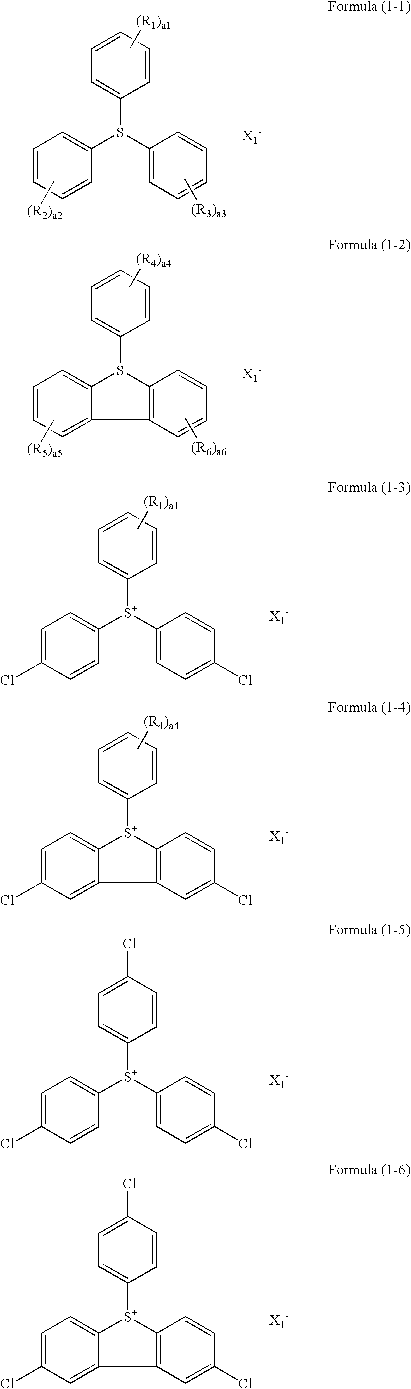 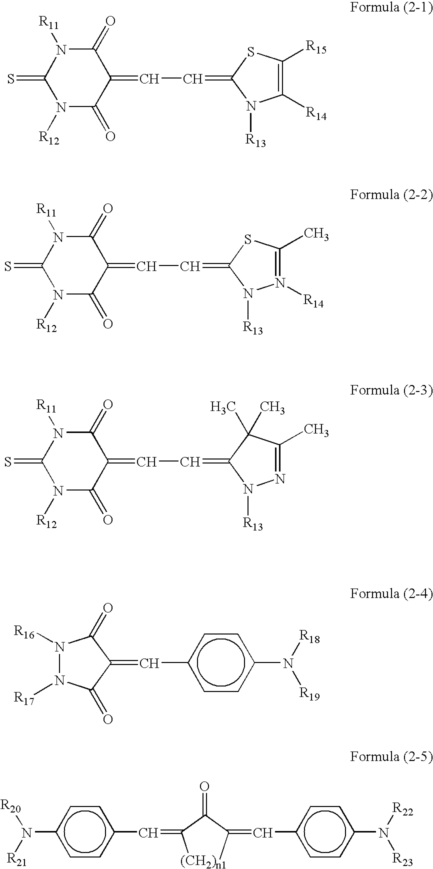
wherein R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; a5 and a6 independently represent an integer of 0 to 4, provided that R₁, R₂, R₃, R₄, R₅ and R₆ independently existing in plurality may be the sane or different when a1 through a6 are 2 or more; and X₁⁻ represents an anion, and wherein R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group; R₁₈, R₁₉, R₂₀, R₂₁, R₂₂ and R₂₃ independently represent an alkyl group, an alkenyl group, a cycloalkyl group, or an aryl group; R₁₈ and R₁₉, R₂₀ and R₂₁, or R₂₂ and R₂₃ may independently bind together to form a ring; and n1 represents any integer of 0, 1, 3 and 4.

10. A hologram recording method comprising recording a refractive index modulation providing interference fringes in an hologram recording material comprising at least one of an acid generator and a sensitizing dye,
wherein the acid generator is represented by one of formulae (1-1) to (1-6): 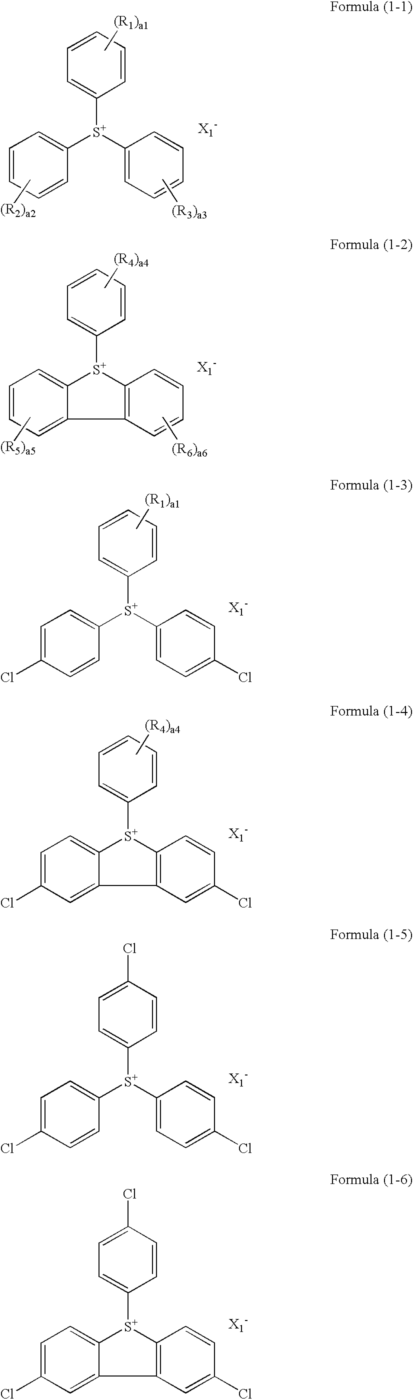
wherein R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; as and a6 independently represent an integer of 0 to 4, provided that R₁, R₂, R₃, R₄, R₅ and R₆ independently existing in plurality may be the same or different when a1 through a6 are 2 or more; and X₁⁻ represents an anion,
wherein the sensitizing dye is represented by one of formulae (2-1) to (2-5): 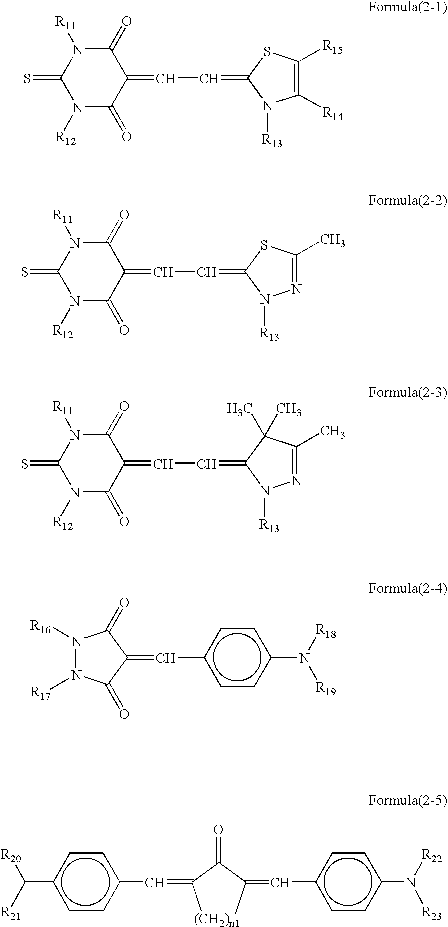
wherein R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group; R₁₈, R₁₉, R₂₀, R₂₁, R₂₂ and R₂₃ independently represent an alkyl group, an alkenyl group, a cycloalkyl group, or an aryl group; R₁₈ and R₁₉, R₂₀ and R₂₁, or R₂₂ and R₂₃ may independently bind together to form a ring; and n1 represents any integer of 0, 1, 3 and 4,
wherein the recording is performed by 4) a polymerization reaction comprising forming a latent image formation via color developing and sensitizing a color developing substance, the recording comprising the steps of:
a first step of generating a color developing substance as a latent image by hologram exposure, the color developing substance having no absorption in a wavelength of hologram reproducing light; and
a second step of irradiating the latent image with light having a wavelength different from that for the hologram exposure to cause the polymerization reaction so as to record the refractive index modulation, and
wherein the first and second steps are performed by dry processes.

11. A hologram recording material for a hologram recording method according to claim 10, comprising:
1) a sensitizing dye absorbing light during the hologram exposure at the first step to generate an excited state of the sensitizing dye;
2) a precursor capable of adding an acid thereto to become the color developing substance having an absorption in a wavelength longer than that of the precursor and having no absorption in a wavelength of hologram reproducing light;
3) an acid generator generating an acid via an electron transfer from the excited state of the sensitizing dye at the first step or from the excited state of the precursor at the second step;
4) a polymerizable compound;
5) a polymerization initiator capable of initiating the polymerization reaction of the polymerizable compound via an electron transfer or energy transfer from the excited state of the sensitizing dye at the first step or from the excited state of the color developing substance at the second step; and
6) a binder,
wherein the sensitizing dye is represented by one of formulae (2-1) to (2-5) or the acid generation is represented by one of formulae (1-1) to (1-6).

12. A hologram recording material for a hologram recording method comprising recording a refractive index modulation providing interference fringes in the hologram recording material by 6) a dye discoloring reaction, the hologram recording material comprising:
1) a sensitizing dye absorbing light upon hologram exposure to generate an excited state of the sensitizing dye;
2) an acid generator generating an acid via an electron transfer or energy transfer from the excited state of the sensitizing dye; and
3) a discolorable dye having no absorption in a wavelength of hologram reproducing light and being discolored with the acid,
wherein the sensitizing dye generates the excited state thereof by the hologram exposure and subsequently transfers an electron to the acid generator to generate an acid, which discolors the discolorable dye to form the refractive index modulation, and
the sensitizing dye is represented by one of formulae (2-1) to (2-5) or the acid generation is represented by one of formulae (1-1) to (1-6): 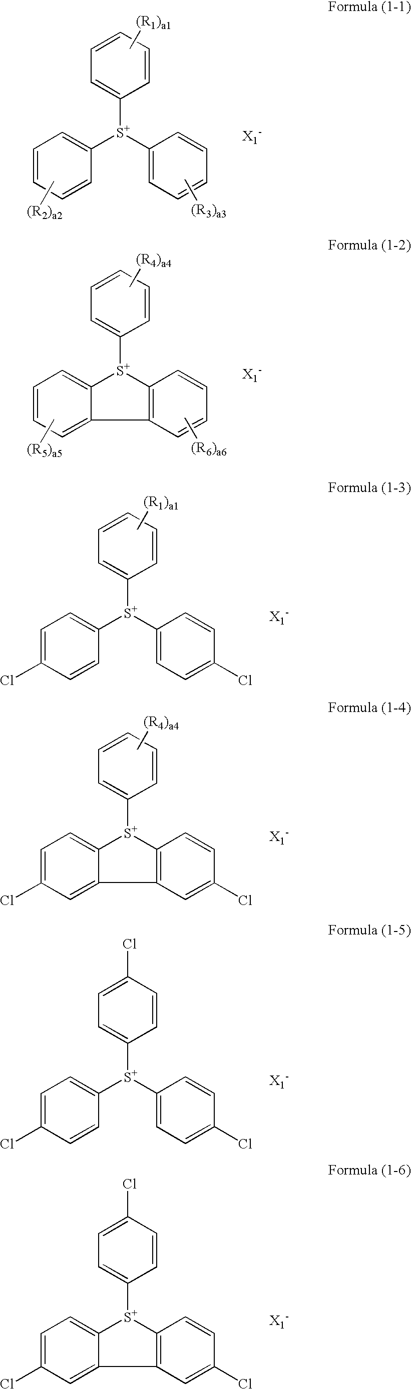 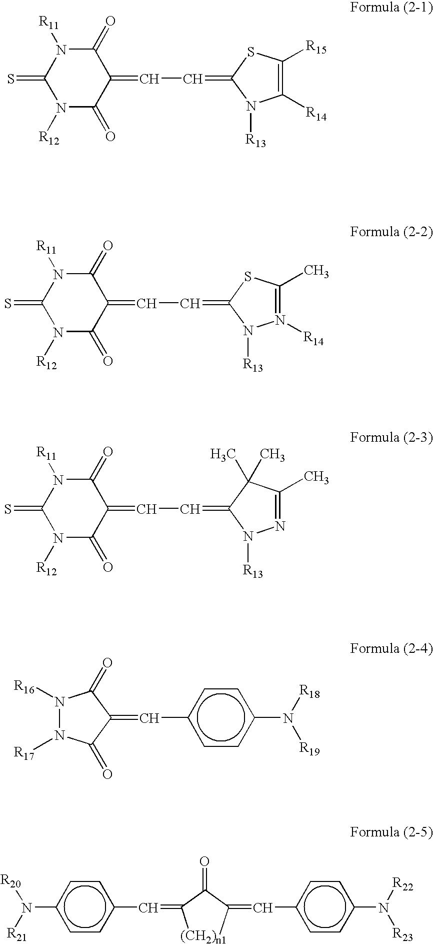
wherein R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; a5 and a6 independently represent an integer of 0 to 4, provided that R₁, R₂, R₃, R₄, R₅ and R₆ independently existing in plurality may be the same or different when a1 through a6 are 2 or more, and X₁⁻ represents an anion, and wherein R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group; R₁₈, R₁₉, R₂₀, R₂₁, R₂₂ and R₂₃ independently represent an alkyl group, an alkenyl group, a cycloalkyl group, or an aryl group; R₁₀ and R₁₉, R₂₀ and R₂₁, or R₂₂ and R₂₃ may independently bind together to form a ring; and n1 represents any integer of 0, 1, 3 and 4.

13. A hologram recording method comprising recording a refractive index modulation providing interference fringes in an hologram recording material comprising at least one of an acid generator and a sensitizing dye,
wherein the acid generator is represented by one of formulae (1-1) to (1-6): 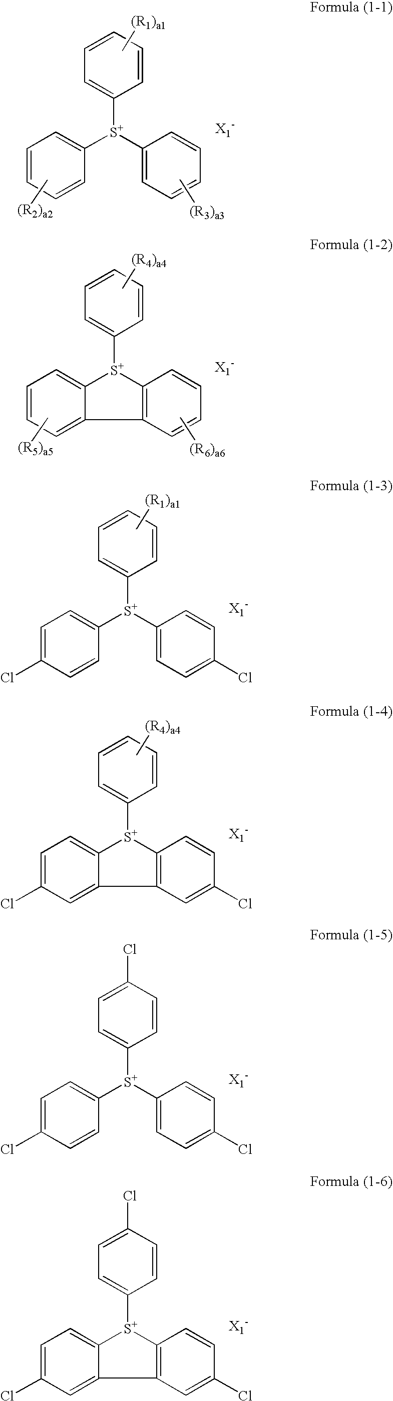
wherein R₁, R₂ and R₃ independently represent an electron attractive substituent; R₄, R₅ and R₆ independently represent a substituent; a1, a2, and a3 independently represent an integer of 1 to 5; a4 represents an integer of 0 to 5; a5 and a6 independently represent an integer of 0 to 4, provided that R₁, R₂, R₃, R₄, R₅ and R₆ independently existing in plurality may be the same or different when a1 through a6 are 2 or more; and X₁⁻ represents an anion,
wherein the sensitizing dye is represented by one of formulae (2-1) to (2-5): 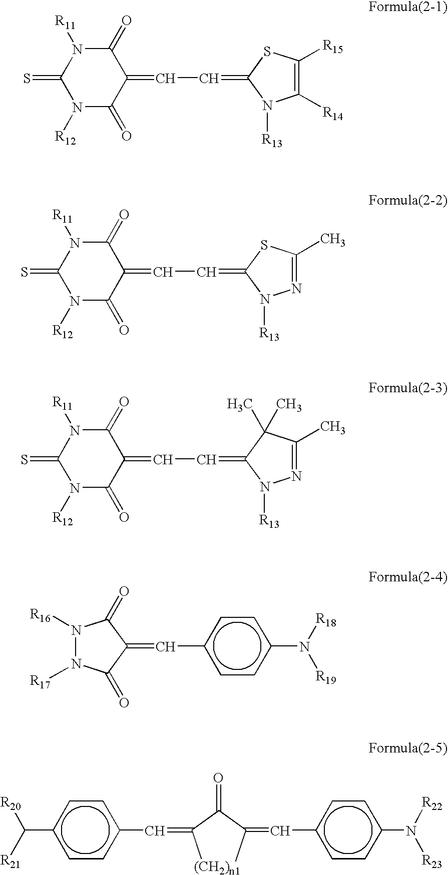
wherein R₁₁, R₁₂, R₁₄, R₁₅, R₁₆ and R₁₇ independently represent hydrogen atom, an alkyl group, an alkenyl group, a cycloalkyl group, or an aryl group; and R₁₃ represents an alkyl group, an alkenyl group, a cycloalkyl group or an aryl group; R₁₈, R₁₉, R₂₀, R₂₁, R₂₂ and R₂₃ independently represent an alkyl group, an alkenyl group, a cycloalkyl group, or an aryl group; R₁₈ and R₁₉, R₂₀ and R₂₁, or R₂₂ and R₂₃ may independently bind together to form a ring; and n1 represents any integer of 0, 1, 3 and 4,
wherein the recording is performed by 7) a polymerization reaction comprising a forming latent image of a residual discolorable dye and sensitizing the latent image, the recording comprising the steps of:
a first step of allowing the sensitizing dye having an absorption in a wavelength of hologram exposure to absorb light during the hologram exposure to generate an excited state thereof and subsequently transfers an electron to the acid generator to allow the acid generator to generate the acid, the acid discoloring the discolorable dye to prepare the latent image of the residual discolorable dye never discolored; and
a second step of irradiating the latent image of the residual discolorable dye with light having a wavelength different from that for the hologram exposure to activate a polymerization initiator via an energy transfer or electron transfer and cause the polymerization so as to record the refractive index modulation.

14. The hologram recording material for a hologram recording method according to claim 13, comprising:
1) a sensitizing dye absorbing light during the hologram exposure at the first step to generate an excited state of the sensitizing dye;
2) an acid generator generating an acid via an electron transfer or energy transfer from the excited state of the sensitizing dye;
3) a discolorable dye having no absorption in a wavelength of hologram reproducing light and discoloring by an acid;
4) a polymerizable compound;
5) a polymerization initiator capable of initiating the polymerization of the polymerizable compound via an electron transfer or energy transfer from the residual discolorable dye at the second step; and
6) a binder.

15. The hologram recording material according to claim 9, further comprising an electron donating compound capable of reducing a radical cation of the sensitizing dye or the color developing substance generated from the precursor.

16. The hologram recording material according to claim 15, wherein the electron donating compound is phenothiazine.

17. The hologram recording material according to claim 1, which is non-rewritable.

18. The hologram recording material according to claim 1, which is for a volume-phase hologram recording method.

19. A hologram recording method comprising subjecting a hologram recording material according to claim 1 to multiple recordings 10 times or more to record a hologram.

20. The hologram recording method according to claim 19, wherein the multiple recordings is performed at a constant exposure level during the multiple recordings.

21. The hologram recording material according to claim 1, which is for an optically recording medium.

22. The hologram recording material according to claim 21, which is stored in a light-shielded cartridge during storage.
